(19) United States
(12) Patent Application Publication
(10) Pub. No.: US 2026/0290892 A1
(43) Pub. Date: Sep. 24, 2026

(54) FLUORINE-CONTAINING PHASE-SEPARATED POLYMER ELECTROLYTES FOR HIGH-ENERGY SOLID-STATE LITHIUM METAL BATTERIES

(71) Applicants: GEORGIA TECH RESEARCH CORPORATION, Atlanta, GA (US); KOREA ADVANCED INSTITUTE OF SCIENCE AND TECHNOLOGY, Daejeon (KR)

(72) Inventors: Junghun HAN, Daejeon (KR); Bumjoon J. KIM, Daejeon (KR); Michael J. Lee, Atlanta, GA (US); Seung Woo Lee, Atlanta, GA (US)

(21) Appl. No.: 19/475,298

(22) PCT Filed: Apr. 12, 2024
(86) PCT No.: PCT/US2024/024468

§ 371 Date: Oct. 14, 2025

Related U.S. Application Data
(60) Provisional application No. 63/496,176, filed on Apr. 14, 2023.

(51) Int. Cl. H01M 10/0565; H01M 10/052

(52) U.S. Cl. CPC H01M 10/0565; H01M 10/052; H01M 2300/0082

(57) ABSTRACT

Disclosed is a composition comprising a) a matrix comprising a fluorinated elastomeric polymer; b) a plurality of plastic crystals dispersed within the matrix to form a three-dimensional interconnected phase of plastic crystals that is separate and distinct from the fluorinated elastomeric polymer, wherein the composition exhibits an ionic conductivity of 0.7 mS/cm to 5 mS/cm at 20° C. Also disclosed herein are batteries comprising the same and methods of making and using the same.

### CROSS-REFERENCE TO THE RELATED APPLICATIONS

This application claims the benefit of U.S. Provisional Application 63/496,176, filed Apr. 14, 2023, the contents of which is hereby incorporated in its entirety.

### TECHNICAL FIELD

This application relates generally to metal and metal-ion batteries with stable solid electrolytes.

### BACKGROUND

Rechargeable batteries based on metal anodes, including lithium (Li), sodium (Na), and zinc (Zn), show great promise in achieving high energy density. Unfortunately, the electrochemical interface of the metal anodes is not favorable for metal deposition. Metal nucleation is inhomogeneous at the surface, leading to the growth of metal dendrites and the formation of unstable solid-electrolyte interphase (SEI) incapable of protecting metals from the side reactions with the electrolyte.

Thus, many research efforts have been devoted to resolving these issues using porous scaffolds, artificial SEI layers, and solid-state electrolytes (SSEs). In particular, solid-state LMBs based on inorganic or organic SSEs have emerged as a promising candidate as they offer a substantial improvement in safety by eliminating the flammable organic solvents. Considering the compatibility with the current roll-to-roll-based manufacturing process of Li-ion batteries, solid polymer electrolytes (SPEs) have attracted great interest because of their low manufacturing cost, non-toxicity, and relatively soft nature that enables the formation of a smooth interface with the electrodes. Among the various polymers, poly(ethylene oxide) (PEO)-based SPEs have been the subject of intensive research; however, these polymers do not exhibit sufficient ionic conductivity and stability for the stable operation of LMBs. A common approach to improving ionic conductivity is incorporating additives, such as organic and inorganic fillers, into the polymer matrix to form a gel or hybrid SPEs.

However, the ionic conductivity and/or mechanical properties of these gel and hybrid SPEs should be further enhanced for viability in high-energy LMBs. Elastomers, synthetic rubbers, are widely used in consumer products and advanced technologies (wearable electronics and soft robotics) due to their superior mechanical properties. Elastomers can provide an excellent matrix to disperse functional components while maintaining both mechanical elasticity and functionality. For example, the important functionalities of the blends, such as electrical and ionic conductivities, can be well maintained when dispersed components are three-dimensionally connected within an elastomer matrix. Polymerization-induced phase separation (PIPS) is a process that controls the domain size and connectivity of phase-separated structures, allowing the formation of co-continuous nanostructures. However, no attempt has been made to develop an ion-conducting phase within an elastomeric system using PIPS.

Thus, new approaches to providing stable solid-polymer electrolytes and batteries utilizing the same and methods of making the same are needed. These needs and other needs are at least partially satisfied by the present disclosure.

### SUMMARY

The present disclosure is directed to a composition comprising: a) a matrix comprising a fluorinated elastomeric polymer; b) a plurality of plastic crystals dispersed within the matrix to form a three-dimensional interconnected phase of plastic crystals that separate and distinct from the fluorinated elastomeric polymer; wherein the composition exhibits an ionic conductivity of 0.7 mS/cm to 5 mS/cm at 20° C.

Also disclosed are heterogeneous compositions comprising a first phase that is a fluorinated elastomeric polymer and a second phase comprising a plurality of plastic crystals. The second phase provides an interconnected network with improved ionic conductivity relative to homogenous compositions containing a plurality of plastic crystals.

Also disclosed herein are solid electrolytes comprising any of the disclosed herein polymer compositions.

Still further, the disclosure is directed to electrochemical cells comprising the solid electrolytes comprising the disclosed herein compositions.

In some aspects disclosed herein, electrochemical cells comprise an anode electrode; and a cathode electrode; wherein the anode electrode and the cathode electrode are in electrical communication with any of the disclosed herein solid electrolytes. In such exemplary and unlimiting aspects, the metal material can comprise Li, Ca, Na, K, Mg, Zn, Al, alloys thereof, or a combination thereof. In yet still further aspects, the electrochemical cells disclosed herein comprise batteries.

Solid-state lithium (Li) metal batteries (LMBs) are disclosed as a promising replacement for conventional Li-ion batteries due to their potential for higher energy having a fluorine (F)-containing solid polymer electrolyte (SPE) having a bi-continuous structure of F-containing elastomers and plastic crystals. The trifluoroethyl acrylate-based SPE (T-SPE) exhibits high ionic conductivity over 10⁻³ S cm⁻¹, superior mechanical elasticity, and robust LiF-rich interphases at both the Li metal anode and the LiNi_{0.83}Mn_{0.06}Co_{0.11}O₂ cathode. Full cells with thin T-SPEs and low negative/positive capacity ratios below 0.5 at the high-operating voltage of 4.5 V demonstrate a high specific energy of 538 Wh kg_{anode+cathode+electrolyte}⁻¹ and maintain 393 Wh kg⁻¹ at a high specific power of 804 W kg⁻¹. The F-containing phase-separated SPE system provides a powerful strategy for achieving high-energy and -power solid-state LMBs.

Additional advantages of the disclosed compositions, systems, and methods will be set forth in part in the description which follows, and in part will be obvious from the description. The advantages of the disclosed compositions, systems, and methods will be realized and attained by means of the elements and combinations particularly pointed out in the appended claims. It is to be understood that both the foregoing general description and the following detailed description are exemplary and explanatory only and are not restrictive of the disclosed compositions, systems, and methods, as claimed.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIGS. 1A-1E depict the design of a plastic-crystal-embedded elastomer electrolyte. FIG. 1A depicts a schematic illustration of the design and structure for PCEE. The structure of PCEE shows that the 3D interconnected plastic crystal phase ( [symbol] ) is surrounded by the elastomer phase ( [symbol] ). The plastic crystal phase supports a fast ion-conducting pathway, whereas the elastomer phase provides superior mechanical extensibility. FIG. 1B shows a 3D tomography image of PCEE constructed by an X-ray microscope. FIG. 1C shows a cross-sectional SEM image of PCEE film. FIG. 1D shows a cross-sectional TEM image of PCEE film. FIG. 1E shows electron energy-loss spectroscopy elemental mapping of the TEM image of FIG. 1D.

FIGS. 2A-2C depict the fabrication process of in situ-polymerized PCEE within the electrochemical cell. FIG. 2A shows digital photo images of a homogeneous solution consisting of BA, SBN, LiTFSI, PEGDA, and AIBN for built-in polymerization (left) and haze-colored PCEE on the bottom of a glass vial after polymerization at 70° C. for 2 h (right). FIG. 2B shows a photo image of PCEE showing mechanical elasticity. FIG. 2C shows a schematic illustration of the build-in polymerization process. The solution was injected into the electrochemical cells and then heated in an oven for build-in polymerization.

FIGS. 3A-3C show scanning electron microscopy (SEM) images of PCEE at different magnifications showing the detailed morphology.

FIG. 4 shows differential scanning calorimetry (DSC) measurements of BA100, SN100, and built-in PCEE. The pristine elastomers (BA100), which were produced by the polymerization of BA and PEGDA, have a low glass transition temperature (T_{g}) of −32° C., SN100 had a plastic crystal phase (positional order but orientational disorder) in the temperature range from −39° C. of the plastic crystal temperature (T_{PC}) to 25° C. of the melting temperature (Tₘ). Built-in PCEE exhibited thermal characteristics of both BA100 and SN100, indicating the separate formation of both phases.

FIGS. 5A-SD depict thermogravimetric analysis (TGA) measurements of BA100 (FIG. 5D), SN100 (FIG. 5C), and built-in PCEE (FIG. 5A-5B). The onset decomposition temperature of SN100 was ~105° C., which showed low thermal stability. In contrast, the thermal degradation of the BA100 started to occur at a high temperature of ~316° C. PCEE showed improved thermal stability over pure SN100, demonstrating the important role of elastomer as a protecting layer for the plastic crystal SN phase.

FIG. 6 depicts Fourier Transform Infrared Spectroscopy (FT-IR) spectra of BA-based solution, BA100, SN100, and built-in PCEE. Built-in PCEE showed the vibrational peaks originated from its main components (BA, SN, and LiTFSI). The vibrational peak corresponding to CEN stretching of SN an built-in PCEE appeared at 2246 cm⁻¹. For built-in PCEE and BA100, the vibrational peak of C═O stretching (acrylate ester) appeared at 1736 cm⁻¹. The vibrational peak of C═C stretching of the BA monomer at 1620 cm⁻¹ disappeared due to the conversion from C═C to —C—C— through polymerization.

FIGS. 7A-7D depict a comparison of morphology, ion conductivity, and mechanical property between polymerization induced-PCEE and blend systems. FIG. 7A shows the morphology of PCEE. SEM image of PCEE shows the continuously-connected SN phases within the elastomeric matrix that was uniformly developed over a large area through PIPS. FIG. 7B shows a morphology of blend consisting of elastomeric polymer (cross-linked poly(butylacrylate) and PEGDA) and plastic crystal (SN) with LiTFSI A blend is prepared from a mixture of elastomeric polymers and SN-LiTFSI in chloroform, followed by a drying process. The same weight ratios of BA, SN, PEGDA, and LiTFSI are used for constructing the PCEE and blend systems. SEM image of blend shows a macrophase separation with a length-scale of over μm. FIGS. 7C-7D compare ionic conductivity (FIG. 70) and toughness (FIG. 7D) between the PCEE and blend systems.

FIGS. 8A-8F depict the properties of the built-in PCEE. FIG. 8A shows Arrhenius plots of the built-in PCEE and its components (BA100 and SN100) based on measurements of ionic conductivity (σ) versus temperature (T). FIG. 8B shows stress-strain curves of the built-in PCEE and BA100 at an extension rate of 100 mm min⁻¹. The tensile property of SN100 could not be measured owing to its brittleness. FIG. 8C shows photo images and schemes showing the ex-situ and the built-in PCEEs. FIG. 8D shows a cross-sectional SEM image of the built-in PCEE on the Li metal anode, FIG. 8E shows an interfacial adhesion test between the built-n PCEE and the Cu foil. The red dotted line indicates the average force per width. FIG. 8F shows Nyquist plots of as-prepared symmetric Li cells configured with various electrolytes. The solid lines correspond to the equivalent circuit fits,

FIG. 9 shows the ionic conductivity of the polymer electrolytes as a function of BA:SN (vol %) composition. The ionic conductivity was measured from BA100 (matrix phase) to SN100 (core phase) in gradual increments of 10 vol % of SN. The results showed that the ionic conductivity increased with increasing SN. The ionic conductivity was not maximized at the 5:5 point, but the increment in the conductivity after BA50SN50 (5:5 point) became relatively modest. Therefore, BA50SN50 was selected as the optimal composition by considering both the contributions of the elastomeric properties and the high ionic conductivity (~10⁻³ S cm⁻¹).

FIG. 10 shows X-ray diffraction (XRD) spectra of BA00, SN100, and PCEE.

FIG. 11 shows a flame retardant of PCEE. Photo images of flammability test on the PCEE.

FIG. 12 shows an interfacial adhesion test between ex-situ PCEE and Cu fail. The ex-situ PCEE was sandwiched between two pieces of Cu foil. Two free arms of Cu foils were stretched in a 180-degree peeling test. The adhesion energy was determined by the plateau value of the force per width demanded for the extension. The adhesion energy of ex-situ PCEE was only 2.7 J m⁻², which is lower by one order in magnitude compared to that of built-in PCEE (21.5 J m⁻²).

FIG. 13 shows the cumulative capacity of the symmetric Li cell with built-in PCEE. The symmetric Li cell was performed at a high current density of 10 mA cm⁻² with a capacity of 10 mAh cm⁻² for every Li plating/stripping (fraction of Li passed per cycle: 0.15) at 20° C.

FIGS. 14A-14J show built-in PCEE in symmetric Li and asymmetric Li∥Cu cells. FIG. 14A shows the cycling performance of the symmetric Li cells with various electrolytes. Insets: enlarged voltage profiles for different times. FIGS. 14B-14D show top-view SEM images of the Li metal anodes with SN100 after cell failure (FIG. 14B), ex-situ PCEE (FIG. 14C), and built-in PCEE (FIG. 14D) after 100 cycles at a current density of 10 mA cm-2 with a capacity of 10 mAh cm-2. Insets: magnified top-view SEM images. FIG. 14E shows coulombic efficiencies for the asymmetric Li∥Cu cells with the built-in PCEE at current densities of 2 mA cm-2 and 5 mA cm-2 with capacities of 4 mA cm-2 and 10 mAh cm-2, respectively. FIG. 14F shows corresponding enlarged voltage profiles. FIGS. 14G-14I show cross-sectional SEM images of pristine (FIG. 14G), Li-plated (FIG. 14H), and Li-stripped (FIG. 14I) Cu electrodes assembled with the built-in PCEE. FIG. 14J shows a schematic illustration of Li plating and stripping with different electrolytes.

FIGS. 15A-15F show electrochemical characterization for the symmetric Li cells with built-in PCEE. FIG. 15A shows time-dependent Nyquist plots of the symmetric Li cells configured with built-in PCEE. FIG. 15B shows Nyquist plots of the symmetric Li cells configured with built-in PCEE after 25, 75, and 100 cycles. FIG. 15C shows the cycling performance of the symmetric Li cells configured with built-in PCEE at different current densities. FIG. 15D shows voltage hysteresis of Li plating/stripping for built-in PCEE compared with previously reported literature data. FIG. 15E shows Nyquist plots of the symmetric Li cels before and after polarization of 10 my. FIG. 15F shows the steady-state current measurement of the symmetric Li cells under 10 mV polarization for 10 h. EIS was measured at an open-circuit voltage in the range of 105 to 10° Hz with an amplitude of 10 mV.

FIG. 16 shows an equivalent circuit for modeling Nyquist plots of symmetric Li cels.

FIG. 17 shows the characterization of the SEI components on the cycled Li metal anodes with built-in PCEE and SN100 by XPS. The high-resolution Li 1s, C 1s, O 1s, N 1s, and F 1s XPS spectra of the Li metal anodes were measured after 100 cycles of the symmetric Li cells with built-in PC EE and SN100 at a current density of 1 mA cm⁻² with a capacity of 1 mAh cm⁻².

FIGS. 18A-18B show the cycling performance of the asymmetric Li∥Cu cells configured with SN100. FIG. 18A shows coulombic efficiencies as a function of cycle number at 0.5 mA cm⁻² with 1 mA cm⁻². FIG. 18B shows corresponding Li stripping and plating profiles.

FIGS. 19A-19C show Li plating and stripping behavior of built-in PCEE on bare Cu. FIG. 19A shows the cycling performance of the asymmetric Li∥Cu cells at current densities of 0.5 and 1 mA cm⁻², respectively. FIGS. 198-19C show Li stripping and plating profiles for built-in PCEE at a current density of 0.5 mA cm⁻² with a capacity of 1 mAh cm⁻² (FIG. 19B) and a current density of 1 mA cm with a capacity of 2 mAh cm⁻² (FIG. 19C).

FIGS. 20A-200 show electrochemical stability of built-in PCEE paired with high-voltage NMC-622 cathode. FIG. 20A shows an electrochemical floating experiment was performed using Li∥NMC-622 with built-in PCEE. The cell was charged to 4.2 Vat 0.2 C (1 C=180 mA g⁻¹) and then held at gradually higher voltages for 10 h up to 4.7 V. FIG. 20B shows the rate capability of the full cell (35-μm-thick Li anode; 25-μm-thick built-in PCEE; high-loading NMC-622 (9.7 mg cm⁻²) in the voltage range of 2.7-4.5 V at equal current densities. (Inset: the capacity utilization at different areal current densities). FIG. 20C shows the cycling performance of the full cell (excess Li; 25-μm-thick built-in PCEE; NMC-622 (2.1 mg cm⁻²)) as a function of cycle number in the voltage range of 2.7-4.5 V. The cell maintained a high capacity of ~140 mAh g⁻¹ (82% capacity retention) with high CEs of 99.5% for 100 cycles, confirming the stable operation at high voltage. Cells were performed at 20° C.

FIG. 21 illustrates electrochemical oxidative stability. Linear sweep voltammetry (LSV) profiles of BA100, SN100, and built-in PCEE in Li∥stainless steel cell at a scan rate of 1 mV s⁻¹ (Inset: enlarged LSV profiles in the potential range of 4 to 5.5 V).

FIGS. 22A-228 show the cycling performance of the Li∥LiFePO4 cell at 1 C without voltage holding. FIG. 22A shows capacity and Coulombic efficiency as a function of cycle number. FIG. 22B shows corresponding voltage profiles. 1 C═170 mA g⁻¹.

FIGS. 23A-23B show electrochemical performances of the full cells with high-voltage NMC-83 cathode. FIG. 23A shows the charge and discharge profiles of the full cell in the voltage range of 2.7-4.3V at 0.1 mA cm⁻². FIG. 23B shows temperature-dependent voltage profiles of the full cell charged/discharged at equal temperatures (60 to 0° C.) in the voltage range of 2.7-4.5 V (Inset: the capacity utilization at different temperatures). Al full cells were configured with 35-μm-thick Li anode; 25-μm-thick built-in PCEE; high-loading NMC-83 (>10 mg cm⁻²).

FIGS. 24A-24D show Towards a high-energy all-solid-state LMB with elastomeric electrolyte. FIG. 24A shows the cycling performance of the full cel as a function of cycle number in the voltage range of 2.7-4.3 V. The cell was initially cycled at a current density of 0.1 mA cm⁻² for 3 cycles before cycling at 0.5 mA cm FIG. 24B shows the rate capability of the full cell in the voltage range of 2.7-4.5 V at equal current densities. Inset shows the capacity utilization at different areal current densities FIG. 24C shows the Ragone plot for the full cells at ambient temperature (20-30° C.). Specific energy and power in the respective references are depicted within the light-shaded regions (blue polymer/composite electrolyte: grey, inorganic electrolyte). Specific energy and power are normalized by the mass of the cells (anode, solid electrolyte, and cathode), excluding the weight of the cell casing and current collectors. FIG. 24D shows a schematic illustration of all-solid-state LMB that comprises a thin Li metal anode, thin built-in PCEE, and high-loading NMC-83. The full cell with the built-in PCEE shows higher specific energy than the typical full cells listed in FIG. 25. All full cells were configured with 35-μm-thick Li anode, 25-μm-thick built-in PCEE, and high-loading NMC-83 (>10 mg cm⁻²).

FIG. 25 shows a comparison of battery performance with previously reported solid-state LMBs.

FIGS. 26A-26D shows the schematic procedure with digital photo images for the preparation of PCEE. The PCEE was prepared in four steps. First, a BA100 solution consisting of BA (monomer), PEGDA (cross-inker), AIBN (thermal initiator), and LiTFSI (salt) was prepared. After dissolving PEGDA, AIBN, and LiTFSI in BA (liquid state), the solution was stirred at room temperature for 1 h to ensure uniform mixing. Second, an SN100 solution consisting of SN (plastic crystal) and LiTFSI (salt) was prepared, SN was in a crystal state at room temperature, and LiTFSI was subsequently mixed with SN. To prevent side-reactions of SN with Li metal, 5 vol % fluoroethylene carbonate was also added. Then, these components were stirred at 50° C. for 1 h to prepare a homogeneous solution. In the third step, the BA100 and SN100 solutions were combined by controlling the volume ratio. For BA50SN50, the volume ratio of BA100 and SN100 solutions was 1:1. Finally, the solution was stirred at 50° C. for 1 h and then polymerized at 70° C. for 2 h, resulting in the formation of PCEE.

FIGS. 27A-27B show galvanostatic charge/discharge profile of LiNi0.88Co0.09Al0.03O2 (NCA-88) at 0.2 C (FIG. 27A) and cycling performance of the full cell (Li//Built-in PCEE//NCA-88) as a function of cycle number at 0.2 C in the voltage range of 2.7-4.3 V (1 C=190 mA g⁻¹) (FIG. 27B)

FIG. 28 shows conductivity as a function of temperature for PCEE systems with mono- (Li, Na, and K), di- (Mg and Zn), and trivalent cations (Al).

FIGS. 29A-29B depict optical properties of E-SPE and T-SPE. E-SPE remains transparent after the in-situ polymerization (FIG. 2A), whereas T-SPE becomes non-transparent, indicating the formation of non-homogenous, phase-separated structures (FIG. 2B).

FIG. 30 depicts thermogravimetric 9nálisis (TGA) measurements for T-SPE, E-SPE, and SN100,

FIGS. 31A-31D depicts design of E-SPE and T-SPE. FIG. 31A shows components utilized to fabricate E-SPE and T-SPE, and schematics illustrating their morphologies. FIG. 31B shows ¹⁹F solid-state nuclear magnetic resonance (NMR) spectra of E-SPE and T-SPE. The NMR spectrum of T-SPE fabricated without salt is also shown for comparison, FIGS. 31C-31D show cryogenic transmission electron microscopy images of cross-sectioned E-SPE (FIG. 31C) and T-SPE (FIG. 31D). Insets represent electron energy loss spectroscopy mapping images of E-SPE and T-SPE where the green area indicate an F-rich region). Scale bars are 2 μm.

FIGS. 32A-32G depict properties of E-SPE and T-SPE. FIG. 32A shows ⁷Li solid-state NMR spectra of E-SPE and T-SPE. The spectrum of T-SPE is deconvoluted into three peaks using Lorentzian-Gaussian functions (the blue, cyan, and orange peaks correspond to Li-ion interactions with the crosslinked poly(TFEA), poly(TFEA)/SN interface, and SN, respectively). FIGS. 32B-32D show comparison of ionic conductivity (a) (FIG. 32B), activation energy (Eₐ) (FIG. 320) and Li-ion transference number (t_{Li}_{⁺}) (FIG. 32D) of E-SPE and T-SPE at 20° C. FIG. 32E shows, Stress-strain curves of E-SPE and T-SPE at an extension rate of 100 mm min⁻¹ FIG. 32F-32G show photographs of pristine and stretched T-SPE (FIG. 32F) and E-SPE specimen (FIG. 32G).

FIGS. 33A-338 depicts ⁷Li solid-state NMR spectra of poly(TFEA), poly(EA), and SN containing Li salts (FIG. 33A) and Arrhenius plots of ionic conductivity versus temperature for T-SPE and E-SPE (FIG. 33B).

FIG. 34 depicts an equivalent circuit for modelling Nyquist plots of symmetric Li cells.

FIGS. 35A-35D depict transference number of different SPEs. Nyquist plots of symmetric Li cells with T-SPE (FIG. 35A) T-SPE and (FIG. 35C) E-SPE before and after polarization of 10 mV. Steady-state current measurement of symmetric Li cells with (FIG. 35B) T-SPE and (FIG. 35D) E-SPE under 10 mV polarization for 10 h.

FIGS. 36A-36C depict extensibility of pristine cross-linked poly(EA), pristine cross-linked poly(TFEA), E-SPE, and T-SPE. FIG. 36A shows Bar plot of elongation at break values of cross-linked poly(EA), cross-linked poly(TFEA), E-SPE, and T-SPE. FIGS. 368-36C show Photographs of cross-linked poly(TFEA) (FIG. 368) and cross-linked poly(EA) specimen (FIG. 36C) before and after stretching.

FIGS. 37A-37F depict a low N/P full-cell performance of E-SPE and T-SPE. FIG. 37A shows cycling performance of the full cells with LFP cathode as a function of cycle number in the voltage range of 2.5-3.9 V. FIG. 37B shows corresponding charge-discharge profiles of E-SPE (top) and T-SPE (bottom). FIG. 37C shows cycling performance of the full cells with NMC-83 as a function of cycle number in the voltage range of 3.0-4.3 V. FIG. 37D shows corresponding charge-discharge profiles of E-SPE (top) and T-SPE (bottom). FIG. 37E shows Nyquist plots of the full cells based on E-SPE (top) and T-SPE (bottom) with NMC-83 at different cycles-pristine, 3rd, and 100th. Zᵣₑₐₗ and −Z_{img} are the real and imaginary parts of Nyquist plots, respectively. FIG. 37F shows different types of resistances obtained at the 100th cycle (R_{b}, bulk electrolyte resistance; Rₛ, surface film resistance; R_{ct}, charge transfer resistance). The low N/P full cels were configured with 35 μm-thick Li metal anode (7 mAh cm⁻²) 25 μm-thick SPE, and high-loading LFP (>12 mg cm⁻²) or NMC-83 (>11 mg cm⁻²) cathode. The cells were initially cycled at a current density of 0.2 mA cm⁻² for 3 cycles prior to cycling at 1 mA cm⁻².

FIG. 38 depicts cycling performances of replicated full cels with LiFePO₄ (LFP) cathodes in FIG. 37A.

FIGS. 39A-398 depict average voltage (FIG. 39A) and voltage difference 9FIG. 39B) of full cells with LFP cathodes presented in FIG. 37A.

FIG. 40 depicts cycling performances of replicated full cells with LiNi_{0.83}Mn_{0.06}Co_{0.11}O₂ (NMC-83) cathodes in FIG. 37C.

FIG. 41A-41B depict average voltage (FIG. 41A) and voltage difference (FIG. 418) of full cells with NMC-83 cathodes presented in FIG. 37C.

FIG. 42 depicts an equivalent circuit for modelling Nyquist plots of full cells.

FIGS. 43A-43H depict electrode stability with E-SPE and T-SPE. FIGS. 43A-43B show top-view SEM images of cycled-Li metal anodes using E-SPE (FIG. 43A) and T-SPE (FIG. 43B) after 100 cycles at 1 mA cm⁻². FIGS. 43C-43D show high-resolution Li 1s (FIG. 43C) and F 1s (FIG. 43D) XPS spectra of cycled-Li metal anodes using different SPEs.

FIGS. 43E-43F show HR-TEM images of cycled-NMC-83 cathodes using E-SPE (FIG. 43E) and T-SPE (FIG. 43F). FIGS. 43G-43H show the high-resolution C 1s (FIG. 43C) and F 1s (FIG. 43D) XPS spectra of cycled-NMC-83 cathodes using different SPEs. The cycled-Li metal anodes and -NMC-83 cathodes were prepared from the low N/P full cells comprising of 35 μm-thick Li and high-loading NMC-83 cathode (>11 mg cm⁻²) after 100 cycles at 1 mA cm⁻².

FIGS. 44A-44B depict Li metal morphology in different SPEs. Top-view SEM images of cycled-Li metal anodes using (FIG. 44A) E-SPE and (FIG. 44B) T-SPE after 100 cycles at 1 mA cm⁻¹.

FIGS. 45A-45B depict characterization of the SEI components on the cycled-Li metal anodes. FIGS. 45A-45B show the high-resolution N is (FIG. 45A) and C is (FIG. 45B) X-ray photoelectron spectroscopy (XPS) spectra of the cycled-Li metal anodes using different SPEs,

FIGS. 46A-46B depicts XPS survey scan of XPS scans of cycled-Li metal anodes (FIG. 46A) and the cycled-NMC-83 cathodes in different SPEs (FIG. 46B).

FIGS. 47A-47E depict demonstration of high-energy and -power solid-state LMB with T-SPE. FIG. 47A shows electrochemical floating experiment of the full cell with T-SPE. The cel was charged to 4.5 V at 0.2 mA cm⁻² and then held at 4.5 V for 20 h FIG. 47B shows cycling performance of the full cel in the voltage range of 3.0-4.5 V. The cell was initially cycled at 0.2 mA cm⁻² for 3 cycles before cycling at 0.5 mA cm⁻². FIG. 47C shows rate capability of the full cel as a function of cycle number in the voltage range of 3.0-4.5 V at equal current densities FIG. 47D shows corresponding GCD profiles (Inset: the capacity utilization at different areal current densities). FIG. 47E shows depicts the Ragone plot for the full cells at ambient temperature (20-30° C.). Specific energy and power in the respective references are depicted within the light-shaded regions (navy, circle, polymer/composite electrolytes; grey, triangle, inorganic electrolytes). Specific energy and power are normalized by the mass of the cells (anode, solid electrolyte, and cathode), excluding the weight of the cell casing and current collectors. 5 μm-thick Li and high-loading NMC-83 cathode (>10 mg cm⁻²) were used in cells.

FIG. 48 depicts galvanostatic charge-discharge profiles of 5 μm-thick Li∥25 μm-thick T-SPE∥high-loading NMC-83 cathode. The cell was performed in the voltage range of 3.0-45 V with three initialization cycles at a current density of 0.2 mA cm⁻² prior to cycling at a current density of 0.5 mA cm⁻².

FIGS. 49A-49C depict rate performance of replicated 5 μm-thick Li∥25 μm-thick T-SPE∥high-loading NMC-83 cathode cells in FIG. 47B (FIG. 49A) and cyclic voltammetry (CV) (FIG. 49B) and linear sweep voltammetry (LSV) tests of T-SPE and E-SPE (FIG. 490). CV was carried out using Li∥stainless steel (SS) asymmetric cells from −0.2 V to 3 V at a scan rate of 2 mV s⁻¹. LSV was conducted using Li SS cells between 2.0-6.5 V with a scan rate of 1 mV s⁻¹

FIG. 50 depicts the rate performance of replicated 5 μm-thick Li∥25 μm-thick T-SPE∥high-loading NMC-83 cathode cells with NMC-83 cathodes in FIG. 20C.

The accompanying figures, which are incorporated in and constitute a part of this specification, illustrate several aspects described below.

### DETAILED DESCRIPTION

The present invention can be understood more readily by reference to the following detailed description, examples, drawings, and claims, and their previous and following description. However, before the present articles, systems, and/or methods are disclosed and described, it is to be understood that this invention is not limited to the specific or exemplary aspects of articles, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known aspect. To this end, those skilled in the relevant art will recognize and appreciate that many changes can be made to the various aspects of the invention described herein while still obtaining the beneficial results of the present invention. It will also be apparent that some of the desired benefits of the present invention can be obtained by selecting some of the features of the present invention without utilizing other features. Accordingly, those of ordinary ski in the pertinent art will recognize that many modifications and adaptations to the present invention are possible and may even be desirable in certain circumstances and are a part of the present invention. Thus, the following description is again provided as illustrative of the principles of the present invention and not in limitation thereof.

### Definitions

As used herein, the terms “optional” or “optionally” means that the subsequently described event or circumstance can or cannot occur and that the description includes instances where said event or circumstance occurs and instances where it does not.

It is appreciated that certain features of the disclosure, which are, for clarity, described in the context of separate aspects, can also be provided in combination in a single aspect. Conversely, various features of the disclosure, which are, for brevity, described in the context of a single aspect, can also be provided separately or in any suitable subcombination.

As used in the description and the appended claims, the singular forms “a,” “an,” and “the” include plural referents unless the context clearly dictates otherwise. Thus, for example, a reference to “a monomer” includes two or more monomers, reference to “a battery” includes two or more such batteries, and the like.

It is also to be understood that the terminology used herein is for the purpose of describing particular aspects only and is not intended to be limiting. As used in the specification and in the claims, the term “comprising” can include the aspects “consisting of” and “consisting essentially of.” Unless defined otherwise, all technical and scientific terms used herein have the same meaning as commonly understood by one of ordinary skill in the art to which this invention belongs. In this specification and in the claims, which follow, reference will be made to a number of terms that shall be defined herein.

For the terms “for example” and “such as,” and grammatical equivalences thereof, the phrase “and without limitation” is understood to follow unless explicitly stated otherwise. It is further understood that these phrases are used for explanatory purposes only, it is further understood that the term “exemplary” as used herein means “an example of” and is not intended to convey an indication of a preferred or ideal aspect.

The term “or” means “and/or.” Recitation of ranges of values is merely intended to serve as a shorthand method of referring individually to each separate value falling within the range, unless otherwise indicated herein, and each separate value is incorporated into the specification as if it were individually recited herein. The endpoints of all ranges are included within the range and independently combinable. All methods described herein can be performed in a suitable order unless otherwise indicated herein or otherwise clearly contradicted by context.

The term “or combinations thereof” as used herein refers to all permutations and combinations of the listed items preceding the term. For example, “A, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

Recitation of ranges of values herein is merely intended to serve as a shorthand method of referring individually to each separate value recited or falling within the range, unless otherwise indicated herein, and each separate value is incorporated into the specification as if it were individually recited. Ranges provided herein are understood to be shorthand for all of the values within the range. For example, a range of 1 to 50 is understood to include any number, combination of numbers, from the group consisting of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 or sub-ranges from the group consisting of 10-40, 20-50, 5-35, etc. Similarly, numerical ranges recited herein by endpoints include subranges subsumed within that range (e.g., 1 to 5 includes 1-1.5, 1.5-2, 2-2.75, 2.75-3, 3-3.90, 3.90-4, 4-4.24, 4.24-5, 2-5, 3-5, 14, and 2-4). For example, a description of a range such as from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 2, 2.7, 3, 4, 5, 5.3, 6 and any whole and partial increments therebetween. This applies regardless of the breadth of the range. It is further understood that if individual numbers within the range are disclosed, also disclosed are ranges formed by these individual numbers. For example, if the ranges, such as 1 to 3, from 1 to 4, from 1 to 5, from 2 to 4, from 2 to 6, from 3 to 6, etc., are disclosed as well as individual numbers within that range, for example, 1, 2, 2.7, 3, 4, 5, 5.3, 6 are disclosed, then additional subranges such as 1 to 2.7 or 2 to 5.3, and so on are also disclosed.

It is understood that the term “between,” when used in the context of ranges, includes the bordering values of the range. For example, a range described as being between 10 and 15 includes both 10 and 15 unless described otherwise.

Values can be expressed herein as an “average value. Average” generally refers to the statistical mean value.

The organic moieties mentioned when defining variable positions within the general formulae described herein (e.g., the term “halogen”) are collective terms for the individual substituents encompassed by the organic moiety. The prefix Cₙ₋ₘ preceding a group or moiety indicates, in each case, the possible number of carbon atoms in the group or moiety that follows.

The term “ion,” as used herein, refers to any molecule, portion of a molecule, a cluster of molecules, molecular complex, moiety, or atom that contains a charge (positive, negative, or both at the same time within one molecule, cluster of molecules, molecular complex, or moiety (e.g., zwitterions)) or that can be made to contain a charge. Methods for producing a charge in a molecule, a portion of a molecule, cluster of molecules, molecular complex, moiety, or atom are disclosed herein and can be accomplished by methods known in the art, e.g., protonation, deprotonation, oxidation, reduction, alkylation, acetylation, esterification, de-esterification, hydrolysis, etc.

The term “anion” is a type of ion and is included within the meaning of the term “ion.” An “anion” is any molecule, portion of a molecule (e.g., zwitterion), a cluster of molecules, molecular complex, moiety, or atom that contains a net negative charge or that can be made to contain a net negative charge. The term “anion precursor” is used herein to specifically refer to a molecule that can be converted to an anion via a chemical reaction (e.g. deprotonation).

The term “cation” is a type of ion and is included within the meaning of the term “ion.” An “cation” is any molecule, portion of a molecule (e.g., zwitterion), a cluster of molecules, molecular complex, moiety, or atom, containing a net positive charge or that can be made to contain a net positive charge. The term “cation precursor” is used herein to specifically refer to a molecule that can be converted to a cation via a chemical reaction (e.g., protonation or alkylation).

It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present. Other words used to describe the relationship between elements or layers should be interpreted in a like fashion (e.g., “between” versus “directly between,” “adjacent” versus “directly adjacent,” “on” versus “directly on”).

It will be understood that the terms “first,” “second,” etc., may be used herein to describe various elements, components, regions, layers, and/or sections. These elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of example embodiments.

As used herein, the term or phrase “effective,” “effective amount,” or “conditions effective to” refers to such amount or condition that is capable of performing the function or property for which an effective amount or condition is expressed. As will be pointed out below, the exact amount or particular condition required will vary from one aspect to another, depending on recognized variables such as the materials employed and the processing conditions observed. Thus, it is not always possible to specify an exact “effective amount” or “condition effective to” However, it should be understood that an appropriate, effective amount will be readily determined by one of ordinary skill in the art using only routine experimentation.

As used herein, the term “substituted” means that a hydrogen atom is removed and replaced by a substituent. It is contemplated to include all permissible substituents of organic compounds. As used herein, the phrase “optionally substituted” means unsubstituted or substituted. It is understood that substitution at a given atom is limited by valency. In a broad aspect, the permissible substituents include acyclic and cyclic, branched and unbranched, carbocyclic and heterocyclic, and aromatic and nonaromatic substituents of organic compounds. Illustrative substituents include, for example, those described below. The permissible substituents can be one or more and the same or different for appropriate organic compounds. For purposes of this disclosure, the heteroatoms, such as nitrogen, can have hydrogen substituents and/or any permissible substituents of organic compounds described herein, which satisfy the valencies of the heteroatoms. This disclosure is not intended to be limited in any manner by the permissible substituents of organic compounds. Also, the terms “substitution” or “substituted with” include the implicit proviso that such substitution is in accordance with a permitted valence of the substituted atom and the substituent and that the substitution results in a stable compound, e.g., a compound that does not spontaneously undergo transformation such as by rearrangement, cyclization, elimination, etc. In still further aspects, it is understood that when the disclosure describes a group being substituted, it means that the group is substituted with one or more (i.e., 1, 2, 3, 4, or 5) groups as allowed by valence selected from alkyl, halogenated alkyl, alkoxy, alkenyl, alkynyl, aryl, heteroaryl, aldehyde, amino, carboxylic acid, ester, ether, halide, hydroxy, ketone, nitro, silyl, sulfo-oxo, sulfonyl, sulfone, sulfoxide, or thiol, as described below.

Compounds provided herein can also include tautomeric forms. Tautomeric forms result from the swapping of a single bond with an adjacent double bond together with the concomitant migration of a proton. Tautomeric forms include prototropic tautomers, which are isomeric protonation states having the same empirical formula and total charge. Example prototropic tautomers include ketone-enol pairs, amide-imidic acid pairs, lactam-lactim pairs, enamine-imine pairs, and annular forms where a proton can occupy two or more positions of a heterocyclic system, for example, 1H- and 3H-imidazole, 1H-, 2H- and 4H-1,2,4-triazole, 1H- and 2H-isoindole, and 1H- and 2H-pyrazole. Tautomeric forms can be in equilibrium or sterically locked into one form by appropriate substitution.

Compounds provided herein can also include all isotopes of atoms occurring in the intermediates or final compounds. Isotopes include those atoms having the same atomic number but different mass numbers. For example, isotopes of hydrogen include hydrogen, tritium, and deuterium.

Also provided herein are salts of the compounds described herein. It is understood that the disclosed salts can refer to derivatives of the disclosed compounds wherein the parent compound is modified by converting an existing acid or base moiety to its salt form. Examples of the salts include, but are not limited to, mineral or organic acid salts of basic residues such as amines; alkali or organic salts of acidic residues such as carboxylic acids; and the like. The salts of the compounds provided herein include the conventional non-toxic salts of the parent compound formed, for example, from non-toxic inorganic or organic acids. The salts of the compounds provided herein can be synthesized from the parent compound that contains a basic or acidic moiety by conventional chemical methods. Generally such salts can be prepared by reacting the free acid or base forms of these compounds with a stoichiometric amount of the appropriate base or acid in water or an organic solvent or in a mixture of the two. In various aspects, nonaqueous media like ether, ethyl acetate, alcohols (e.g., methanol, ethanol, isopropanol, or butanol), or acetonitrile (ACN) can be used.

In various aspects, the compounds provided herein, or salts thereof, are substantially isolated. By “substantially isolated,” it meant that the compound is at least partially or substantially separated from the environment in which it was formed or detected. Partial separation can include, for example, a composition enriched in the compounds provided herein. Substantial separation can include compositions containing at least 50%, at least 60%, at least 70%, at least 80%, at least 90%, at least 95%, at least 97%, or at least 99% by weight of the compounds provided herein, or salt thereof. Methods for isolating compounds and their salts are routine in the art.

As used herein, chemical structures that contain one or more stereocenters depicted with dashed and bold bonds are meant to indicate the absolute stereochemistry of the stereocenter(s) present in the chemical structure. As used herein, bonds symbolized by a simple line do not indicate a stereo-preference. Unless otherwise indicated to the contrary, chemical structures, which include one or more stereocenters, illustrated herein without indicating absolute or relative stereochemistry encompass all possible stereoisomeric forms of the compound (e.g., diastereomers and enantiomers) and mixtures thereof. Structures with a single bold or dashed line and at least one additional simple line encompass a single enantiomeric series of all possible diastereomers.

The terms for various functional groups as used herein are not intended to be limited to monovalent radicals and may include polyvalent radical groups as appropriate, such as divalent, trivalent, tetravalent, pentavalent, and hexavalent groups, and the like, based on the position and location of such groups in the compounds described herein as would be readily understood by the skilled person.

The expressions “ambient temperature” and “room temperature” as used herein are understood in the art and refer generally to a temperature, e.g., a reaction temperature, that is the temperature of the room in which the reaction is carried out, for example, a temperature from 20° C. to 35° C.

As used herein, the term “aliphatic group” refers to any carbon-containing substituent, including heteroatoms within the group. The current definition of aliphatic group includes, but not limited to, alkyl and heteroalkyl groups, alkenyl and heteroalkenyl groups, alkynyl and heteroalkenyl groups, cyclic and heterocyclic groups, aryl and heteroalkyl groups. In aspects where the aliphatic group comprises heteroatoms, such an aliphatic group can comprise at least one heteroatom in the chain. In certain aspects, the only heteroatom is nitrogen. In certain aspects, the only heteroatom is oxygen. In certain aspects, the only heteroatom is sulfur.

As used herein, the term “Cₙ-Cₘ alkyl” (or “Cₙ₋ₘ”) employed alone or in combination with other terms refers to a saturated hydrocarbon group that may be straight-chain or branched, having n to m carbons. It is understood that the terms Cₙ₋ₘ and Cₙ-Cₘ can be used interchangeably and just to show that the specific compound has between n to m carbons. Unless otherwise specified, C₁-C₂₄ (e.g., C₁-C₂₂, C₁-C₂₀, C₁-C₁₈, C₁-C₁₆, C₁-C₁₄, C₁-C₁₂, C₁-C₁₀, C₁-C₈, C₁-C₆, or C₁-C₄) alkyl groups are intended. Examples of alkyl moieties include, but are not limited to, chemical groups such as methyl, ethyl, n-propyl, isopropyl, n-butyl, tert-butyl, isobutyl, sec-butyl; higher homologs such as 2-methyl-I-butyl, n-pentyl, 3-pentyl, n-hexyl, 1,2,2-trimethylpropyl, heptyl, octyl, nonyl, decyl, dodecyl, tetradecyl, hexadecyl, eicosyl, tetracosyl, and the like. The alkyl group can also be substituted or unsubstituted. Throughout the specification, “alkyl” is generally used to refer to both unsubstituted alkyl groups and substituted alkyl groups; however, substituted alkyl groups are also specifically referred to herein by identifying the specific substituent(s) on the alkyl group. The alkyl group can be substituted with one or more groups including, but not limited to, alkyl, halogenated alkyl, alkoxy, alkenyl, alkynyl, aryl, heteroaryl, aldehyde, amino, carboxylic acid, ester, ether, halide, hydroxy, ketone, nitro, silyl, sulfo-oxo, sulfonyl, sulfone, sulfoxide, or thiol, as described below, provided that the substituents are sterically compatible and the rules of chemical bonding and strain energy are satisfied. It is further understood that throughout the specification, “alkyl” can also be referred to as a linking group of saturated hydrocarbons that are divalent radicals. In other words, in a broader description, the term “alkyls” also encompasses alkylenes. It is further understood that the term “alkyl” covers saturated hydrocarbons that are multivalent radicals. Throughout the specification, “alkyl” is generally used to refer to both unsubstituted alkyl groups and substituted alkyl groups: however, substituted alkyl groups are also specifically referred to herein by identifying the specific substituent(s) on the alkyl group. It is understood that the term “alkyl” as used herein encompasses alkylenes.

The term “heteroalkyl” refers to an alkyl group, which further includes at least one heteroatom (e.g., 1, 2, 3, or 4 heteroatoms) selected from oxygen, nitrogen, or sulfur within (i.e., inserted between adjacent carbon atoms of) and/or placed at one or more terminal position(s) of the parent chain. By way of example, a heteroC₁₋₆alkyl (which may also be designated a C₁₋₆heteroalkyl) group includes, but is not limited to, the following structures:

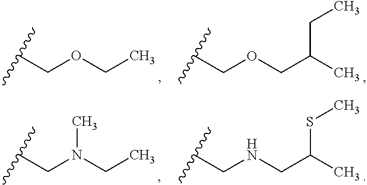

For example, the term “halogenated alkyl” specifically refers to an alkyl group that is substituted with one or more halides. e.g., fluorine, chlorine, bromine, or iodine. Haloalkyl” is a branched or straight-chain alkyl group substituted with 1 or more halo atoms described above, up to the maximum allowable number of halogen atoms. Examples of haloalkyl groups include, but are not limited to, fluoromethyl, difluoromethyl, trifluoromethyl, chloromethyl, dichloromethyl, trichloromethyl, pentafluoroethyl, heptafluoropropyl, difluorochloromethyl, dichlorofluoromethyl, difluoroethyl, difluoropropyl, dichloroethyl and di chloropropyl. “Perhaloalkyl” means an alkyl group having all hydrogen atoms replaced with halogen atoms. Examples include but are not limited to trifluoromethyl and pentafluoroethyl.

As used herein, “Cₙ-Cₘ alkenyl” refers to an alkyl group having one or more double carbon-carbon bonds and having n to m carbons. Alkenyls can be straight-chained or branched. Unless otherwise specified, C₂-C₂₄ (e.g., C₂-C₂₂, C₂-C₂₀, C₂-C₁₅, C₂-C₁₆, C₂-C₁₄, C₂-C₁₂, C₂-C₁₀, C₂-C₆, C₂-C₆, or C₂-C₄) alkenyl groups are intended. Alkenyl groups may contain more than one unsaturated bond. Examples include ethenyl, 1-propenyl, 2-propenyl, 1-methylethenyl, 1-butenyl, 2-butenyl, 3-butenyl, 1-methyl-1-propenyl, 2-methyl-1-propenyl, 1-methyl-2-propenyl, 2-methyl-2-propenyl, 1-pentenyl, 2-pentenyl, 3-pentenyl, 4-pentenyl, 1-methyl-1-butenyl, 2-methyl-1-butenyl, 3-methyl-1-butenyl, 1-methyl-2-butenyl, 2-methyl-2-butenyl, 3-methyl-2-butenyl, 1-methyl-3-butenyl, 2-methyl-3-butenyl, 3-methyl-3-butenyl, 1,1-dimethyl-2-propenyl, 1,2-dimethyl-1-propenyl, 1,2-dimethyl-2-propenyl, 1-ethyl-1-propenyl, 1-ethyl-2-propenyl, 1-hexenyl, 2-hexenyl, 3-hexenyl, 4-hexenyl, 5-hexenyl, 1-methyl-1-pentenyl, 2-methyl-1-pentenyl, 3-methyl-1-pentenyl, 4-methyl-1-pentenyl, 1-methyl-2-pentenyl, 2-methyl-2-pentenyl, 3-methyl-2-pentenyl, 4-methyl-2-pentenyl, 1-methyl-3-pentenyl, 2-methyl-3-pentenyl, 3-methyl-3-pentenyl, 4-methyl-3-pentenyl, 1-methyl-4-pentenyl, 2-methyl-4-pentenyl, 3-methyl-4-pentenyl, 4-methyl-4-pentenyl, 1,1-dimethyl-2-butenyl, 1,1-dimethyl-3-butenyl, 1,2-dimethyl-1-butenyl, 1,2-dimethyl-2-butenyl, 1,2-dimethyl-3-butenyl, 1,3-dimethyl-1-butenyl, 1,3-dimethyl-2-butenyl, 1,3-dimethyl-3-butenyl, 2,2-dimethyl-3-butenyl, 2,3-dimethyl-1-butenyl, 2,3-dimethyl-2-butenyl, 2,3-dimethyl-3-butenyl, 3,3-dimethyl-1-butenyl, 3,3-dimethyl-2-butenyl, 1-ethyl-1-butenyl, 1-ethyl-2-butenyl, 1-ethyl-3-butenyl, 2-ethyl-1-butenyl, 2-ethyl-2-butenyl, 2-ethyl-3-butenyl, 1,1,2-trimethyl-2-propenyl, 1-ethyl-1-methyl-2-propenyl, 1-ethyl-2-methyl-1-propenyl, and 1-ethyl-2-methyl-2-propenyl. The term “vinyl” refers to a group having the structure —CH═CH₂; 1-propenyl refers to a group with the structure —CH═CH—CH₃; and 2-propenyl refers to a group with the structure —CH₂—CH═CH₂. Asymmetric structures such as (Z¹Z²)C═C(Z³Z⁴) are intended to include both the E and Z isomers. This can be presumed in structural formulae herein wherein an asymmetric alkene is present, or it can be explicitly indicated by the bond symbol C≡C. Examples of alkenyl groups include, but are not limited to, ethenyl, n-propenyl, isopropenyl, n-butenyl, seobutenyl, and the like. In various aspects, the alkenyl moiety contains 2 to 6, 2 to 4, or 2 to 3 carbon atoms. The alkenyl group can be substituted with one or more groups including, but not limited to, alkyl, halogenated alkyl, alkoxy, alkenyl, alkynyl, aryl, heteroaryl, aldehyde, amino, carboxylic acid, ester, ether, halide, hydroxy, ketone, nitro, cyano, silyl, sulfo-oxo, sulfonyl, sulfone, sulfoxide, thiol, thiol, or phosphonyl, as described below. It is understood that the term “alkenyl” as used herein encompasses alkenylenes.

As used herein, “Cₙ-Cₘ alkynyl” refers to an alkyl group having one or more triple carbon-carbon bonds and having n to m carbons. Alkynyls can be straight-chained or branched hydrocarbon moieties containing a triple bond. Unless otherwise specified, C₂-C₂₄ (e.g., C₂-C₂₄, C₂-C₂₀, C₂-C₁₈, C₂-C₁₆, C₂-C₁₄, C₂-C₁₂, C₂-C₁₀, C₂-C₈, C₂-C₆, or C₂-C₄) alkynyl groups are intended. Alkynyl groups may contain more than one unsaturated bond. Examples include C₂-C₆-alkynyl, such as ethynyl, 1-propynyl, 2-propynyl (or propargyl), 1-butynyl, 2-butynyl, 3-butynyl, 1-methyl-2-propynyl, 1-pentynyl, 2-pentynyl, 3-pentynyl, 4-pentynyl, 3-methyl-1-butynyl, 1-methyl-2-butynyl, 1-methyl-3-butynyl, 2-methyl-3-butynyl, 1,1-dimethyl-2-propynyl, 1-ethyl-2-propynyl, 1-hexynyl, 2-hexynyl, 3-hexynyl, 4-hexynyl, 5-hexynyl, 3-methyl-1-pentynyl, 4-methyl-1-pentynyl, 1-methyl-2-pentynyl, 4-methyl-2-pentynyl, 1-methyl-3-pentynyl, 2-methyl-3-pentynyl, 1-methyl-4-pentynyl, 2-methyl-4-pentynyl, 3-methyl-4-pentynyl, 1,1-dimethyl-2-butynyl, 1,1-dimethyl-3-butynyl, 1,2-dimethyl-3-butynyl, 2,2-dimethyl-3-butynyl, 3,3-dimethyl-1-butynyl, 1-ethyl-2-butynyl, 1-ethyl-3-butynyl, 2-ethyl-3-butynyl, and 1-ethyl-1-methyl-2-propynyl. In various aspects, the alkynyl moiety contains 2 to 6, 2 to 4, or 2 to 3 carbon atoms. The alkynyl group can be substituted with one or more groups including, but not limited to, alkyl, halogenated alkyl, alkoxy, alkenyl, alkynyl, aryl, heteroaryl, aldehyde, amino, carboxylic add, ester, ether, halide, hydroxy, ketone, nitro, cyano, silyl, sulfo-oxo, sulfonyl, sulfone, sulfoxide, thiol, or phosphonyl, as described below. It is understood that the term “alkynyl” as used herein encompasses alkynylenes.

As used herein, the term “Cₙ-Cₘ alkylene,” employed alone or in combination with other terms, refers to a divalent alkyl linking group having n to m carbons. Examples of alkylene groups include, but are not limited to, ethan-1,2-diyl, propan-1,3-diyl, propan-1,2-diyl, butan-1,4-diyl, butan-1,3-diyl, butan-1,2-diyl, 2-methyl-propan-1,3-diyl, and the like. In various aspects, the alkylene moiety contains 2 to 6, 2 to 4, 2 to 3, 1 to 6, 1 to 4, or 1 to 2 carbon atoms. It is understood however that if the group generically refers to as alkyl, it also includes alkylenes.

As used herein, “aryl” refers to a radical of a monocyclic or polycyclic (e.g., bicyclic or tricyclic) 4n+2 aromatic ring system (e.g., having 6, 10, or 14 it electrons shared in a cyclic array) having 6-14 ring carbon atoms and zero heteroatoms provided in the aromatic ring system (“C₆₋₁₄ aryl”). In some embodiments, an aryl group has 6 ring carbon atoms (“C₆ aryl” e.g., phenyl). In some embodiments, an aryl group has 10 ring carbon atoms (“C₁₀ aryl”; e.g., naphthyl such as 1-naphthyl and 2-naphthyl). In some embodiments, an aryl group has 14 ring carbon atoms (“C₁₄ aryl”; e.g., anthracyl). “Aryl” also includes ring systems wherein the aryl ring, as defined above, is fused with one or more cycloalkyl or heterocyle groups wherein the radical or point of attachment is on the aryl ring, and in such instances, the number of carbon atoms continues to designate the number of carbon atoms in the aryl ring system. The one or more fused cycloalkyl or heterocycle groups can be 4 to 7-membered saturated or partially unsaturated cycloalkyl or heterocyle groups.

“Arylalkyl” refers to either an alkyl group as defined herein substituted with an aryl group as defined herein or to an aryl group as defined herein substituted with an alkyl group as defined herein.

The term “heterocyle” denotes saturated and partially saturated heteroatom-containing ring radicals wherein there are 1, 2, 3, or 4 heteroatoms independently selected from nitrogen, sulfur, boron, silicone, and oxygen. Heterocyclic rings may comprise monocyclic 3-10 membered rings, as well as 5-16 membered bicyclic ring systems (which can include bridged, fused, and spiro-fused bicyclic ring systems). It does not include rings containing —O—O—, —O—S— or —S—S— portions. Examples of saturated heterocycle groups include saturated 3- to 6-membered heteromonocyclic groups containing 1 to 4 nitrogen atoms [e.g., pyrrolidinyl, imidazolidinyl, piperidinyl, pyrrolinyl, piperazinyl]; saturated 3 to a 6-membered heteromonocyclic group containing 1 to 2 oxygen atoms and 1 to 3 nitrogen atoms (e.g., morpholinyl; saturated 3 to 6-membered heteromonocyclic group containing 1 to 2 sulfur atoms and 1 to 3 nitrogen atoms [e.g., thiazolidinyl]. Examples of partially saturated heterocycle radicals include but are not limited to dihydrothienyl, dihydropyranyl, dihydrofuryl, and dihydrothiazolyl. Examples of partially saturated and saturated heterocyle groups include but are not limited to pyrrolidinyl, imidazolidinyl, piperidinyl, pyrrolinyl, pyrazolidinyl, piperazinyl, morpholinyl, tetrahydropyranyl, thiazolidinyl, dihydrothienyl, 2,3-dihydro-benzo[I,4]dioxanyl, indolinyl, isoindolinyl, dihydrobenzothienyl, dihydrobenzofuryl, isochromanyl, chromanyl, 1,2-dihydroquinolyl, 1,2, 3, 4-tetrahydro-isoquinolyl, 1,2,3,4-tetrahydro-quinolyl, 2, 3, 4, 4a, 9,9a-hexahydro-4H-3-aza-fluorenyl, 5,6,7-trihydro-1, 2, 4-triazolo[3,4-a]isoquinolyl, 3,4-dihydro-2H-benzo[I,4]oxazinyl, benzo[I,4]dioxanyl, 2,3-dihydro-IH-Iλ′-benzo[d]isothiazol-6-yl, dihydropyranyl, dihydrofuryl, and dihydrothiazolyl.

The term “heteroaryl” denotes stable aromatic ring systems that contain 1, 2, 3, or 4 heteroatoms independently selected from O, N, and S, wherein the ring nitrogen and sulfur atom(s) are optionally oxidized, and the nitrogen atom(s) are optionally quarternized. Examples include but are not limited to, unsaturated 5 to 6 membered heteromonocyclyl groups containing 1 to 4 nitrogen atoms, such as pyrrolyl, imidazolyl, pyrazolyl, 2-pyridyl, 3-pyridyl, 4-pyridyl, pyrimidyl, pyrazinyl, pyridazinyl, triazolyl [e.g., 4H-I,2,4-triazolyl, H4-1,2,3-triazolyl, 2H-I,2,3-triazolyl]; unsaturated 5- to 6-membered heteromonocyclic groups containing an oxygen atom, for example, pyranyl, 2-furyl, 3-furyl, etc.; unsaturated 5 to 6-membered heteromonocyclic groups containing a sulfur atom, for example, 2-thienyl, 3-thienyl, etc.; unsaturated 5- to 6-membered heteromonocyclic groups containing 1 to 2 oxygen atoms and 1 to 3 nitrogen atoms, for example, oxazolyl, isoxazolyl, oxadiazolyl [e.g., 1,2,4-oxadiazolyl, 1,3,4-oxadiazolyl, 1,2,5-oxadiazolyl]; unsaturated 5 to 6-membered heteromonocyclic groups containing 1 to 2 sulfur atoms and 1 to 3 nitrogen atoms, for example, thiazolyl, thiadiazolyl [e.g., 1,2,4-thiadiazolyl, 1,3,4-thiadiazolyl, 1,2,5-thiadiazolyl]. In certain embodiments the “heteroaryl” group is a 8, 9, or 10 membered bicyclic ring system. Examples of 8, 9, or 10 membered bicylic heteroaryl groups include benzofurazanyl, benzothiophenyl, benzothiazolyl, benzoxazolyl, quinazolinyl, quinoxalinyl, naphthyridinyl, quinolinyl, isoquinolinyl, benzofuranyl, indolyl, indazolyl, and benzotri azolyl.

In general, the inclusion of the prefix “alk” In front of a substituent name indicates there is an alkyl group (as defined herein) connecting the named substituent with the rest of the compound. For example, “alkaryl” (which is a subset of alkyl) refers to an alkyl group substituted by an aryl group, wherein the point of attachment is on the alkyl moiety and “alkheteroaryl” (which is a subset of “alkyl”) refers to an alkyl group substituted by a heteroaryl group, wherein the point of attachment is on the alkyl moiety. The number of carbon atoms may be specified in the alkyl chain, the named substituent, or both. For example, C₁₋₂alkC₆aryl refers to a phenyl ring (which may be substituted) connected via a 1-2 carbon alkylene group.

Affixing the suffix “-ene” to a group indicates the group is a polyvalent moiety, e.g., boned to two or more groups. Alkylene is the polyvalent moiety of alkyl, alkenylene is the divalent moiety of alkenyl, alkynylene is the divalent moiety of alkynyl, heteroalkylene is the divalent moiety of heteroalkyl, heteroalkenylene is the divalent moiety of heteroalkenyl, heteroalkynylene is the divalent moiety of heteroalkynyl, carbocyclylene is the divalent moiety of carbocyclyl, heterocyclylene is the divalent moiety of heterocyclyl, arylene is the divalent moiety of aryl, and heteroarylene is the divalent moiety of heteroaryl.

As used herein, “carbocyclic,” “carbocycle,” or “cycloalkyl” includes a saturated or partially unsaturated (i.e., not aromatic) group containing all carbon ring atoms and from 3 to 14 ring carbon atoms (“C3-14 cycloalkyl”) and zero heteroatoms in the non-aromatic ring system. In some embodiments, a cycloalkyl group has 3 to 10 ring carbon atoms (“C3-10 cycloalkyl”). In some embodiments, a cycloalkyl group has 3 to 9 ring carbon atoms (“C3-9 cycloalkyl”). In some embodiments, a cycloalkyl group has 3 to 8 ring carbon atoms (“C3-8 cycloalkyl”). In some embodiments, a cycloalkyl group has 3 to 7 ring carbon atoms (“C3-7 cycloalkyl”). In some embodiments, a cycloalkyl group has 3 to 6 ring carbon atoms (“C3-6 cycloalkyl”). In some embodiments, a cycloalkyl group has 4 to 6 ring carbon atoms (“C4-6 cycloalkyl”). In some embodiments, a cycloalkyl group has 5 to 6 ring carbon atoms (“C5-6 cycloalkyl”). In some embodiments, a cycloalkyl group has 5 to 10 ring carbon atoms (“C5-10 cycloalkyl”). Exemplary C3-6 cycloalkyl groups include, without limitation, cyclopropyl (C3), cyclopropenyl (C3), cyclobutyl (C4), cyclobutenyl (C4), cyclopentyl (C5), cyclopentenyl (C5), cyclohexyl (C6), cyclohexenyl (C6), cyclohexadienyl (C7), and the like. Exemplary C3-8 cycloalkyl groups include, without limitation, the aforementioned C3-6 cycloalkyl groups as well as cycloheptyl (C7) and cycloheptenyl (C7), cycloheptadienyl (C7), cycloheptatrienyl (C7), cyclooctyl (C8), cyclooctenyl (C8), and the like. Exemplary C3-10 cycloalkyl groups include, without limitation, the aforementioned C3-8 cycloalkyl groups as well as cyclononyl (C9) and cyclononenyl (C9), cyclodecyl (C10), cyclodecenyl (C10), and the like. As the foregoing examples illustrate, in certain embodiments, the cycloalkyl group can be saturated or can contain one or more carbon-carbon double bonds. The term “cycloalkyl” also includes ring systems wherein the cycloalkyl ring, as defined above, is fused with one heterocycle, aryl, or heteroaryl ring wherein the point of attachment is on the cycloalkyl ring, and in such instances, the number of carbons continues to designate the number of carbons in the carbocyclic ring system. The term “cycloalkyl” also includes ring systems wherein the cycloalkyl ring, as defined above, has a spirocyclic heterocycle, aryl, or heteroaryl ring wherein the point of attachment is on the cycloalkyl ring, and in such instances, the number of carbons continues to designate the number of carbons in the carbocyclic ring system. The term “cycloalkyl” also includes bicyclic or polycyclic fused, bridged, or spiro ring systems that contain from 5 to 14 carbon atoms and zero heteroatoms in the non-aromatic ring system.

The terms “amine” or “amino” as used herein are represented by the formula —NR¹R², where R¹ and R² can each be substitution groups as described herein, such as hydrogen, an alkyl, halogenated alkyl, alkenyl, alkynyl, aryl, heteroaryl, cycloalkyl, cycloalkenyl, heterocycloalkyl, or heterocycloalkenyl group described above. “Amido” is —C(O)NR¹R².

The term “anhydride” as used herein is represented by the formula Z¹C(O)OC(O)Z², where Z¹ and Z², independently, can be an alkyl, alkenyl, alkynyl, aryl, heteroaryl, cycloalkyl, cycloalkenyl, heterocycloalkyl, or heterocycloalkenyl group described above.

The term “carboxylic acid” as used herein is represented by the formula —C(O)OH. A “carboxylate” or “carboxyl” group as used herein is represented by the formula —C(O)O.

The term “ester” as used herein is represented by the formula —OC(O)R¹ or —C(O)OR¹, where R¹ can be an alkyl, halogenated alkyl, alkenyl, alkynyl, aryl, heteroaryl, cycloalkyl, cycloalkenyl, heterocycloalkyl, or heterocycloalkenyl group described above.

The term “ketone” as used herein is represented by the formula R¹C(O)R², where R¹ and R² can be, independently, an alkyl, halogenated alkyl, alkenyl, alkynyl, aryl, heteroaryl, cycloalkyl, cycloalkenyl, heterocycloalkyl, or heterocycloalkenyl group described above.

As used herein, the designation of a polyvalent moiety without specifying the specific order of attachment is intended to cover all possible arrangements. By way of example, a compound that is represented by the formula:

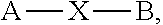

wherein X is NHC(═O) embraces both:

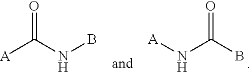

As used herein, a chemical bond depicted: [symbol] represents either a single, double, or triple bond, valency permitting. By way of example,

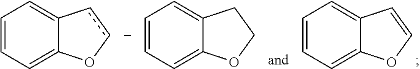

The term “halide” or “halogen” or “halo” as used herein refers to fluorine, chlorine, bromine, and iodine.

The term “sulfonyl” or “sulfone” is used herein to refer to the sulfo-oxo group represented by the formula —S(O)₂Z¹, where Z¹ can be hydrogen, an alkyl, alkenyl, alkynyl, aryl, heteroaryl, cycloalkyl, cycloalkenyl, heterocycloalkyl, or heterocycloalkenyl group described above.

“R¹,” “R²,” “R³,” “Rⁿ,” etc., where n is some integer, as used herein can, independently, possess one or more of the groups listed above. For example, if R¹ is a straight chain alkyl group, one of the hydrogen atoms of the alkyl group can optionally be substituted with a hydroxyl group, an alkoxy group, an amine group, an alkyl group, a halide, and the like. Depending upon the groups that are selected, a first group can be incorporated within the second group or, alternatively, the first group can be pendant (i.e., attached) to the second group. For example, with the phrase “an alkyl group comprising an amino group,” the amino group can be incorporated within the backbone of the alkyl group. Alternatively, the amino group can be attached to the backbone of the alkyl group. The nature of the group(s) that is (are) selected will determine if the first group is embedded or attached to the second group.

Unless stated contrary, a formula with chemical bonds shown only as solid lines and not as wedges or dashed lines contemplates each possible stereoisomer or a mixture of stereoisomer (e.g., each enantiomer, each diastereomer, each meso compound, a racemic mixture, or scalemic mixture).

“Phase,” as used herein, generally refers to a region of a material having a substantially uniform composition which is a distinct and physically separate portion of a heterogeneous system. The term “phase” does not imply that the material making up a phase is a chemically pure substance but merely that the chemical and/or physical properties of the material making up the phase are essentially uniform throughout the material and that these chemical and/or physical properties differ significantly from the chemical and/or physical properties of another phase within the material. Examples of physical properties include density, thickness, aspect ratio, specific surface area, porosity, dimensionality, stretchability, modulus, and ionic conductivity. Examples of chemical properties include chemical composition.

The term “olefinically unsaturated group” or “ethylenically unsaturated group” is employed herein in a broad sense and is intended to encompass any groups containing a carbon-carbon double-bonded group (>C═C< group). Exemplary ethylenically unsaturated groups include, but are not limited to, (meth)acrylate, (meth)acrylamide, (meth)acryloyl, allyl, vinyl, styrenyl, or other >C═C< containing groups.

“Polymer” means a material formed by polymerizing one or more monomers.

The term “(co)polymer” includes homopolymers, copolymers, or mixtures thereof.

The term “(meth)acryl . . . ” includes “acryl . . . ,” “methacryl . . . ,” or mixtures thereof.

The term prepolymer is used herein to refer to a polymer that has reactive groups that are available for bond-forming reactions that will crosslink (intermolecular and/or intramolecular crosslink). It is not meant to imply that the prepolymer is not yet a polymer (e.g., a monomer or polymer precursor). Rather, a ‘prepolymer’ refers to a starting polymer which contains multiple crosslinkable groups and can be cured (e.g., crosslinked) to obtain a crosslinked polymer having a molecular weight higher than the starting polymer.

“Molecular weight” of a polymeric material (including monomeric or macro-monomeric materials), as used herein, refers to the number-average molecular weight as measured by ¹H NMR spectroscopy unless otherwise specifically noted or unless testing conditions indicate otherwise.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements. Furthermore, when numerical ranges of varying scope are set forth herein, it is contemplated that any combination of these values, inclusive of the recited values, may be used.

As used herein, the term “composition” is intended to encompass a product comprising the specified ingredients in the specified amounts, as well as any product which results, directly or indirectly, from a combination of the specified ingredients in the specified amounts.

References in the specification and concluding claims to parts by weight of a particular element or component in a composition denotes the weight relationship between the element or component and any other elements or components in the composition or article for which a part by weight is expressed. Thus, in a mixture containing 2 parts by weight of component X and 5 parts by weight, components Y, X, and Y are present at a weight ratio of 2:5 and are present in such ratio regardless of whether additional components are contained in the mixture.

A weight percent (wt. %) of a component, unless specifically stated to the contrary, is based on the total weight of the formulation or composition in which the component is included.

It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present. Other words used to describe the relationship between elements or layers should be interpreted in a like fashion (e.g., “between” versus “directly between,” “adjacent” versus “directly adjacent,” “on” versus “directly on”). As used herein, the term “and/or” includes any and all combinations of one or more of the associated listed items.

It will be understood that, although the terms “first.” “second,” etc., may be used herein to describe various elements, components, regions, layers, and/or sections. These elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of example embodiments.

As used herein, the term “substantially” means that the subsequently described event or circumstance completely occurs or that the subsequently described event or circumstance generally, typically, or approximately occurs.

Still further, the term “substantially” can in some aspects refer to at least 80%, at least 85%, at least 90%, at least 91%, at least 92%, at least 93%, at least 94%, at least 95%, at least 96%, at least 97%, at least 98%, at least 99%, or 100% of the stated property, component, composition, or other condition for which substantially is used to characterize or otherwise quantify an amount.

In other aspects, as used herein, the term “substantially free,” when used in the context of a composition or component of a composition that is substantially absent, is intended to refer to an amount that is then 1% by weight, e.g., less than 0.5% by weight, less than 0.1% by weight, less than 0.05% by weight, or less than 0.01% by weight of the stated material, based on the total weight of the composition.

In other aspects, as used herein, the term “substantially free,” when used in the context of a surface substantially free of defects or substantially free of dendrites, for example, is intended to refer to a surface that has less than 5% of defects or dendrites, less than 4.5% of defects or dendrites, less than 4% of defects or dendrites, less than 3.5% of defects or dendrites, less than 3% of defects or dendrites, less than 2.5% of defects or dendrites, less than 2% of defects or dendrites, less than 1.5% of defects or dendrites, less than 1% of defects or dendrites, less than 0.5% of defects or dendrites, less than 0.1% of defects or dendrites, less than 0.05% of defects, or less than 0.01% of defects or dendrites of the total surface.

While aspects of the present invention can be described and claimed in a particular statutory class, such as the system statutory class, this is for convenience only and one of ordinary skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is in no way intended that an order be inferred in any respect. This holds for any possible non-express basis for interpretation, including matters of logic with respect to arrangement of steps or operational flow, plain meaning derived from grammatical organization or punctuation, or the number or type of aspects described in the specification.

The present invention may be understood more readily by reference to the following detailed description of various aspects of the invention and the examples included therein and to the Figures and their previous and following description.

### Compositions

As described above, in some aspects disclosed herein is a composition comprising: a) a matrix comprising an fluorinated elastomeric polymer; b) a plurality of plastic crystals dispersed within the matrix to form a three-dimensional interconnected phase of plastic crystals that is separate and distinct from the fluorinated elastomeric phase, and wherein the composition exhibits an ionic conductivity of at least 1.1 mS/cm at 20° C.

The composition is multiphasic, including a first phase including a fluorinated elastomeric polymer, and a second phase including a plurality of plastic crystals. Due the multiphase nature of the composition, ionic conductivity is enhanced as ion transport through the plastic crystal is improved relative to homogeneous compositions in which plastic crystals are homogenously distributed through the matrix polymer, i.e., elastomeric polymer. The fluorinated elastomeric polymer expectedly permits formation of the multiphase composition.

In some implementations of the disclosure, the fluorinated elastomeric polymer is a crosslinked fluorinated elastomeric polymer. In other implementations, the fluorinated elastomeric polymer is not crosslinked. Unless a given fluorinated elastomeric polymer is specifically identified as uncrosslinked or crosslinked, reference to a fluorinated elastomeric polymer is intended to cover both crosslinked and uncrosslinked species.

In certain implementations, the fluorinated elastomeric polymer is present in an amount from 5-80 vol. %, from 10-80 vol. %, from 20-80 vol. %, from 30-80 vol. %, from 50-80 vol. %, from 60-80 vol. %, from 30-70 vol. %, from 30-60 vol. %, from 30-50 vol. %, from 30-40 vol. %, from 35-45 vol. %, from 40-60 vol. %, from 44-55 vol. %, from 5-50 vol. %, from 5-40 vol. %, from 5-30 vol. %, from 5-20 vol. %, from 5-10 vol. %, from 10-50 vol. %, from 10-40 vol. %, from 10-30 vol. %, from 10-20 vol. %, from 20-50 vol. %, from 20-40 vol. %, or from 20-30 vol. % of the composition.

In certain implementations, the plurality of plastic crystals is present in an amount from 20-95 vol. %, from 30-95 vol. %, from 40-95 vol. %, from 50-95 vol. %, from 60-95 vol. %, from 70-95 vol. %, from 80-95 vol. %, from 20-85 vol. %, from 30-85 vol. %, from 40-85 vol. %, from 50-85 vol. %, from 60-85 vol. %, from 70-85 vol. %, from 80-85 vol. %, from 20-75 vol. %, from 30-75 vol. %, from 40-75 vol. %, from 50-75 vol. %, from 60-75 vol. %, from 70-75 vol. %, from 20-65 vol. %, from 30-65 vol. %, from 40-65 vol. %, from 50-65 vol. %, from 60-65 vol. %, from 20-55 vol. %, from 30-55 vol. %, from 40-55 vol. %, from 50-55 vol. %, from 20-45 vol. %, from 30-45 vol. %, from 40-45 vol. %, from 20-35 vol. %, from 30-35 vol. %, or from 20-25 vol. %, of the composition.

In some aspects, the composition disclosed herein can exhibit an ionic conductivity from 1.0 mS/cm to 10 mS/cm, including exemplary values of 1.5 mS/cm, 2.0 mS/cm, 2.5 mS/cm, 3.0 mS/cm, 3.5 mS/cm, 4.0 mS/cm, 4.5 mS/cm, 5.0 mS/cm, 5.5 mS/cm, 6.0 mS/cm, 6.5 mS/cm, 7.0 mS/cm, 7.5 mS/cm, 8.0 mS/cm, 8.5 mS/cm, 9.0 mS/cm, and 9.5 mS/cm. In still further aspects, the composition disclosed herein can exhibit an ionic conductivity greater than 1 mS/cm, greater than 1.1 mS/cm, greater than 1.2 mS/cm, greater than 1.3 mS/cm, greater than 1.4 mS/cm, greater than 1.5 mS/cm, greater than 1.6 mS/cm, greater than 1.7 mS/cm, greater than 1.8 mS/cm, greater than 1.9 mS/cm, greater than 2.0 mS/cm, greater than 2.1 mS/cm, greater than 2.2 mS/cm, greater than 2.3 mS/cm, greater than 2.4 mS/cm, greater than 2.5 mS/cm, greater than 2.6 mS/cm, greater than 2.7 mS/cm, greater than 2.8 mS/cm, greater than 2.9 mS/cm, greater than 3.0 mS/cm, greater than 3.1 mS/cm, greater than 3.2 mS/cm, greater than 3.3 mS/cm, greater than 3.4 mS/cm, greater than 3.5 mS/cm, greater than 3.6 mS/cm, greater than 3.7 mS/cm, greater than 3.8 mS/cm, greater than 3.9 mS/cm, or even greater than 4.0 mS/cm. In yet still further aspects, the ionic conductivity of the disclosed herein polymer can be also greater than 5.0 mS/cm.

In some aspects of the invention, the plurality of plastic crystals is present in the composition in a volume that is greater than the fluorinated elastomer.

In certain implementations, the plurality of plastic crystals is present in the composition in a volume that is from 1-25%, from 1-20%, from 1-15%, from 1-10%, from 1-5%, from 1-2.5%, from 2.5-25%, from 2.5-20%, from 2.5-15, from 2.5-10%, from 2.5-5%, from 5-25%, from 5-20%, from 5-15%, from 5-10%, from 10-25%, from 10-20%, from 10-15%, from 15-25%, or from 15-20% greater than the volume of the fluorinated elastomeric polymer. In some implementations, the plurality of plastic crystals is present in an volume that is at least 25% greater, at least 35% greater, at least 45% greater, or at least 50% greater than the fluorinated elastomer.

In some implementations, the fluorinated elastomeric polymer is present in an amount from 5-80 wt. %, from 10-80 wt. %, from 20-80 wt. %, from 30-80 wt. %, from 50-80 vol. %, from 60-80 wt. %, from 30-70 wt. %, from 30-60 wt. %, from 30-50 wt. %, from 30-40 wt. %, from 35-45 wt. %, from 40-60 wt. %, from 44-55 wt. %, from 5-50 wt. %, from 5-40 wt. %, from 5-30 wt. %, from 5-20 wt. %, from 5-10 wt. %, from 10-50 wt. %, from 10-40 wt. %, from 10-30 wt. %, from 10-20 wt. %, from 20-50 wt. %, from 20-40 wt. %, or from 20-30 wt. % of the composition.

In certain implementations, the plurality of plastic crystals is present in an amount from 20-95 wt. %, from 30-95 wt. %, from 40-95 wt. %, from 50-95 wt. %, from 60-95 wt. %, from 70-95 wt. %, from 80-95 wt. %, from 20-85 wt. %, from 30-85 wt. %, from 40-85 wt. %, from 50-85 wt. %, from 60-85 wt. %, from 70-85 wt. %, from 80-85 wt. %, from 20-75 wt. %, from 30-75 wt. %, from 40-75 wt. %, from 50-75 wt. %, from 60-75 wt. %, from 70-75 wt. %, from 20-65 wt. %, from 30-65 wt. %, from 40-65 wt. %, from 50-65 wt. %, from 60-65 wt. %, from 20-55 wt. %, from 30-55 wt. %, from 40-55 wt. %, from 50-55 wt. %, from 20-45 wt. %, from 30-45 wt. %, from 40-45 wt. %, from 20-35 wt. %, from 30-35 wt. %, or from 20-25 wt. %, of the composition.

In some implementations, the plurality of plastic crystals is present in the composition in a weight that is greater than the fluorinated elastomer.

In certain implementations, the plurality of plastic crystals is present in a weight that is from 1-25%, from 1-20%, from 1-15%, from 1-10%, from 1-5%, from 1-2.5%, from 2.5-25%, from 2.5-20%, from 2.5-15, from 2.5-10%, from 2.5-5%, from 5-25%, from 5-20%, from 5-15%, from 5-10%, from 10-25%, from 10-20%, from 10-15%, from 15-25%, or from 15-20% greater than the weight of the fluorinated elastomeric polymer. In some implementations, the plurality of plastic crystals is present in an amount that is at least 25% greater, at least 35% greater, at least 45% greater, or at least 50% greater than the fluorinated elastomer.

In some implementations, the fluorinated elastomeric polymer is derived from a mixture comprising a compound of Formula (I):

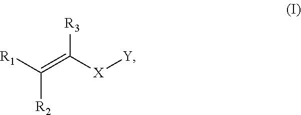

wherein R₁, R₂, and R₃ each is independently selected from hydrogen, C₁₋₁₂ alkyl, C₁₋₁₂ alkoxyl, C₁₋₁₂ heteroalkyl, —(C₀₋₅ alkylene)(C₆₋₁₄ aryl), —(C₀₋₅ alkylene)(C₁₋₁₃ heteroaryl), —(C₀₋₅ alkylene)(C₆₋₁₄ aryloxy), —(C₀₋₅ alkylene)(C₃₋₁₀ cycloalkyl), —(C₀₋₅ alkylene)(C₃₋₁₀ heterocycloalkyl), —(C₀₋₅ alkylene)(C₃₋₁₀cycloalkenyl), —(C₀₋₅ alkylene)(C₃₋₁₀ heterocycloalkenyl), halo, amine; wherein R₁ and R₂ each is independently and optionally substituted with one or more of C₁₋₁₂ alkyl, C₁₋₁₂ alkoxy, C₁₋₁₂ heteroalkyl, —(C₀₋₅ alkylene-)(C₆₋₁₄ aryl), —(C₀₋₅ alkylene)(C₁₋₁₃ heteroaryl), —(C₀₋₅ alkylene)(C₈₋₁₄ aryloxy), —(C₀₋₅ alkyl)(C₃₋₁₀ cycloalkyl), —(C₀₋₅ alkylene)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), aldehyde, amino, carbonyl, ester, ketone, ether, halo, carboxyl, hydroxy, nitro, sulfo-oxo, sulfonyl, sulfone, sulfoxide, thiol, or phosphonyl,
X is C(═O), C(═O)O, C(═O)NH, or null,
Y is R₄CF₃;
wherein R₄ is selected from C₁₋₂₀ alkylene, C₂₋₂₀ alkenylene, C₂₋₂₀ alkynylene, C₁₋₂₀ alkoxylene, C₁₋₂₀ heteroalkylene. C₂₋₂₀ heteroalkenylene, C₂₋₂₀ heteroalkynylene, —(C₀₋₅ alkylene)(C₆₋₁₄ aryl), —(C₀₋₅ alkylene)(C₁₋₁₃ heteroaryl), —(C₀₋₅ alkylene)(C₆₋₁₄ aryloxy), —(C₀₋₅ alkylene)(C₃₋₁₀ cycloalkyl), —(C₀₋₅ alkylene)(C₃₋₁₀ heterocycloalkyl), —(C₀₋₅ alkylene)(C₃₋₁₀ cycloalkenyl), —(C₀₋₅ alkylene)(C₃₋₁₀ heterocycloalkenyl), (—O—CH₂—CH₂—)ₙ, (O—CH₂—CF₂—), amine; wherein R₄ is independently and optionally substituted with one or more of C₁₋₂₀ alkyl, C₂₋₂₀ alkenyl. C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkylene)(C₆-C₁₄ aryl), —(C₀₋₅ alkylene)(C₁-C₁₃ heteroaryl), —(C₀₋₅ alkyl-ene)(C₆-C₁₄ aryloxy), —(C₀₋₅ alkylene)(C₃-C₁₀ cycloalkyl), —(C₀₋₅ alkylene)(C₃-C₁₀ heterocycloalkyl), —(C₀₋₅ alkylene)(C₃-C₁₀ cycloalkenyl), —(C₀₋₅ alkylene)(C₃-C₁₀ heterocycloalkenyl), aldehyde, amino, carbonyl, ester, ketone, ether, halo, carboxyl, hydroxy, nitro, sulfo-oxo, sulfonyl, sulfone, sulfoxide, thiol, or phosphonyl; and
wherein n is 1 to 200.

In certain implementations of the compound of Formula (1) R₁ and R₂ are each hydrogen.

In certain implementations of the compound of Formula (1) R₃ is hydrogen or methyl.

In certain implementations of the compound of Formula (1) X is C(O)O.

In some implementations of the compound of Formula (1) R₁ and R₂ are each hydrogen, X is C(O), and R₃ is hydrogen, and the compound of Formula (1) is a compound of Formula (1-a):

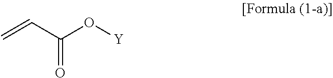

In some implementations of the compound of Formula (1) R₁ and R₂ are each hydrogen, X is C(O)O, and R₉ is methyl, and the compound of Formula (1) is a compound of Formula (1-m).

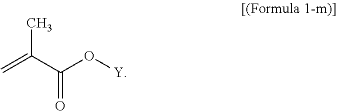

In certain implementations of the compound of Formula (1), and especially of the compounds of Formula (1-a) and Formula (1-m), Y is C₁₋₂₀ alkylene, optionally substituted one or more times by halo.

In certain implementations of the compound of Formula (1), and especially of the compounds of Formula (1-a) and Formula (1-m), Y is C₁₋₂₀ alkylene, optionally substituted one or more times by fluoro (F).

In certain implementations of the compound of Formula (1), and especially of the compounds of Formula (1-a) and Formula (1-m), Y is C₁₋₁₄ alkylene, optionally substituted one or more times by F.

In certain implementations of the compound of Formula (1), and especially of the compounds of Formula (1-a) and Formula (1-m), Y is C₁₋₂ alkylene, optionally substituted one or more times by F.

In certain implementations, the compound of Formula (1) is a compound of Formula (1-a) and has the structure:

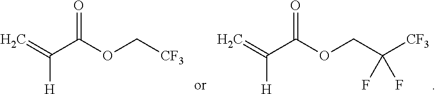

In certain implementations, the compound of Formula (1) is a compound of Formula (1-m) and has the structure:

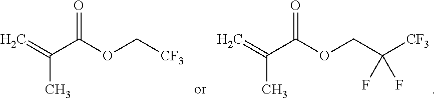

The fluorinated elastomeric polymer can be derived from a mixture that, in addition to one or compounds of Formula (1), can also include one or more crosslinker compounds (or, simply, crosslinker). In certain implementations, the crosslinker compound can be a compound having two or more crosslinkable functional groups, for example two or more (meth)acrylates, vinyl, or allyl functional groups. In some implementations the crosslinker can be one or more bis(meth)acrylates, bis(meth)acrylamides, divinyl compounds, or diallyl compounds. In certain implementations the crosslinker is a tri(meth)acrylate or a tetra(meth)acrylate.

In certain implementations the crosslinker is poly(ethylene glycol) diacrylate.

In certain implementations, the crosslinker can be methylene bisacrylamide, ethylene glycol dimethacrylate, tetraethylene glycol dimethacrylate, trimethylolpropane trimethacrylate, ethoxylated trimethylol triacrylate, ethoxylated pentaerythritol tetracrylate, glycol (PEG)-thiol/PEG-acrylate, acrylamide/N,N′-bis(acryloyl)cystamine (BACy), (meth)acrylate-oligolactide-PEO-oligolactide (meth)acrylate, N,N′ bis(acryloyl)cystamine, bisacrylamide, diacrylate, diallylamine, triallylamine, divinyl sulfone, diallylether, diethylene glycol diallyl ether, ethylene glycol diacrylate, poly(ethylene glycol) diacrylate, 1,4-phenylenediacryloyl chloride, 1,3 butadiene, 1,4 pentadiene, 1,5 hexadiene, 1,4-divinylbenzene, or a combination thereof.

In certain implementations, the crosslinker is a compound having the formula.

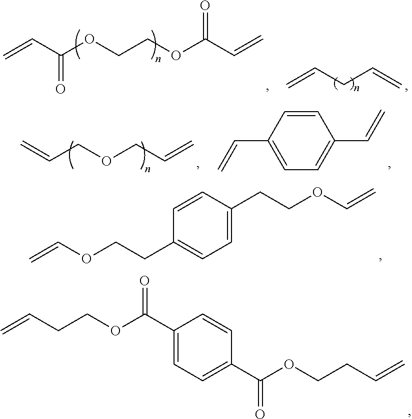

or a combination thereof, wherein n is from 1 to 30.

The crosslinker compound can be combined with the compound of Formula (1) in an amount from 0.1-5 mol %, from 0.25-5 mol %, from 0.5-5 mol %, from 1-5 mol %, from 2-5 mol %, from 3-5 mol %, from 3-4 mol %, from 0.1-0.25 mol %, from 0.1-0.5 mol %, from 0.5-0.75 mol %, from 0.5-1 mol %, from 0.5-1.5 mol %, from 1-2 mol %, from 1.5-2.5 mol %, from 1-3 mol %, from 2-4 mol %, from 2.5-5 mol %, relative to the compound of Formula (1).

The composition includes the plurality of plastic crystals. It is understood that the term plastic crystal refers to a crystal composed of weakly interacting molecules that possess some orientational and conformational degree of freedom. Plastic crystals can be considered a soft matter. Without wishing to be bound by any theory, it is understood that the plastic crystal exhibit strong long-range order.

In certain aspects, any known in the art plastic crystals suitable for the desired application can be used. In still further aspects, the plastic crystals can be selected from

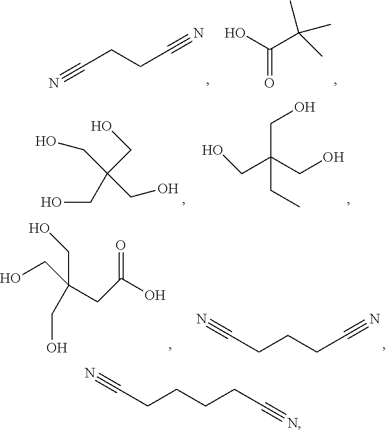

or a combination thereof.

In still further aspects, the compositions disclosed herein can comprise a metal salt including a cation and anion. It is understood that any metal salts suitable for the desired applications can be used. For example, in some aspects, the metal salts are alkali metal salts. Yet, in other aspects, the metal salts are alkaline-earth metal salts. Yet, in still further aspects, the metal salts can comprise post-transition metal salts. Yet, in still further aspects, the metal salts can comprise transition metal salts. In still further aspects, the metal salts can comprise any combination of any of the disclosed above metal salts.

In still further aspects, the composition can include a metal salt having a cation that is Li, K, Na, Ca, Mg, Zn, Al, or a combination thereof.

In still further aspects, an anion of the disclosed herein metal salts can include any anion that is suitable for the desired application. For example, the anion can be halide. In such aspects, halide can be I⁻, Cl⁻, Br⁻, or F⁻. In still further aspects, the anion can be bistriflimide (TFSI⁻), bis(fluorosulfonyl)imide) (FSI⁻), triflate (OTf⁻), hexafluorophosphate (PF₆⁻), hexafluoroarsenate (AsF₆⁻), aluminum tetrachloride (AlCl₄⁻), boron tetrachloride (BCl₄⁻), boron tetrafluoride (BF₄⁻), iodide (I⁻), chlorate (ClO₃⁻), bromate (BrO₃⁻) iodate (IO₃⁻) difluoro(oxalato)borate (DFOB⁻), bis(oxalato)borate (BOB⁻), difluorophosphate (DFP), or a combination thereof.

In still further aspects, the metal salts can be present in an amount from 0 wt. % to 70 wt. %, including exemplary values of 0.01 wt. %, 0.05 wt. %, 0.1 wt. %, 0.5 wt. %, 1 wt. %, 5 wt. %, 10 wt. %, 15 wt. %, 20 wt. %, 25 wt. %, 30 wt. %, 35 wt. %, 40 wt. %, 45 wt. %, 50 wt. %, 55 wt. %, 60 wt. %, 65 wt. %, and 66.9 wt. % of the composition.

In some implementations, the metal salt is present in a concentration from 0-10 M, from 1-10 M, from 2-10 M, from 3-10 M, from 4-10 M, from 5-10 M, from 6-10 M, from 7-10 M, from 8-10 M, from 9-10 M, from 1-8 M, from 2-8 M, from 3-8 M, from 4-8 M, from 5-8 M, from 6-8 M, from 7-8 M, from 1-6 M, from 2-6 M, from 3-6 M, from 4-6 M, from 5-6 M, from 1-4 M, from 2-4 M, from 3-4 M, from 1-3 M, from 2-3 M, or from 1-2 M.

In some implementations, the metal salt is present in a concentration from 0.1-25 wt. %, from 1-25 wt. %, from 2.5-25 wt. %, from 5-25 wt. %, from 7.5-25 wt. %, from 10-25 wt. %, from 12.5-25 wt. %, from 15-25 wt. %, from 17.5-25 wt. %, from 20-25 wt. %, 0.1-20 wt. %, from 1-20 wt. %, from 2.5-20 wt. %, from 5-20 wt. %, from 7.5-20 wt. %, from 10-20 wt. %, from 12.5-20 wt. %, from 15-20 wt. %, from 17.5-20 wt. %, from 0.1-17.5 wt. %, from 1-17.5 wt. %, from 2.5-17.5 wt. %, from 5-17.5 wt. %, from 7.5-17.5 wt. %, from 10-17.5 wt. %, from 12.5-17.5 wt. %, from 15-17.5 wt. %, from 0.1-15 wt. %, from 1-15 wt. %, from 2.5-15 wt. %, from 5-15 wt. %, from 7.5-15 wt. %, from 10-15 wt. %, from 12.5-15 wt. %, from 0.1-12.5 wt. %, from 1-12.5 wt. %, from 2.5-12.5 wt. %, from 5-12.5 wt. %, from 7.5-12.5 wt. %, from 10-12.5 wt. %, from 0.1-10 wt. %, from 1-10 wt. %, from 2.5-10 wt. %, from 5-10 wt. %, from 7.5-10 wt. %, from 0.1-7.5 wt. %, from 1-7.5 wt. %, from 2.5-7.5 wt. %, from 5-7.5 wt. %, from 0.1-5 wt. %, from 1-5 wt. %, from 2.5-5 wt. %, from 0.1-2.5 wt. %, from 1-2.5 wt. %., or from 0.1-1 wt. %, relative to the composition.
from 0.1-25 wt. %, from 0.1-25 wt. %, from 0.1-25 wt. %, from 0.1-25 wt. %, from 0.1-25 wt. %, or from 1-2 M

In still further aspects, the composition disclosed herein is crosslinked. It is understood that the crosslinking can be covalent or ionic, or both. In yet still further aspects, the crosslinking can be achieved by any known in the art methods that are also discussed in more detail below. In some aspects, the crosslinking of the disclosed herein polymer can be achieved by adding a crosslinker during the polymerization process. In yet other aspects, crosslinking can be achieved by irradiation. In such aspects, irradiation can include IR, UV, or e-beam polymerization. In still further aspects, the crosslinking can be achieved by both adding the crosslinker and irradiating the formed polymer. In yet other aspects, crosslinking can be achieved by a thermal initiation.

In still further aspects, the compositions disclosed herein exhibit elastomeric properties. For example, and without limitations, the composition can have a tensile strength from 150% to 500%, including exemplary values of 175%, 200%, 225%, 250%, 275%, 300%, 325%, 350%, 375%, 400%, 425%, 450%, and 475%.

In some implementations, the composition can exhibit at elongation at break of at least 100%, at least 150%, at least 200%, at least 250%, at least 300%, at least 350%, at least 400%, at least 450%, at least 500%, at least 550%, at least 600%, at least 650%, at least 700%, or at least 750%.

In still further aspects, the composition described herein can exhibit flame retardant properties.

In still further aspects, the composition is stable in a temperature range from −30° C. to 100° C., including exemplary values of −25° C., −20° C., −15° C., −10° C., −5° C., 0° C., 5° C., 10° C., 15° C., 20° C., 25° C., 30° C., 35° C., 40° C., 45° C., 50° C., 55° C., 60° C., 65° C., 70° C., 75° C., 80° C., 85° C., 90° C., and 95° C. It is understood that the term “stable” as disclosed herein indicates that the composition retains its properties in the disclosed range of temperatures. For example, it does not undergo any degradation or change in the disclosed electrical and mechanical properties. It is understood that the term “stable” Implies that the composition can be used for its intended purpose, whether due to its electrical properties or mechanical properties in the disclosed range, without any limitations or substantial changes in performance.

In still further aspects, the compositions disclosed herein exhibit an ion transference number of the cation of any of the disclosed above metal salts to be greater than 0.4, or greater than 0.45, or greater than 0.5, or greater than 0.6, or greater than 0.7, or greater than 0.8. For example, the ion transference number of the cation can be anywhere between 0.4 to 0.8, including exemplary values of 0.42, 0.45, 0.47, 0.5, 0.52, 0.55, 0.57, 0.6, 0.62, 0.65, 0.67, 0.7, 0.72, 0.75, and 0.77. It is understood that the specific ion transference number will depend on the specific cation. For example, and without limitations, the compositions disclosed herein exhibit Li-ion transference numbers from 0.7 to 0.75, including exemplary numbers of 0.71, 0.72, 0.73, and 0.74.

In some implementations, the composition can have a ion transference number, including a lithium ion transference number, greater than 0.25, greater than 0.3, greater than 0.35, greater than 0.4, greater than 0.45, greater than 0.5, greater than 0.55, greater than 0.6, greater than 0.65, greater than 0.7, or greater than 0.75.

The multiplasic nature of the composition results in non-homogeneous distribution of cationic species throughout the composition. In certain implementations, the concentration of cationic species is higher in the interconnected plastic crystal phase relative to the fluorinated elastomeric polymer phase. Because the fluorinated elastomeric polymer and interconnected plastical crystal phase have different chemical properties, cationic species disposed within each can be distinguished using analytical techniques such as NMR spectroscopy. The relative proportion of cationic species in each phase can be determined by integration of the relative NMR peaks.

In some implementations, at least 75%, at least 80%, at least 85%, at least 90%, at least 95%, or at least 99% of the cations are in the interconnected phase of plastic crystals.

In certain implementations, the composition includes a lithium salt, and at least 75%, at least 80%, at least 85%, at least 90%, at least 95%, or at least 99% of the lithium ions are in the interconnected phase of plastic crystals.

In still further aspects, the compositions disclosed herein can be used as solid electrolytes, ionic conductors, actuators, sensors, capacitors, or a combination thereof. In still further aspects, the compositions disclosed herein can be used in solar cells, supercapacitors, fuel cells, Li—S batteries, Na—S batteries, Li-air batteries, Na-air batteries, Zn-air batteries, or any batteries disclosed herein.

Also disclosed herein are compositions that are formed by polymerizing a mixture comprising:
a) a salt comprising a cation and an anion;
b) a plurality of plastic crystals; and
c) a compound of Formula (I):

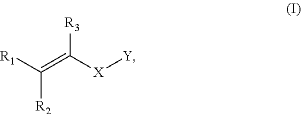

wherein R₁, R₂, and R₃ each is independently selected from hydrogen, C₁₋₁₂ alkyl, C₁₋₁₂ alkoxyl, C₁₋₁₂ heteroalkyl, —(C₀₋₅ alkylene(C₆₋₁₄ aryl), —(C₀₋₅ alkylene)(C₁₋₁₃ heteroaryl), —(C₀₋₅ alkylene)(C₆₋₁₄ aryloxy), —(C₀₋₅ alkylene)(C₃₋₁₀ cycloalkyl), —(C₀₋₅ alkylene)(C₃₋₁₀ heterocycloalkyl), —(C₀₋₅ alkylene)(C₃₋₁₀ cycloalkenyl), —(C₀₋₅ alkyl-ene)(C₃₋₁₀ heterocycloalkenyl), halo, amine; wherein R₁ and R₂ each is independently and optionally substituted with one or more of C₁₋₁₂ alkyl, C₁₋₁₂ alkoxy, C₁₋₁₂ heteroalkyl, —(C₀₋₅ alkylene)(C₆₋₁₄ aryl), —(C₀₋₅ alkylene)(C₁₋₁₃ heteroaryl), —(C₀₋₅ alkylene)(C₆₋₁₄ aryloxy), —(C₀₋₅ alkyl)(C₃₋₁₀ cycloalkyl), —(C₀₋₅ alkylene)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), aldehyde, amino, carbonyl, ester, ketone, ether, halo, carboxyl, hydroxy, nitro, sulfo-oxo, sulfonyl, sulfone, sulfoxide, thiol, or phosphonyl,
X is C(═O), C(═O)O, C(═O)NH, or null,
Y is R₄CF₃;
wherein R₄ is selected from C₁₋₂₀ alkylene, C₂₋₂₀ alkenylene, C₂₋₂₀ alkynylene, C₁₋₂₀ alkoxylene, C₁₋₂₀ heteroalkylene, C₂₋₂₀ heteroalkenylene, C₂₋₂₀ heteroalkynylene, —(C₀₋₅ alkylene)(C₆₋₁₄ aryl), —(C₀₋₅ alkylene)(C₁₋₁₃ heteroaryl), —(C₀₋₅ alkylene)(C₆₋₁₄ aryloxy), —(C₀₋₅ alkylene)(C₃₋₁₀ cycloalkyl), —(C₀₋₅ alkylene)(C₃₋₁₀ heterocycloalkyl), —(C₀₋₅ alkylene)(C₃₋₁₀ cycloalkenyl), —(C₀₋₅ alkylene)(C₃₋₁₀ heterocycloalkenyl), (—O—CH₂—CH₂—)ₙ, (O—CH₂—CF₂—), amine; wherein R₄ is independently and optionally substituted with one or more of C₁₋₂₀ alkyl, C₂₋₂₀ alkenyl, C₂₋₂₀ alkynyl. C₁₋₂₀ alkoxy, C₁₋₂₀ heteroalkyl, C₂₋₂₀ heteroalkenyl, C₂₋₂₀ heteroalkynyl, —(C₀₋₅ alkylene)(C₆-C₁₄ aryl), —(C₀₋₅ alkylene)(C₁-C₁₃ heteroaryl), —(C₀₋₅ alkylene)(C₆-C₁₄ aryloxy), —(C₀₋₅ alkyl-ene)(C₃-C₁₀ cycloalkyl), —(C₀₋₅ alkylene)(C₃-C₁₀ heterocycloalkyl), —(C₀₋₅ alkylene)(C₃-C₁₀, cycloalkenyl), —(C₀₋₅ alkylene)(C₃-C₁₀ heterocycloalkenyl), aldehyde, amino, carbonyl, ester, ketone, ether, halo, carboxyl, hydroxy, nitro, sulfo-oxo, sulfonyl, sulfone, sulfoxide, thiol, or phosphonyl; and
wherein n is 1 to 200.

In certain implementations of the compound of Formula (1) R₁ and R₂ are each hydrogen.

In certain implementations of the compound of Formula (1) R₃ is hydrogen or methyl.

In certain implementations of the compound of Formula (1) X is C(O)O.

In some implementations of the compound of Formula (1) R₁ and R₂ are each hydrogen, X is C(O), and R₃ is hydrogen, and the compound of Formula (1) is a compound of Formula (1-a):

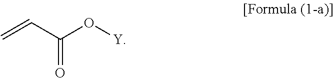

In some implementations of the compound of Formula (1) R₁ and R₂ are each hydrogen, X is C(O)O, and R₃ is methyl, and the compound of Formula (1) is a compound of Formula (1-m):

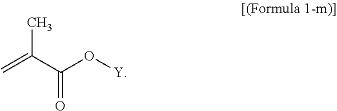

In certain implementations of the compound of Formula (1), and especially of the compounds of Formula (1-a) and Formula (1-m), Y is C₁₋₂₀ alkylene, optionally substituted one or more times by halo.

In certain implementations of the compound of Formula (1), and especially of the compounds of Formula (1-a) and Formula (1-m), Y is C₁₋₂₀ alkylene, optionally substituted one or more times by fluoro (F).

In certain implementations of the compound of Formula (1), and especially of the compounds of Formula (1-a) and Formula (1-m). Y is C₁₋₄ alkylene, optionally substituted one or more times by F.

In certain implementations of the compound of Formula (1), and especially of the compounds of Formula (1-a) and Formula (1-m). Y is C₁₋₂ alkylene, optionally substituted one or more times by F.

In certain implementations, the compound of Formula (1) is a compound of Formula (1-a) and has the structure:

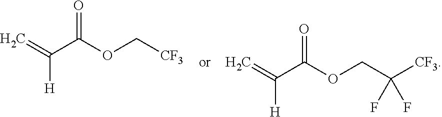

In certain implementations, the compound of Formula (1) is a compound of Formula (1-m) and has the structure:

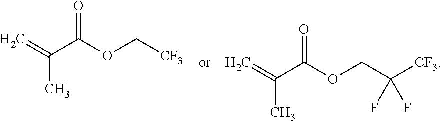

The mixture can also include one or more crosslinker compounds (or, simply, crosslinker). In certain implementations, the crosslinker compound can be a compound having two or more crosslinkable functional groups, for example two or more (meth)acrylates, vinyl, or allyl functional groups. In some implementations the crosslinker can be one or more bis(meth)acrylates, bis(meth)acrylamides, divinyl compounds, or diallyl compounds. In certain implementations the crosslinker is a tri(meth)acrylate or a tetra(meth)acrylate.

In certain implementations the crosslinker is poly(ethylene glycol) diacrylate.

In certain implementations, the crosslinker can be methylene bisacrylamide, ethylene glycol dimethacrylate, tetraethylene glycol dimethacrylate, trimethylolpropane trimethacrylate, ethoxylated trimethylol triacrylate, ethoxylated pentaerythritol tetracrylate, glycol (PEG)-thiol/PEG-acrylate, acrylamide/N,N′-bis(acryloyl)cystamine (BACy), (meth)acrylate-oligolactide-PEO-oligolactide (meth)acrylate, N,N′ bis(acryloyl)cystamine, bisacrylamide, diacrylate, diallylamine, triallylamine, divinyl sulfone, diallylether, diethylene glycol diallyl ether, ethylene glycol diacrylate, poly(ethylene glycol) diacrylate, 1,4-phenylenediacryloyl chloride, 1,3 butadiene, 1,4 pentadiene, 1.5 hexadiene, 1,4-divinylbenzene, or a combination thereof.

In certain implementations, the crosslinker is a compound having the formula

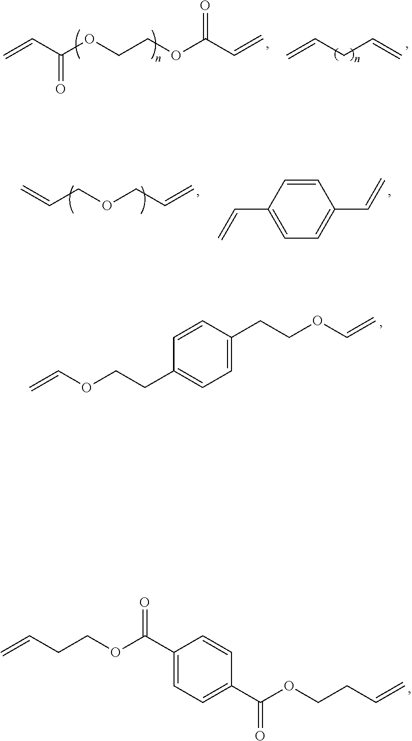

or a combination thereof, wherein n is from 1 to 30.

The crosslinker compound can be present in the mixture in an amount from 0.1-5 mol %, from 0.25-5 mol %, from 0.5-5 mol %, from 1-5 mol %, from 2-5 mol %, from 3-6 mol %, from 3-4 mol %, from 0.1-0.25 mol %, from 0.1-0.5 mol %, from 0.5-0.75 mol %, from 0.5-1 mol %, from 0.5-1.5 mol %, from 1-2 mol %, from 1.5-2.5 mol %, from 1-3 mol %, from 2-4 mol %, from 2.5-5 mol %, relative to the compound of Formula (1).

The mixture can include a plurality of plastic crystals comprise a compound having the formula:

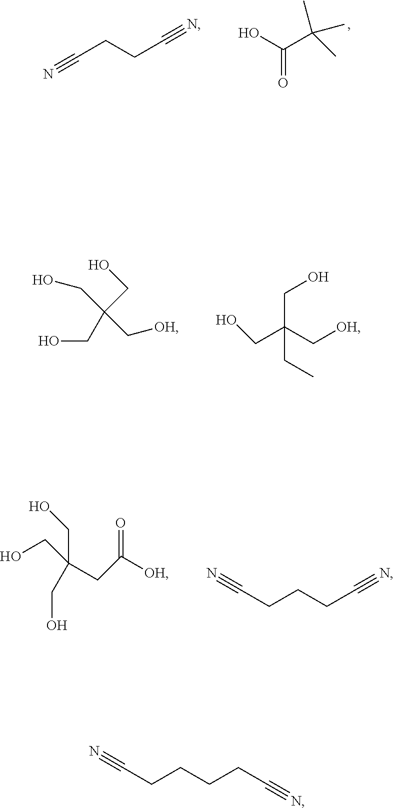

a combination thereof.

The metal salt can include a cation such as L, K, Na, Ca, Mg, Zn, Al, or a combination thereof.

The metal salt can include an anion such as bistriflimide (TFSI⁻), bis(fluorosulfonyl)imide) (FSI⁻), triflate (OTf⁻), hexafluorophosphate (PF₆⁻), hexafluoroarsenate (AsF₆⁻), aluminum tetrachloride (AlCl₄⁻), boron tetrachloride (BCl₄⁻), boron tetrafluoride (BF₄⁻), iodide (I⁻), chlorate (ClO₃⁻), bromate (BrO₃⁻), iodate (IO₃⁻), difluoro(oxalato)borate (DFOB⁻), bis(oxalato)borate (BOB⁻), difluorophosphate (DFP) or a combination thereof.

The compound of Formula (1) can be present in the mixture in an amount from 5-80 vol. %, from 10-80 vol. %, from 20-80 vol. %, from 30-80 vol. %, from 50-80 vol. %, from 60-80 vol. %, from 30-70 vol. %, from 30-60 vol. %, from 30-50 vol. %, from 30-40 vol. %, from 35-45 vol. %, from 40-60 vol. %, from 44-55 vol. %, from 5-50 vol. %, from 5-40 vol. %, from 5-30 vol. %, from 5-20 vol. %, from 5-10 vol. %, from 10-50 vol. %, from 10-40 vol. %, from 10-30 vol. %, from 10-20 vol. %, from 20-50 vol. %, from 20-40 vol. %, or from 20-30 vol. %.

The plurality of plastic crystals can be present in the mixture an amount from 20-95 vol. %, from 30-95 vol. %, from 40-95 vol. %, from 50-95 vol. %, from 60-95 vol. %, from 70-95 vol. %, from 80-95 vol. %, from 20-85 vol. %, from 30-85 vol. %, from 40-85 vol. %, from 50-85 vol. %, from 60-85 vol. %, from 70-85 vol. %, from 80-85 vol. %, from 20-75 vol. %, from 30-75 vol. %, from 40-75 vol. %, from 50-75 vol. %, from 60-75 vol. %, from 70-75 vol. %, from 20-65 vol. %, from 30-65 vol. %, from 40-65 vol. %, from 50-65 vol. %, from 60-65 vol. %, from 20-55 vol. %, from 30-55 vol. %, from 40-55 vol. %, from 50-55 vol. %, from 20-45 vol. %, from 30-45 vol. %, from 40-45 vol. %, from 20-35 vol. %, from 30-35 vol. %, or from 20-25 vol. %.

In certain aspects, the plurality of plastic crystals can be present in a greater volume than the compound of Formula (1). In certain implementations, the plurality of plastic crystals is present in the mixture in a volume that is from 1-25% greater, from 1-20% greater, from 1-15%, greater from 1-10% greater from 1-5%, greater from 1-2.5%, from 2.5-25% greater, from 2.5-20% greater, from 2.5-15%, greater from 2.5-10% greater from 2.5-5%, from 5-25% greater, from 5-20% greater, from 5-15%, greater from 5-10% greater, from 10-25% greater, from 10-20% greater, from 10-15%, from 15-25% greater, from 15-20% greater, at least 25% greater, at least 35% greater, at least 45% greater, or at least 50% greater, than the fluorinated elastomer.

The compound of Formula (1) can be present in the mixture in an amount from 5-80 wt. %, from 10-80 wt. %, from 20-80 wt. %, from 30-80 wt. %, from 50-80 vol. %, from 60-80 wt. %, from 30-70 wt. %, from 30-60 wt. %, from 30-50 wt. %, from 30-40 wt. %, from 35-45 wt. %, from 40-60 wt. %, from 44-55 wt. %, from 5-50 wt. %, from 5-40 wt. %, from 5-30 wt. %, from 5-20 wt. %, from 5-10 wt. %, from 10-50 wt. %, from 10-40 wt. %, from 10-30 wt. %, from 10-20 wt. %, from 20-50 wt. %, from 20-40 wt. %, or from 20-30 wt. %.

The plurality of plastic crystals can be present in the mixture in an amount that is from 20-95 wt. %, from 30-95 wt. %, from 40-95 wt. %, from 50-95 wt. %, from 60-95 wt. %, from 70-95 wt. %, from 80-95 wt. %, from 20-85 wt. %, from 30-85 wt. %, from 40-85 wt. %, from 50-85 wt. %, from 60-85 wt. %, from 70-85 wt. %, from 80-85 wt. %, from 20-75 wt. %, from 30-75 wt. %, from 40-75 wt. %, from 50-75 wt. %, from 60-75 wt. %, from 70-75 wt. %, from 20-65 wt. %, from 30-65 wt. %, from 40-65 wt. %, from 50465 wt. %, from 60-65 wt. %, from 20-55 wt. %, from 30-55 wt. %, from 40-55 wt. %, from 50-55 wt. %, from 20-45 wt. %, from 30-45 wt. %, from 40-45 wt. %, from 20-35 wt. %, from 30-35 wt. %, or from 20-25 wt. %.

In certain implementations, the plurality of plastic crystals is present in the mixture in a greater weight amount than the compound of Formula (1). In certain implementations, plurality of plastic crystals is present in the mixture in a weight that is from 1-25% greater, from 1-20% greater, from 1-15%, greater from 1-10% greater from 1-5%, greater from 1-2.5%, from 2.5-25% greater, from 2.5-20% greater, from 2.5-15%, greater from 2.5-10% greater from 2.5-5%, from 5-25% greater, from 5-20% greater, from 5-15%, greater from 5-10% greater, from 10-25% greater, from 10-20% greater, from 10-15%, from 15-25% greater, from 15-20% greater, at least 25% greater, at least 35% greater, at least 45% greater, or at least 50% greater, than the fluorinated elastomer.

The metal salt may be present in the mixture at a concentration from 0-10 M, from 1-10 M, from 2-10 M, from 3-10 M, from 4-10 M, from 5-10 M, from 6-10 M, from 7-10 M, from 8-10 M, from 9-10 M, from 1-8 M, from 2-8 M, from 3-8M, from 4-8 M, from 5-8 M, from 6-8 M, from 7-8 M, from 1-6 M, from 2-6 M, from 3-6 M, from 4-6 M, from 5-6 M, from 1-4 M, from 2-4 M, from 3-4 M, from 1-3 M, from 2-3 M, or from 1-2 M.

It is understood that the step of polymerizing the mixture can be done by any known in the art methods. For example, the polymerization can be free radical polymerization, ionic polymerization, or coordination polymerization. In some aspects, the mixture that is used to form the disclosed herein composition can further comprise an initiator. In such aspects, the initiator is a polymerization initiator. In still further aspects, the initiator can comprise a thermal initiator, a photoinitiator, or a combination thereof.

In some aspects, the initiator is a thermal initiator. Any known in the art thermal initiators can be utilized if they result in the desired composition. In such exemplary and unlimiting aspects, the thermal initiator can comprise azobisisobutyronitrile, benzoyl peroxide, or a combination thereof. When any of these thermal initiators are used to form the composition, the polymerization is a thermal polymerization.

Yet, in other aspects, the initiator is a photo-initiator. Any known in the art photo-initiators can be utilized if they result in the desired composition. In such exemplary and unlimiting aspects, the photo-Initiator can comprise bis(2,4,6-trimethylbenzoyl)-phenylphosphine oxide (Irgacure 819), 2-hydroxyl-2-methyl-1-phenyl-1-propanone, methyl benzoylformate, hydroxycyclohexyl phenyl ketone (Irgacure 184), or a combination thereof. When any of these photo-initiators are used to form the composition, the polymerization is a photopolymerization.

In still further aspects, the composition formed from polymerizing the disclosed mixture can also exhibit an ionic conductivity from 1.0 mS/cm to 10 mS/cm, including exemplary values of 1.5 mS/cm, 2.0 mS/cm, 2.5 mS/cm, 3.0 mS/cm, 3.5 mS/cm, 4.0 mS/cm, 4.5 mS/cm, 5.0 mS/cm, 5.5 mS/cm, 6.0 mS/cm, 6.5 mS/cm, 7.0 mS/cm, 7.5 mS/cm, 8.0 mS/cm, 8.5 mS/cm, 9.0 mS/cm, and 9.5 mS/cm. In still further aspects, the composition disclosed herein can exhibit an ionic conductivity greater than 1 mS/cm, greater than 1.1 mS/cm, greater than 1.2 mS/cm, greater than 1.3 mS/cm, greater than 1.4 mS/cm, greater than 1.5 mS/cm, greater than 1.6 mS/cm, greater than 1.7 mS/cm, greater than 1.8 mS/cm, greater than 1.9 mS/cm, greater than 2.0 mS/cm, greater than 2.1 mS/cm, greater than 2.2 mS/cm, greater than 2.3 mS/cm, greater than 2.4 mS/cm, greater than 2.5 mS/cm, greater than 2.6 mS/cm, greater than 2.7 mS/cm, greater than 2.8 mS/cm, greater than 2.9 mS/cm, greater than 3.0 mS/cm, greater than 3.1 mS/cm, greater than 3.2 mS/cm, greater than 3.3 mS/cm, greater than 3.4 mS/cm, greater than 3.5 mS/cm, greater than 3.6 mS/cm, greater than 3.7 mS/cm, greater than 3.8 mS/cm, greater than 3.9 mS/cm, or even greater than 4.0 mS/cm. In yet still further aspects, the ionic conductivity of the disclosed herein polymer can be also greater than 5.0 mS/cm.

It is understood, however, that the composition can also be crosslinked subsequent to the polymerization reaction by irradiating the polymerizable mixture. Any known times of radiation can be used to form a crosslinked polymer. For example, and without limitations, the composition can be crosslinked with UV, IR, or e-beam radiation.

In still further aspects, the metal salt can be present in the mixture in any amount to 70 wt. %, Including exemplary values of 0.01 wt. %, 0.05 wt. %, 0.1 wt. %, 0.5 wt. %, 1 wt. %, 5 wt. %, 10 wt. %, 15 wt. %, 20 wt. %, 25 wt. %, 30 wt. %, 35 wt. %, 40 wt. %, 45 wt. %, 50 wt. %, 55 wt. %, 60 wt. %, 65 wt. %, and 66.9 wt. % of the composition In still further aspects, the metal salt can be added, for example, as a powder. In such aspects, the salt is substantially dry and substantially water-free.

In still further aspects, the mixture is substantially water-free.

In still further aspects, the mixture can also comprise various additives. In some aspects, the additives can comprise functional groups that protect the polymerization reaction from side reactions that can form undesired compositions. For example, and without limitation, the mixture can comprise fluoroethylene carbonate (FEC), lithium nitrate (LiNO₃), or any combination thereof. It is understood that the listed herein compounds are only exemplary, and any other compounds capable of achieving the desired application can be utilized. It is understood that all the compounds present in the mixture are substantially water-free.

In still further aspects, the mixture is homogenous prior to polymerization.

In still further aspects, the plurality of plastic crystals dispersed within the composition can form a three-dimensional interconnected phase of plastic crystals. The interconnected phase is unexpectedly distinct and separated from the fluorinated elastomeric polymer. If the elastomeric polymer is derived from simple alkyl (meth)acrylates (e.g., methyl methacrylate, butyl acrylate, ethyl acrylate, etc.) the distinct and separate phases disclosed herein are not observed.

### Electrochemical Cells

Also disclosed herein are electrochemical cells. In such aspects, the electrochemical cell can comprise a solid electrolyte comprising any of the disclosed herein compositions, an anode electrode; and a cathode electrode; wherein the anode electrode and the cathode electrode are in electrical communication with the solid electrolyte.

In some aspects, the anode electrode can comprise a metal material. It is understood that the metal material can be a metal or material that comprises cations of the disclosed metal. In some aspects, the metal material can comprise metal of Li, Ca, Na, K, Mg, Zn, Al, alloys thereof, or a combination thereof. Yet, in other aspects, the anode can comprise a material capable of intercalating any of the disclosed herein metal materials. In still further aspects, the anode material can comprise ions of Li, Ca, Na, K, Mg, Zn, Al, alloys thereof, or a combination thereof. In certain aspects, the anode is Li-based material. In yet other aspects, the anode is Li metal. In still further aspects, the anode is a K-based material. In yet other aspects, the anode is K metal. In still further aspects, the anode is a Na-based material. In yet other aspects, the anode is Na metal. In still further aspects, the anode is a Zn-based material. In yet other aspects, the anode is Zn metal. In still further aspects, the anode is a Ca-based material. In yet other aspects, the anode is Ca metal. In still further aspects, the anode is an Mg-based material. In yet other aspects, the anode is Mg metal. In still further aspects, the anode is an Al-based material. In yet other aspects, the anode is Al metal. In still further aspects, the anode is an alloy of any of the disclosed above metal materials.

In still further aspects, the anode material can also comprise a host material configured to receive and intercalate any of the disclosed above metal materials. Such host materials can comprise any known in the art materials. For example, the host material can comprise copper or graphite-based materials. In certain exemplary aspects, the host material comprises copper. In such exemplary aspects, it can be presented as a foil, foam, grid, wire, filament, or any combination thereof. In yet other exemplary aspects, the host material comprises a carbon-based material. The carbon-based materials can comprise hard carbon, carbon black, graphene, reduced graphene oxide, graphene oxide, graphite, or any combination thereof. In still further aspects, additional host materials can comprise silicon or graphite/silicon composite materials.

In still further aspects, the cathode electrode can be a metal cathode or a composite cathode. It is understood that any known in the art cathode materials that can be useful for the desired purpose can be utilized. In some aspects, the cathode can be a metal cathode or composite cathode.

In yet still further aspects, the cathode material can comprise copper, carbon, graphite, sodium, potassium, lithium, magnesium, calcium, aluminum, layered oxides, vanadium-based cathode, sulfur-based cathode, manganese-based cathode, rocksalt cathode, disordered rocksalt cathode, lithium-rich cathode, high voltage ceramic, low voltage ceramic, NMC (nickel-manganese-cobalt oxide) cathode, NCA (nickel-cobalt-aluminum oxide) cathode, LCO (lithium cobalt oxide) cathode, lithium-nickel-cobalt-aluminum oxide material (LNCAO), lithium-nickel-manganese-cobalt oxide (LNMCO), LFP (lithium iron phosphate) cathode, fluoride-based cathode, sulfur selenium cathode, sulfur selenium tellurium cathode, spinels, olivines, or any combination thereof

If the metal cathode is similar to the metal anode, such an electrochemical cell can be a symmetrical electrochemical cell. For example, and without limitation, the symmetrical cell can comprise Li or K anode material and Li or K cathode material, respectively, and the like.

In still further aspects, the cathode electrode comprises Na₃V₂(PO₄)₃ (NVP), LNMCO, Na₃V₂(PO₄)₂F₃ (NVPF), KMnFe(CN)₆, MnO₂, V₂O₅, graphite, LiFePO₄, LiCoO₂, LiMnO₂, derivatives thereof, or a combination thereof.

In still further aspects, the cathode material comprises Li metal, LiNi_{1-x-y}MnₓCo_{y}O₂, or LiNi_{1-a-b}CoₐAl_{b}O₂, wherein 1≥x≥0, 1≥y≥0, 1≥a≥0, and 1≥b≥0. In such exemplary aspects, x can have any value from 0 and 1, including exemplary values of 0.01, 0.02, 0.03, 0.04, 0.05, 0.06, 0.07, 0.08, 0.09, 0.1, 0.2, 0.3, 0.4, 0.5, 0.6, 0.7, 0.8, 0.9 and 1.0. In still further aspects, y can have any value from 0 and 1, including exemplary values of 0.01, 0.02, 0.03, 0.04, 0.05, 0.06, 0.07, 0.08, 0.09, 0.1, 0.2, 0.3, 0.4, 0.5, 0.6, 0.7, 0.8, 0.9 and 1.0. In still further aspects, a can have any value from 0 and 1, including exemplary values of 0.01, 0.02, 0.03, 0.04, 0.05, 0.06, 0.07, 0.08, 0.09, 0.1, 0.2, 0.3, 0.4, 0.5, 0.6, 0.7, 0.8, 0.9 and 1.0. In still further aspects, b can have any value from 0 and 1, including exemplary values of 0.01, 0.02, 0.03, 0.04, 0.05, 0.06, 0.07, 0.08, 0.09, 0.1, 0.2, 0.3, 0.4, 0.5, 0.6, 0.7, 0.8, 0.9 and 1.0.

In some implementations, x is from 0.01-0.99, from 0.01-0.9, from 0.01-0.8, from 0.01-0.7, from 0.01-0.6, from 0.01-0.5, from 0.01-0.4, from 0.01-0.3, from 0.01-0.2, from 0.01-0.1, from 0.1-0.99, from 0.1-0.8, from 0.1-0.7, from 0.1-0.6, from 0.1-0.5, from 0.1-0.4, from 0.1-0.3, from 0.1-0.2, from 0.2-0.99, from 0.2-0.8, from 0.2-0.7, from 0.2-0.6, from 0.2-0.5, from 0.2-0.4, from 0.2-0.3, from 0.4-0.99, from 0.4-0.8, from 0.4-0.7, from 0.4-0.6, from 0.4-0.5.

In some implementations, y is from 0.01-0.99, from 0.01-0.9, from 0.01-0.8, from 0.01-0.7, from 0.01-0.6, from 0.01-0.5, from 0.01-0.4, from 0.01-0.3, from 0.01-0.2, from 0.01-0.1, from 0.1-0.99, from 0.1-0.8, from 0.1-0.7, from 0.1-0.6, from 0.1-0.5, from 0.1-0.4, from 0.1-0.3, from 0.1-0.2, from 0.2-0.99, from 0.2-0.8, from 0.2-0.7, from 0.2-0.6, from 0.2-0.5, from 0.2-0.4, from 0.2-0.3, from 0.4-0.99, from 0.4-0.8, from 0.4-0.7, from 0.4-0.6, from 0.4-0.5.

In some implementations, x+y is from 0.01-0.5, from 0.01-0.4, from 0.01-0.3, from 0.01-0.2, from 0.01-0.1, from 0.1-0.5, from 0.1-0.4, from 0.1-0.3, from 0.1-0.2, from 0.2-0.5, from 0.2-0.4, from 0.2-0.3, from 0.3-0.5, from 0.3-0.4, or from 0.4-0.5.

In some implementations, a is from 0.01-0.99, from 0.01-0.9, from 0.01-0.8, from 0.01-0.7, from 0.01-0.6, from 0.01-0.5, from 0.01-0.4, from 0.01-0.3, from 0.01-0.2, from 0.01-0.1, from 0.1-0.99, from 0.1-0.8, from 0.1-0.7, from 0.1-0.6, from 0.1-0.5, from 0.1-0.4, from 0.1-0.3, from 0.1-0.2, from 0.2-0.99, from 0.2-0.8, from 0.2-0.7, from 0.2-0.6, from 0.2-0.5, from 0.2-0.4, from 0.2-0.3, from 0.4-0.99, from 0.4-0.8, from 0.4-0.7, from 0.4-0.6, from 0.4-0.5.

In some implementations, b is from 0.01-0.99, from 0.01-0.9, from 0.01-0.8, from 0.01-0.7, from 0.01-0.6, from 0.01-0.5, from 0.01-0.4, from 0.01-0.3, from 0.01-0.2, from 0.01-0.1, from 0.1-0.99, from 0.1-0.8, from 0.1-0.7, from 0.1-0.6, from 0.1-0.5, from 0.1-0.4, from 0.1-0.3, from 0.1-0.2, from 0.2-0.99, from 0.2-0.8, from 0.2-0.7, from 0.2-0.6, from 0.2-0.5, from 0.2-0.4, from 0.2-0.3, from 0.4-0.99, from 0.4-0.8, from 0.4-0.7, from 0.4-0.6, from 0.4-0.5.

In some implementations, a+b is from 0.01-0.5, from 0.01-0.4, from 0.01-0.3, from 0.01-0.2, from 0.01-0.1, from 0.1-0.5, from 0.1-0.4, from 0.1-0.3, from 0.1-0.2, from 0.2-0.5, from 0.2-0.4, from 0.2-0.3, from 0.3-0.5, from 0.3-0.4, or from 0.4-0.5.

In still further exemplary and unlimiting aspects, the cathode material can comprise LiCoO₂, LiNi_{0.9}Mn_{0.05}Co_{0.05}O₂, LiNi_{0.6}Mn_{0.2}Co_{0.2}O₂, LiNi_{0.83}Mn_{0.06}Co_{0.11}O₂, or LiNi_{0.88}Co_{0.09}Al_{0.03}O₂, LiNi_{0.8}Co_{0.15}Al_{0.05}O₂, a LiNi_{1/3}Mn_{1/3}Co_{1/3}O₂, a LiNi_{0.4}Mn_{0.3}Co_{0.3}O₂, a LiNi_{0.5}Mn_{0.3}Co_{0.2}O₂, a LiNi_{0.6}Mn_{0.2}Co_{0.2}O₂, or a LiNi_{0.8}Mn_{0.1}Co_{0.1}O₂ composite cathode.

In yet still further aspects, the cathode material can also comprise additives. For example, and without limitations, the additives can comprise a poly(ethylene oxide), cellulose, carboxymethylcellulose (CMC), a polytetrafluoroethylene (PTFE), styrene-butadiene rubber (SBR), or a polyvinylidene fluoride binder (PVDF).

In still further aspects, the electrochemical cells if the present disclosure can exhibit a cyclic Coulombic efficiency greater than 90%, greater than 91%, greater than 92%, greater than 93%, greater than 94%, greater than 95%, greater than 96%, greater than 97%, greater than 98%, greater than 99%, greater than 99.1%, greater than 99.2%, greater than 99.3%, greater than 99.4%, greater than 99.5%, greater than 99.6%, greater than 99.7%, greater than 99.8%, or greater than 99.9% for 500 cycles, 600 cycles, 700 cycles, 800 cycles, 900 cycles, 1,000 cycles, 1,260 cycles, 1,500 cycles, 1,750 cycles, 2,000 cycles, 5,000 cycles, or 10,000 at a current density from 0.1 mA cm⁻² to 10 mA cm⁻², including exemplary values of 0.25 mA cm⁻², 0.5 mA cm⁻², 0.75 mA cm⁻², 1 mA cm⁻², 1.5 mA cm⁻², 2 mA cm⁻², 2.5 mA cm⁻², 3 mA cm⁻², 3.5 mA cm⁻², 4 mA cm⁻², 4.5 mA cm⁻², 5 mA cm⁻², 5.5 mA cm⁻², 6 mA cm⁻², 6.5 mA cm⁻², 7 mA cm⁻², 7.5 mA cm⁻², 8 mA cm⁻², 8.5 mA cm⁻², 9 mA cm⁻², and 9.5 mA cm⁻².

In yet further aspects, the cell is substantially stable for 200, 300, 400, 500, 600, 700, 800, 900, or 1,000 plating/stripping cycles a temperature from −30° C. to 100° C., including exemplary values of −−25° C., −20° C., −15° C., −10° C., −5° C., 0° C., 5° C., 10° C., 15° C., 20° C., 25° C. 30° C., 35° C., 40° C., 45° C., 50° C., 55° C., 60° C., 65° C., 70° C., 75° C., 80° C., 85° C., 90° C., and 95° C.

In still further aspects, the disclosed herein electrochemical cells are configured to provide specific energy of 350 to 520 watt-hours per kilogram of the anode, cathode, and the solid electrolyte after 500 cycles at a specific energy of 150 to 500 W/kg. In such aspects, the specific energy of the cell can be from 350 to 600 watt-hours per kilogram of the anode, cathode, and the solid electrolyte, including exemplary values of 400, 425, 450, 475, 500, 520, 550, and 575 watt-hours per kilogram of the anode, cathode, and the solid electrolyte after 500 cycles at a specific energy of 150 to 500 W/kg, including exemplary values of 200, 250, 300, 350, 400, and 450 W/kg.

In yet still further aspects, the electrochemical cell exhibits a substantially stable plating and stripping cycling at least 500 hours, at least 600 hours, at least 700 hours, at least 800 hours, at least 900 hours, at least 1,000 hours, at least 1,250 hours, at least 1,500 hours, at least 1,750 hours, at least 2,000 hours, at least 5,000 hours, at least 10,000 at a current density from 0.1 mA cm⁻² to 10 mA cm⁻², including exemplary values of 0.25 mA cm⁻², 0.5 mA cm⁻², 0.75 mA cm⁻², 1 mA cm⁻², 1.5 mA cm⁻², 2 mA cm⁻², 2.5 mA cm⁻², 3 mA cm⁻², 3.5 mA cm⁻², 4 mA cm⁻², 4.5 mA cm⁻², 5 mA cm⁻², 5.5 mA cm⁻², 6 mA cm⁻², 6.5 mA cm⁻², 7 mA cm⁻², 7.5 mA cm⁻², 8 mA cm⁻², 8.5 mA cm⁻², 9 mA cm⁻², and 9.5 mA cm⁻².

In still further aspects, the cell exhibits a substantially stable plating and stripping cycling for up to 500 hours, up to 600 hours, up to 700 hours, up to 800 hours, up to 900 hours, up to 1,000 hours, up to 1,100 hours, up to 1,200 hours, up to 1,300 hours, up to 1,400 hours, and up to 1500 hours at a current density from 0.1 mA cm⁻² to 10 mA cm⁻², including exemplary values of 0.25 mA cm⁻², 0.5 mA cm⁻², 0.75 mA cm⁻², 1 mA cm⁻², 1.5 mA cm⁻², 2 mA cm⁻², 2.5 mA cm⁻², 3 mA cm⁻², 3.5 mA cm⁻², 4 mA cm⁻², 4.5 mA cm⁻², 5 mA cm⁻², 5.5 mA cm⁻², 6 mA cm⁻², 6.5 mA cm⁻², 7 mA cm⁻², 7.5 mA cm⁻², 8 mA cm⁻², 8.5 mA cm⁻², 9 mA cm⁻², and 9.5 mA cm⁻².

In still further aspects, the electrochemical cell can exhibit a reversible capacity up to 100 mAh/g, up to 110 mAh/g, up to 120 mAh/g, up to 130 mAh/g, up to 140 mAh/g, up to 150 mAh/g, up to 160 mAh/g, up to 170 mAh/g, up to 180 mAh/g, up to 190 mAh/g, and up to 200 mAh/g.

In still further aspects, the solid electrolyte composition does not undergo any substantial change for 200, 300, 400, 500, 600, 700, 800, 900, or 1,000 plating/stripping cycles a temperature from −30° C. to 100° C., including exemplary values of −−25° C., −20° C., −15° C., −10° C., −5° C., 0° C., 5° C., 10° C., 15° C., 20° C., 25° C., 30° C., 35° C., 40° C., 45° C., 50° C., 55° C., 60° C., 65° C., 70° C., 75° C., 80° C., 85° C., 90° C., and 95° C.

In still further aspects, the solid electrolyte can have a thickness from 10 nm to 1 mm, including exemplary values of 15 nm, 20 nm, 50 nm, 100 nm, 250 nm, 500 nm, 750 nm, 1 μm, 5 μm, 10 μm, 25 μm, 50 μm, 75 μm, 100 μm, 250 μm, 500 μm, 750 μm, and 990 μm.

In certain implementations, the solid electrolyte can have a thickness from 0.01-1,000 μm, from 0.1-1,000 μm, from 1-1,000 μm, from 10-1,000 μm, from 25-1,000 μm, from 50-1,000 μm, from 100-1,000 μm, from 250-1,000 μm, from 500-1,000 μm, from 0.01-500 μm, from 0.1-500 μm, from 1-500 μm, from 10-500 μm, from 25-500 μm, from 50-500 μm, from 100-500 μm, from 250-500 μm, from 0.01-250 μm, from 0.1-250 μm, from 1-250 μm, from 10-250 μm, from 25-250 μm, from 50-250 μm, from 100-250 μm, from 0.01-100 μm, from 0.1-100 μm, from 1-100 μm, from 10-100 μm, from 25-100 μm, from 50-100 μm, from 0.01-50 μm, from 0.1-50 μm, from 1-50 μm, from 10-50 μm, from 25-50 μm, from 0.01-25 μm, from 0.1-25 μm, from 1-25 μm, from 10-25 μm, from 0.01-10 μm, from 0.1-10 μm, from 1-10 μm, from 0.01-1 μm, from 0.1-1 μm, or from 0.01-0.1 μm.

In still further aspects, the electrochemical cell, as disclosed herein, exhibits a capacity retention greater than 80%, greater than 81%, greater than 82%, greater than 83%, greater than 84%, greater than 85%, greater than 86%, greater than 87%, greater than 88%, greater than 89%, greater than 90%, greater than 91%, greater than 92%, greater than 93%, greater than 94%, greater than 95%, greater than 96%, greater than 97%, greater than 98%, or greater than 99% for at least 50 cycles, at least 80 cycles, at least 100 cycles, at least 200 cycles, at least 300 cycles, at least 400 cycles, at least 500 cycles, at least 600 cycles, at least 700 cycles, at least 800 cycles, at least 900 cycles, or at least 1000 cycles.

In yet still further aspects, the cell can exhibit a substantial discharge capacity retention of no less than 99.9%, no less than 99%, no less than 98, or no less than 97, or no less than 96, or no less than 95%, no less than 94, or no less than 93, or no less than 92, or no less than 91, or no less than 90%, no less than 89, or no less than 88, or no less than 87, or no less than 86, or no less than 85%, no less than 84, or no less than 83, or no less than 82, or no less than 81, or no less than 80%, no less than 79, or no less than 78, or no less than 77, or no less than 76, or no less than 75%, or no less than 74, or no less than 73, or no less than 72, or no less than 71, or no less than 70% after at least 50 cycles, at least 80 cycles, at least 100 cycles, at least 200 cycles, at least 300 cycles, at least 400 cycles, at least 500 cycles, at least 600 cycles, at least 700 cycles, at least 800 cycles, at least 900 cycles, or at least 1000 cycles

In still further aspects, the solid electrolyte can be formed in situ. In such aspects, the mixture as described above can be inserted into the electrochemical cell during the cell construction, and the polymerization process can be achieved inside the cell. In such exemplary and unlimiting aspects, the polymerization can be activated by heat.

In yet other aspects, the solid electrolyte can be formed separately and added as a separate component during the cell construction.

In still further aspects, the disclosed herein electrochemical cells operate such that the anode material is substantially dendrite free during a plating cycle.

In still further aspects, the electrochemical cell disclosed herein is a battery. In still further aspects, the battery is a secondary battery.

By way of example, electrochemical cells of the present disclosure may be used in portable batteries, including those in hand-held and/or wearable electronic devices, such as a phone, watch, or laptop computer; in stationary electronic devices, such as a desktop or mainframe computer; in an electric tool, such as a power drill; in an electric or hybrid land, water, or air-based vehicle, such as a boat, submarine, bus, train, truck, car, motorcycle, moped, powered bicycle, airplane, drone, other flying vehicle, or toy versions thereof; for other toys; for energy storage, such as in storing electric power from wind, solar, wave, hydropower, or nuclear energy and/or in grid storage, or as a stationary power store for small-scale use, such as for a home, business, or hospital.

In addition, batteries, according to the present disclosure, may be multi-cell batteries containing at least 10, at least 100, at least 500, between 10 and 10,000, between 100 and 10,000, between 1,000 and 10,000, between 10 and 1000, between 100 and 1,000, or between 500 and 1,000 electrochemical cells of the present disclosure. Cells in multi-cell batteries may be arranged in parallel or in series.

### Methods

Further disclosed herein are methods of making of the disclosed herein compositions. In some aspects, the methods comprise: a) forming a mixture comprising: i) one or more monomers of Formula (1) as disclosed above, ii) any of the disclosed above a plurality of plastic crystals; iii) any of the disclosed above metal salts, and polymerizing the mixture to form the disclosed above composition.

In still further aspects, the mixture can also comprise a cross-linker. Any of the disclosed above cross-liners can be utilized. In still further aspects, the mixture can further comprise an initiator. Any of the disclosed above initiators can be utilized.

In still further aspects, the disclosed methods result in the composition where the plurality of plastic crystals dispersed within the composition to form a three-dimensional interconnected phase of plastic crystals that is distinct and separate from the fluorinated elastomeric phase.

Also disclosed herein are methods of making an electrochemical cell comprising: a) providing an anode material; b) providing a cathode material, and c) providing a solid electrolyte formed by the disclosed methods.

While in still further aspects, also disclosed is a method of making an electrochemical cell comprising: a) providing an anode material; b) providing a cathode material; and c) providing the mixture of any of the disclosed herein compounds and polymerizing the mixture in-situ during the electrochemical cell operation to form the disclosed solid electrolyte.

By way of non-limiting illustration, examples of certain aspects of the present disclosure are given below.

### EXAMPLES

The following examples are put forth so as to provide those of ordinary skill in the art with a complete disclosure and description of how the compounds, compositions, articles, devices, and/or methods claimed herein are made and evaluated and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is degrees c, or is at ambient temperature, and pressure is at or near atmospheric.

### Example 1

### Preparation of Electrolytes

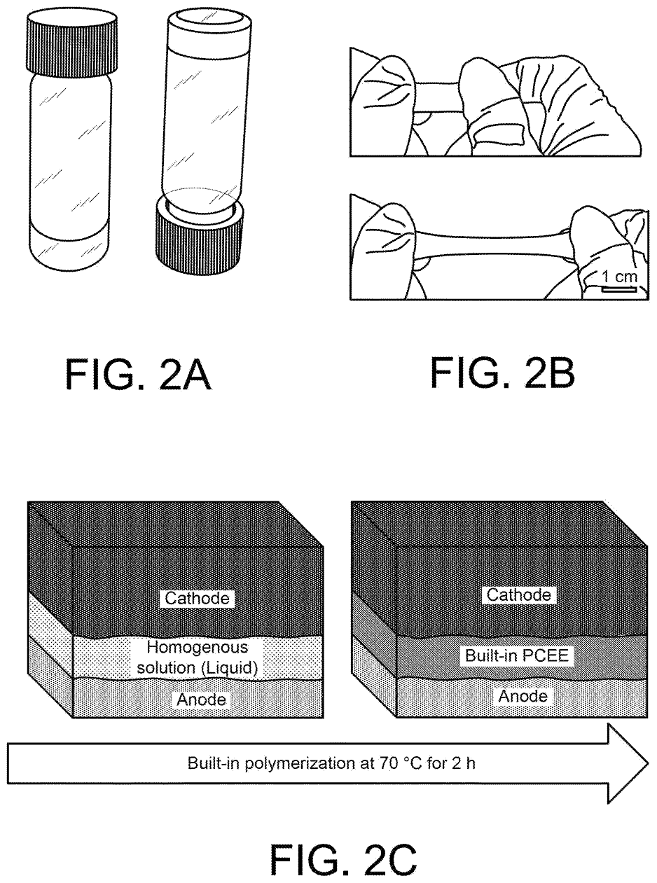

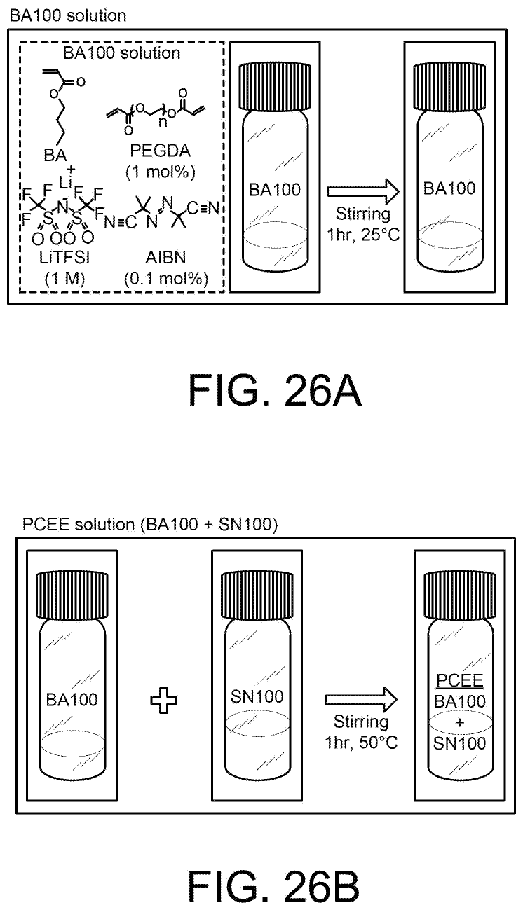

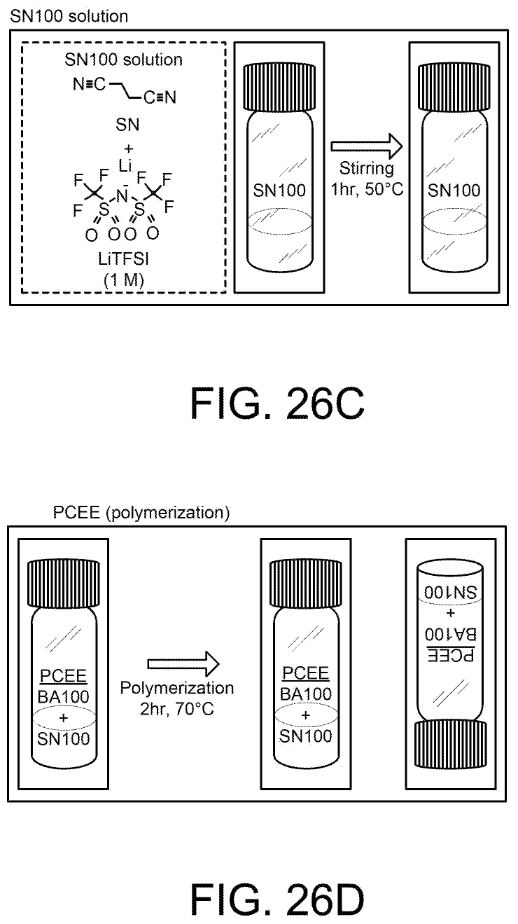

FOR PCEE fabrication, electrolyte preparation and cell assembly were implemented in an argon gas-filled glove box where the concentration of O₂ and water (H₂O) was below 0.1 ppm. The butylacrylate (BA)-based solutions were prepared by dissolving 1 mol % poly(ethylene glycol) diacrylate (PEGDA) (Sigma-Aldrich), 0.5 mol % AIBN (Sigma-Aldrich), and 1 M LiTFSI powder (99%; Sigma-Aldrich) in BA liquid (Sigma-Aldrich). The BA-based solutions were polymerized at 70° C. for 2 h to compare BA-based elastomer (BA100) with PCEE. The succinonitrile (SN)-based solutions (SN100) were made by mixing SN (Sigma-Aldrich) with 1 M LiTFSI powder and 5 Vol % fluoroethylene carbonate additive (Sigma-Aldrich) to protect against the side reaction of SN with Li metal at 50° C. Each prepared liquid solution was homogeneously mixed in a volume ratio of 1:1 at 50° C. to fabricate the build-in PCEE (FIGS. 26A-26D). After injecting the prepared solution into the cells (2032-type coin cell, for example), the assembled cell was heated at 70° C. for 2 h to generate built-in PCEEs (FIGS. 2A-2C). A homemade mold was used to prepare the free-standing ex-situ PCEEs.

PCEE can also be prepared via a photopolymerization process. The polymerization time of PCEE can be reduced from 2 h to 5-20 min by replacing the thermal initiator (e.g., azobisisobutyronitrile) with a photoinitiator (e.g., photoinitator bis(2,4,6-trimethylbenzoyl)-phenylphosphine oxide (Irgacure 819), 2-hydroxyl-2-methyl-1-phenyl-1-propanone, and methyl benzoylformate).

### Material Characterization

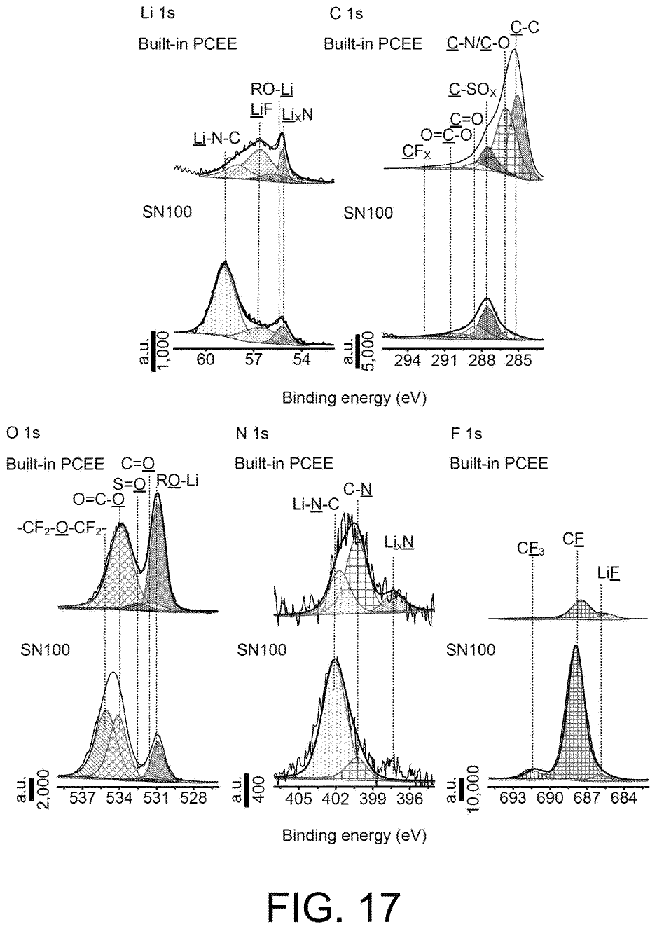

Fourier transform infrared spectroscopy spectra were measured using a Bruker ALPHA-P spectrometer in an attenuated total reflectance setup. Thermogravimetric analysis testing (TA Instruments Q500) was measured from room temperature to 700° C. at a heating rate of 10° C. min⁻¹ under a nitrogen atmosphere. Differential scanning calorimetry curves were obtained using a TA Instruments 0200 under a nitrogen atmosphere at a heating and cooling rate of 10° C. min⁻¹. The morphologies of the built-In PCEE were observed by SEM (Hitachi SU-5000) and TEM (Talos F200X). Cross-sectional TEM samples were prepared by microtoming with a diamond knife (RMC PowerTomeX). Electron energy-loss spectroscopy elemental mapping was performed using TEM with high-angle annular dark-field imaging. The 3D tomography image was constructed by an X-ray microscope (Zeiss Xradia 520 versa). Mechanical tensile stress and interfacial adhesion-strength measurements were carried out using a universal testing machine (Lloyd Instruments LR5K). Adhesion energies were calculated using a previously reported method. X-ray photoelectron spectroscopy (XPS; Thermal Scientific K-alpha XPS instrument) was used to investigate the compositions of the SEI formed on the Li metal anodes after 100 cycles in the symmetric Li cells with the built-In PCEE and SN100 (FIG. 17). The cycled cells were disassembled in an argon-filled glove box. The cycled Li metal anodes were then transferred to the XPS using a vacuum transfer vessel to avoid contamination or side reactions with ambient oxygen and moisture. For comparison, the top surfaces of the cycled Li metal anodes were etched using argon-Ion sputtering until the atomic ratio of Li in the SEI components of the built-in PCEE, and SN100 reached approximately 30%. High-resolution XPS Li 1s, C 1s, O 1s, N 1s, and F is spectra were deconvoluted using XPSPEAKS 4.1.

### Electrode Preparation

NMC-622, NMC-83, and LFP cathodes were prepared using a slurry casting technique. Active material, Super P carbon as a conductive additive, SN-LiTFSI with a molar ratio of 20:1, and polyvinylidene fluoride were dissolved in N-methyl-2-pyrrolidone with a weight ratio of 7:1:1:1 to make a slurry and then coated onto a current collector of aluminum foil. The cathodes were dried in a vacuum oven at 55° C. for 24 h. The active loading density of the LFP cathode was 1.5 mg cm⁻². The active loading densities of the NMC-622 cathode were 2.1 mg cm⁻² and 9.8 mg cm⁻². The active loading density of the NMC-83 cathode was in the range of 10.3-10.6 mg cm⁻².

### Electrochemical Measurements

The electrochemical performances of all cells were tested with 2032-type coin cells assembled using Li foil as the anode in an argon-filled glovebox (M. Braun, 02 and H2O<0.1 ppm). Linear-sweep voltammetry was carried out using Li∥stainless steel (SS) asymmetric cells from 1.5 V to 6 V versus Li/Li+ at a scan rate of 1 mV s⁻¹. EIS (Bio-Logic VMP3) of the PCEEs was carried out from 100 Hz to 105 Hz using a 10-mV peak voltage at an open-circuit voltage. The ionic conductivity of the electrolytes was measured using EIS with SS∥electrolyte∥SS symmetric cells in an environmental chamber (MC-812R, Espec) at the desired temperatures. Considering the compatibility with the current roll-to-roll-based Li-ion battery manufacturing, polypropylene or glass fibre as a separator was applied to prevent a short circuit in the liquid precursors of the PCEEs for the full cells in this work. The cycling test of the 35-μm-thick Li∥25-μm-built-in PCEE∥high-loading NMC-83 cell was performed in the voltage range of 2.7-4.3 V with three initialization cycles at a current density of 0.1 mA cm⁻² before cycling at a current density of 0.5 mA cm⁻² without any voltage holding. The galvanostatic charge/discharge test of the 35-μm-thick Li∥25-μm-thick built-in PCEE∥high-loading NMC-83 cell was carried out in the voltage range of 2.7-4.5 V at equal current densities of 0.1-3 mA cm⁻² (Arbin battery tester). For the temperature-dependent test, the 35-μm-thick Li∥25-μm-built-in PCEE∥high-loading NMC-83 cell was charged and discharged at equal current density (0.1 mA cm⁻²) and temperatures (0° C. to 60° C.) in an environmental chamber. All specific and areal capacities were normalized using the weight of the active material in the electrodes and the area of the electrodes, respectively.

### Example 2

### Designing Elastomeric Electrolytes

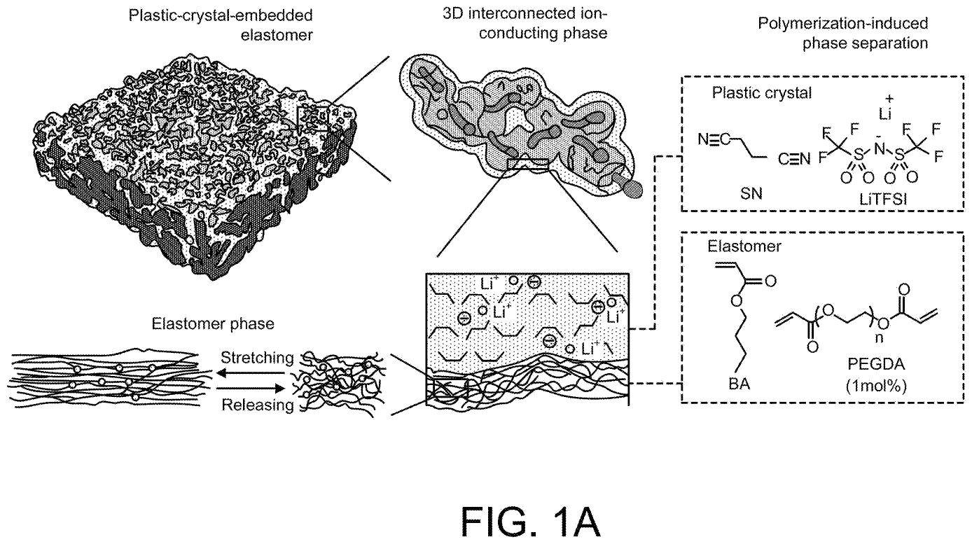

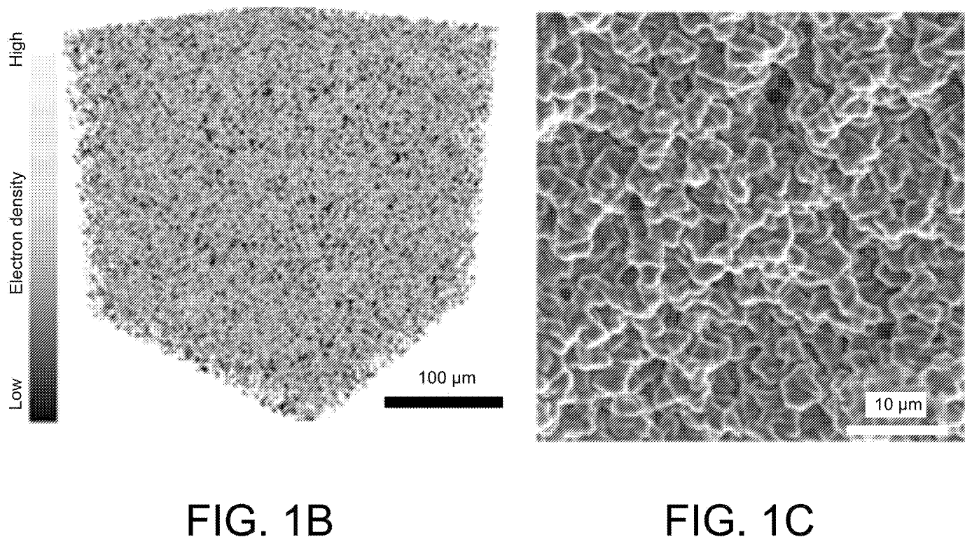

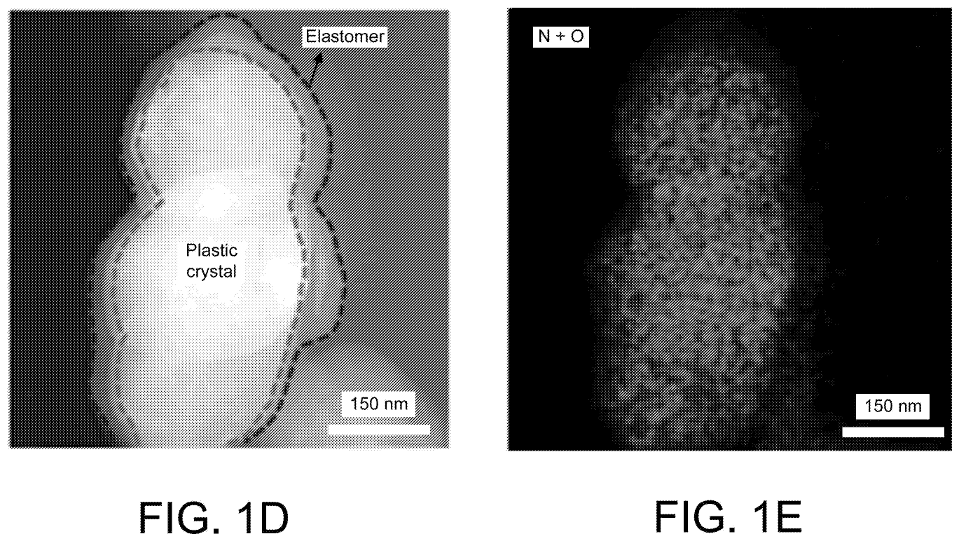

Built-in PCEE was synthesized by polymerizing a homogeneous solution consisting primarily of butyl acrylate (BA), succinonitrile (SN), and lithium bis(trifluoromethanesulfonyl)imide (LiTFSI) at 70° C. in an assembled electrochemical cell (FIG. 1a, FIGS. 2A, 2C). SN, a representative plastic crystal, was selected as an ionic conductive material owing to its high ionic conductivity when complexed with Li salts. For polymerization, azobisisobutyronitrile (AIBN; 0.5 mol %) and poly(ethylene glycol) diacrylate (PEGDA; 1 mol %) were used as the thermal initiator and cross-linking agent, respectively. In this polymerization process, BA/PEGDA produces in situ-formed polymers chemically cross-linked by PEGDA, eventually resulting in elastomer networks, whereas the SN-LiTFSI phase is partitioned into nanoscale domains.

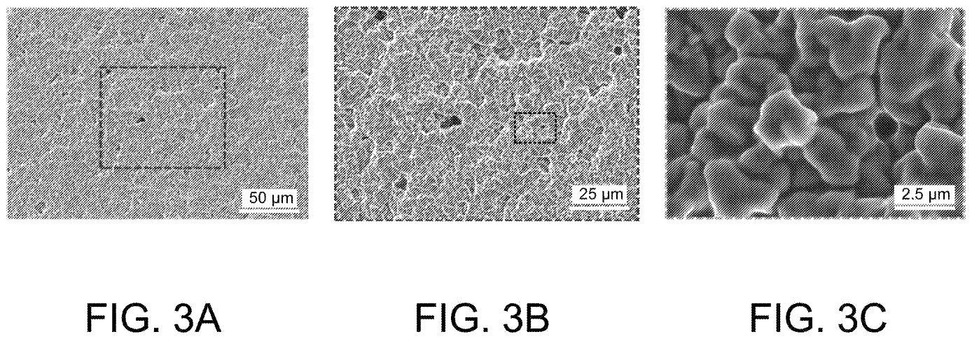

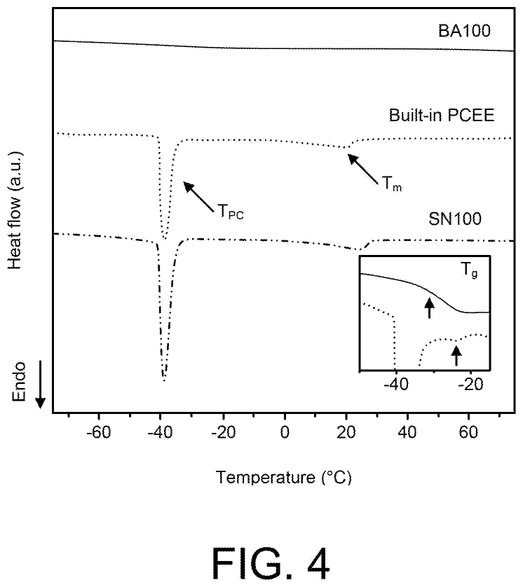

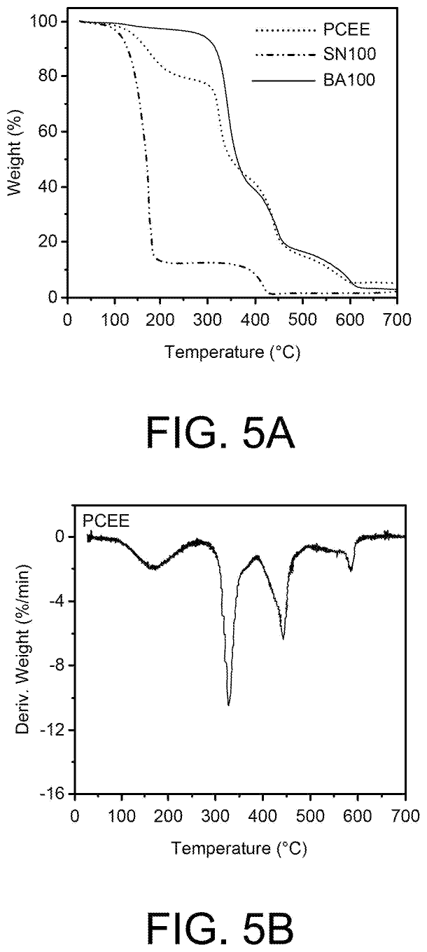

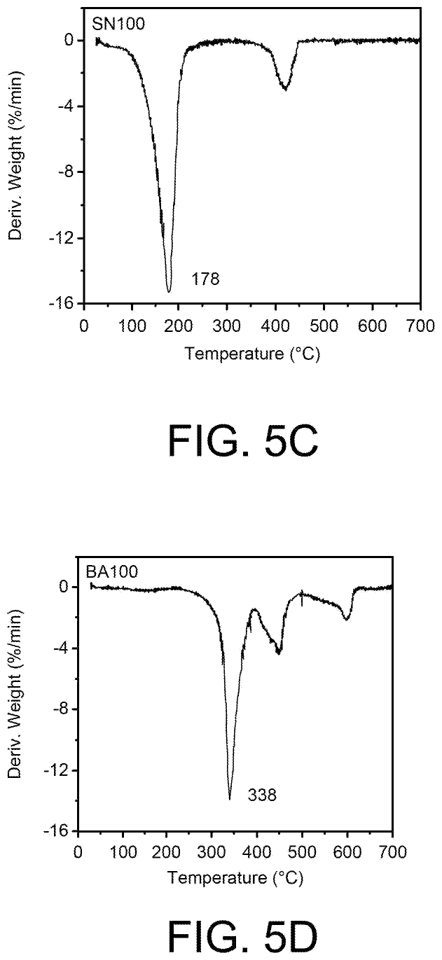

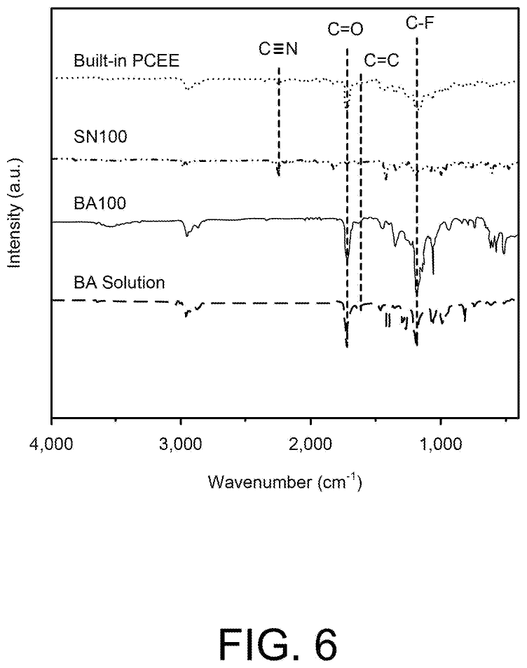

The synthesized PCEE showed a high mechanical elasticity owing to the elastomer matrix (FIG. 2B). Three-dimensional tomography and scanning electron microscopy (SEM) images showed that PCEE had an interconnected network structure in which worm-shaped polymer ducts were three-dimensionally connected (FIGS. 1B, 1C, FIG. 3). In detail the SN phase was well enclosed by the cross-linked polymer phase, and the interface between the SN phase and the elastomer matrix was smoothly connected, as revealed by transmission electron microscopy (TEM) (FIG. 1D). The electron energy-loss spectroscopy elemental mapping image confirmed that nitrogen (N) of the SN phase was embedded within oxygen (O) of the BA-based elastomer matrix (FIG. 1E). Without wishing to be bound by any theory, this unique structure was attributed to nanoscale phase separation during PIPS, which was driven by the increase in the molecular weight of polymerized BA/PEGDA and the enthalpic interactions between the SN and the emerging polymer. Importantly, the coarsening of the resulting SN phase was effectively suppressed by the elastomer matrix, allowing the formation of the 3D interconnected SN phase as an effective ion-conducting pathway within the BA-based elastomer. In addition, differential scanning calorimetry, thermogravimetric analysis, and Fourier transform infrared spectroscopy revealed that PCEE showed the characteristics of both the plastic crystal and the rubbery polymer phases (FIGS. 4-6).

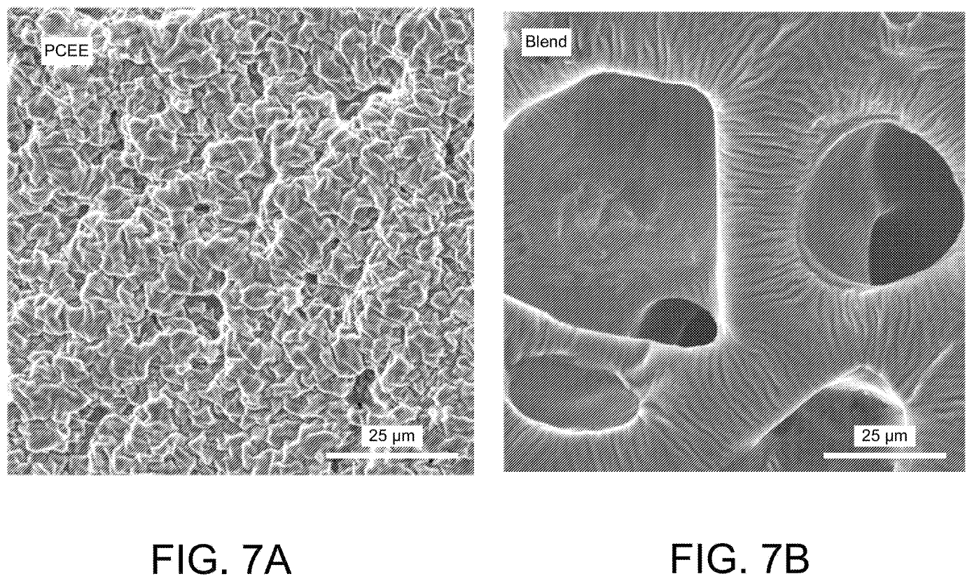

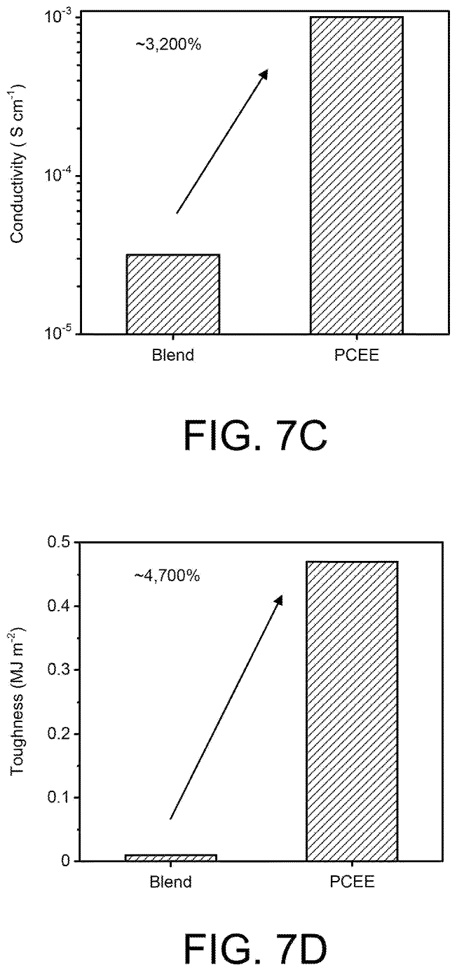

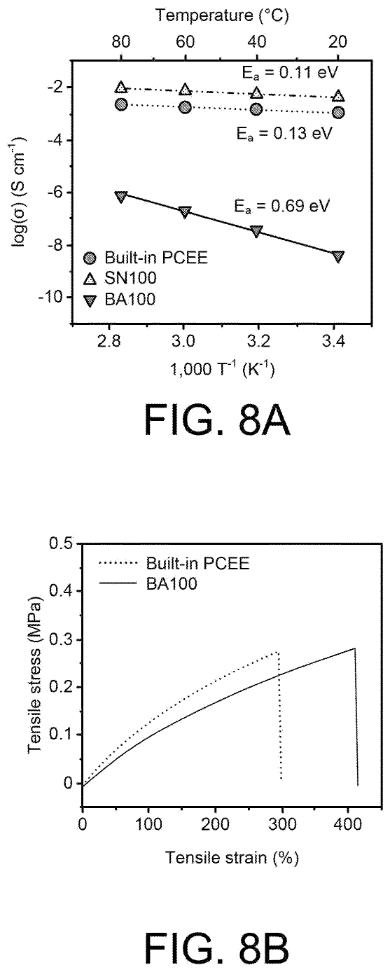

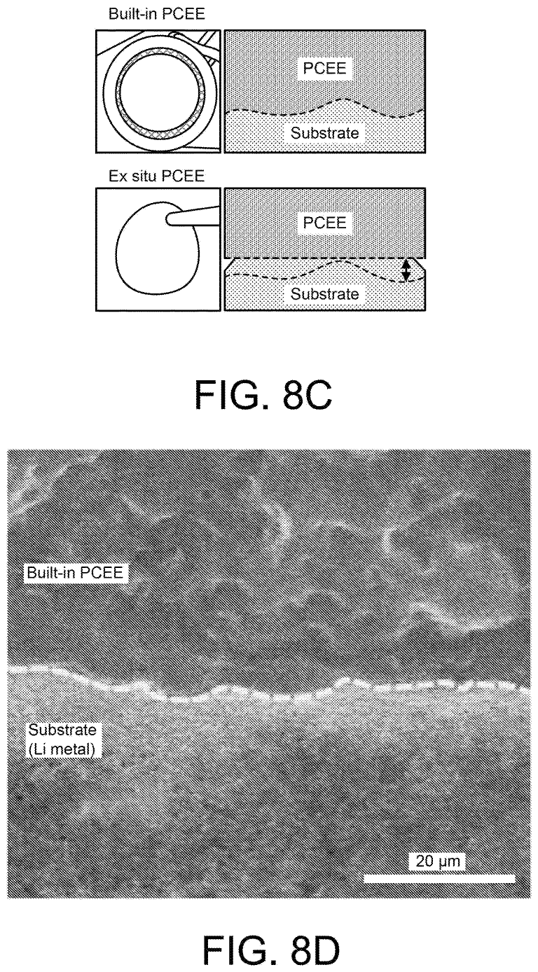

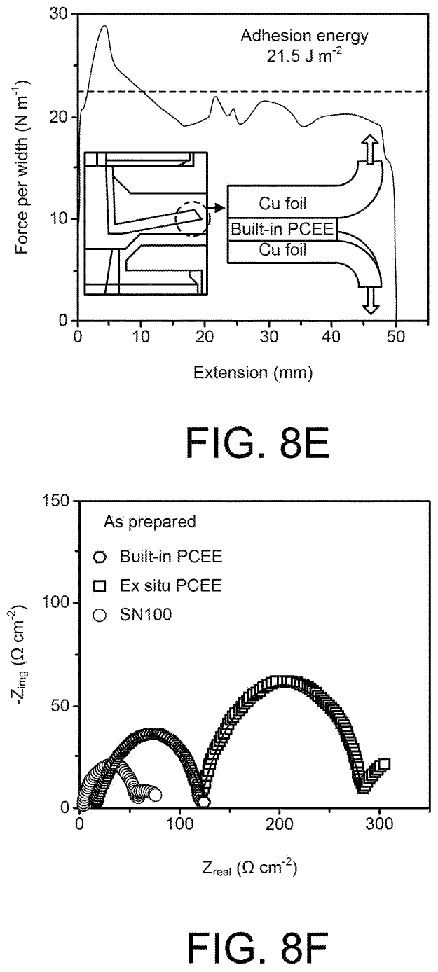

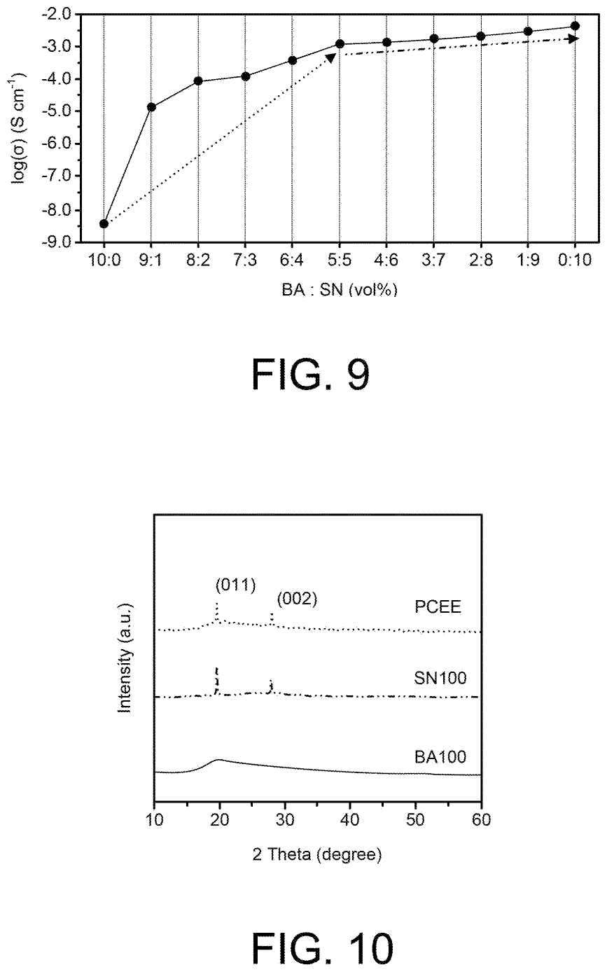

It should be noted that the unique structure of PCEE is completely different from that of a conventional blend (FIGS. 7A-7D). The simple blend of BA-based polymer (BA100) and SN without involving PIPS showed macroscopically separated morphologies. The Ionic conductivity and tensile toughness of the blend are substantially inferior by factors of 32 and 47, respectively, compared with those of PCEE (FIG. 7C, 7D). The interconnected nature of the SN phase in PCEE was further studied by temperature-dependent ionic conductivity measurements. Despite the low ionic conductivity of BA100 (10⁻⁶ mS cm⁻¹ at 20° C.), PCEE exhibited a high ionic conductivity of 1.1 mS cm⁻¹ at 20° C., which was slightly lower than that of the SN-LiTFSI complex (SN100; 4.1 mS cm⁻¹ at 20° C.; FIG. 8A, FIG. 9). The activation energy (Ea) of the built-in PCEE was estimated to be 0.13 eV, which was comparable to that of SN100 (0.11 eV) but much smaller than that of BA100 (0.69 eV).

Considering the volume fraction of the SN conducting phase in PCEE, the tortuosity of the continuous conducting phase was determined to be very low (1.9). This result suggests that the ion-conductive pathways of the continuous SN domains with high connectivity were successfully developed within the elastomer matrix of PCEE. In addition, X-ray diffraction results showed that the crystallinity of the SN phase within the elastomeric phase was well maintained, contributing to the high ionic conductivity of PCEE (FIG. 10). The superior mechanical elasticity of PCEE was demonstrated by tensile tests. PCEE showed an SN100 could not be measured owing to its extreme brittleness (FIG. 75). Overall, the results indicate that the embedded SN network in PCEE did not compromise the mechanical robustness of the elastomer matrix.

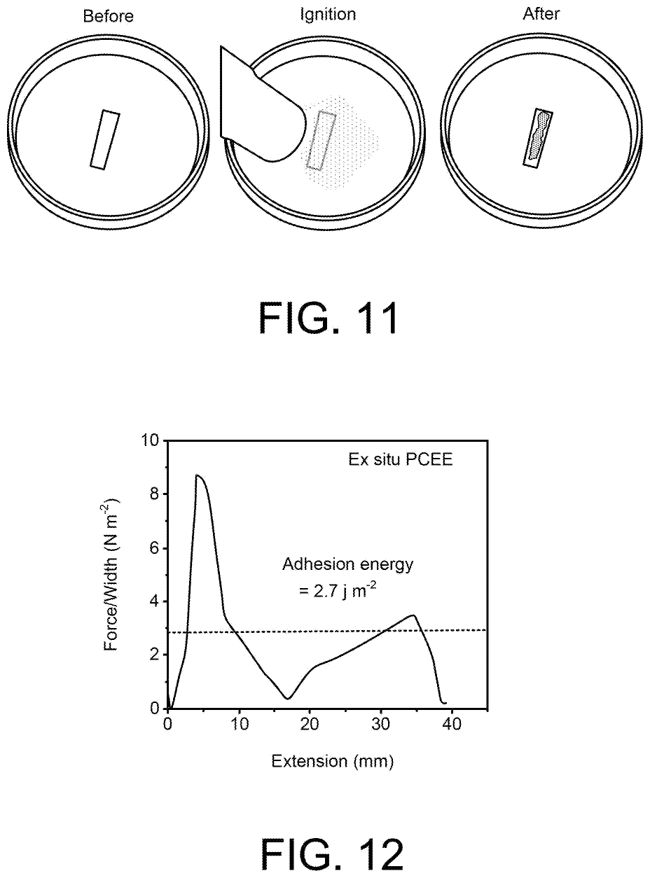

Moreover, PCEE showed excellent flame retardancy (FIG. 11). A photographic image of the built-in PCEE that was formed on Li metal is compared with that of the ex situ-synthesized PCEE (hereinafter. ‘ex-situ PCEE’) (FIG. 7C). The built-in PCEE had a seamless contact with the electrode, forming a more stable interface than the ex-situ PCEE. A cross-sectional SEM image shows that the built-in PCEE seamlessly adhered to the Li metal anode (FIG. 7D), in which the solution that initially wet the rough electrode is in situ-polymerized along the surface8. An interfacial adhesion test shows that the built-in PCEE produced a strong adhesion with the electrode, resulting in higher adhesion energy of 21.5 J m⁻² than that of the ex-situ PCEE (2.7 J m⁻²) (FIG. 7E, FIG. 12). In general, adhesion energy above 5 J m⁻² is considered to be a crucial requirement for creating a stable interface that is capable of withstanding mechanical stress during cell fabrication and operation30. In addition, electrochemical impedance spectroscopy (EIS) measurements showed that the overall resistance of the built-in PCEE was 122 D cm⁻², which was lower than that of the ex-situ PCEE (304 Ωcm⁻²) (FIG. 7F).

### Investigating Li Reversibility

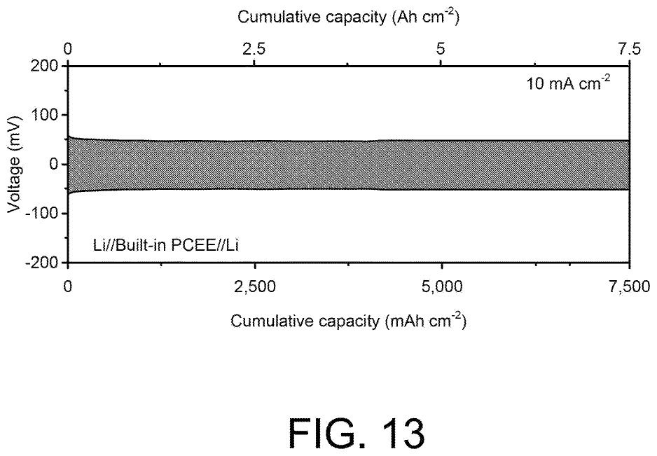

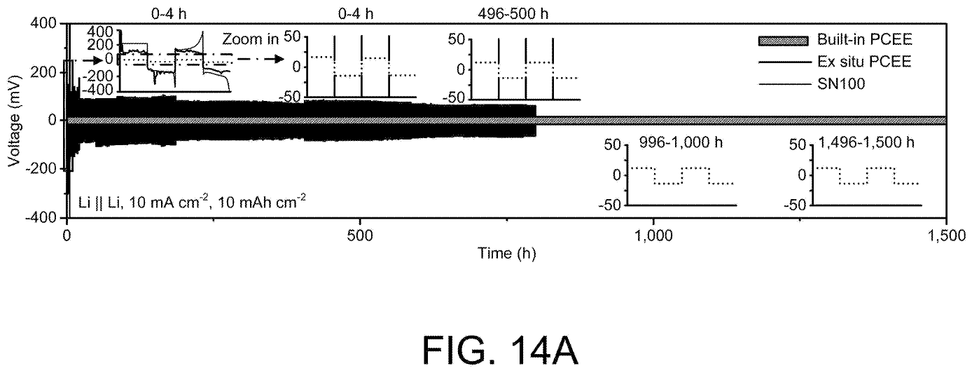

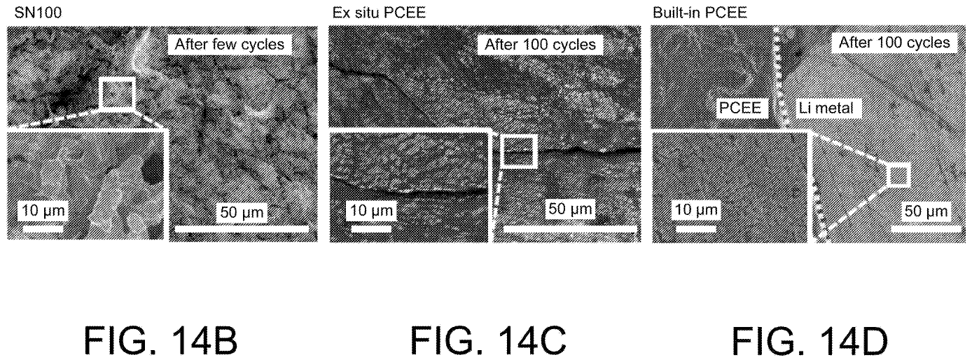

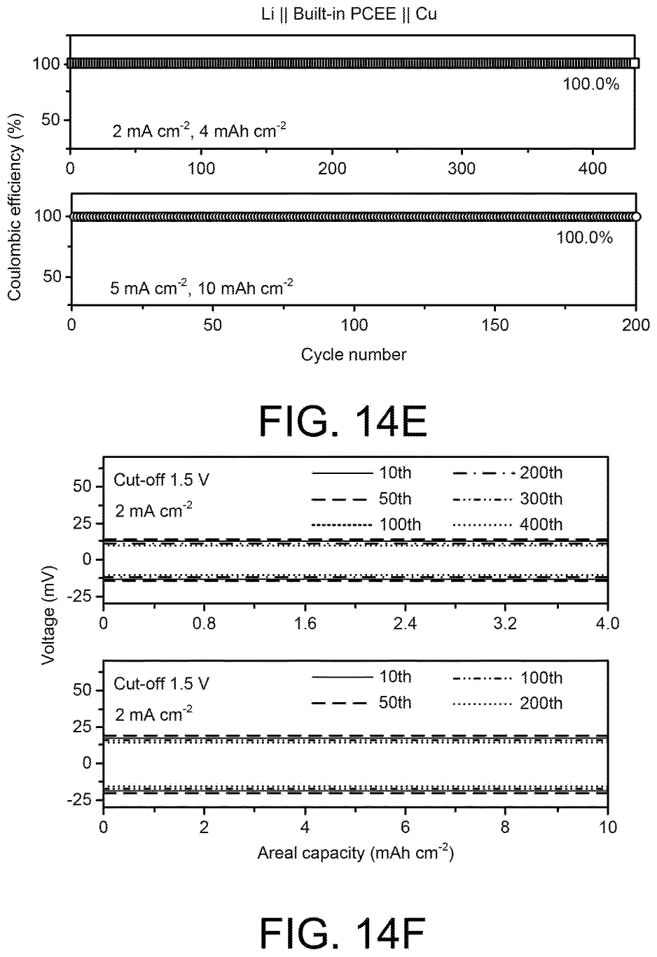

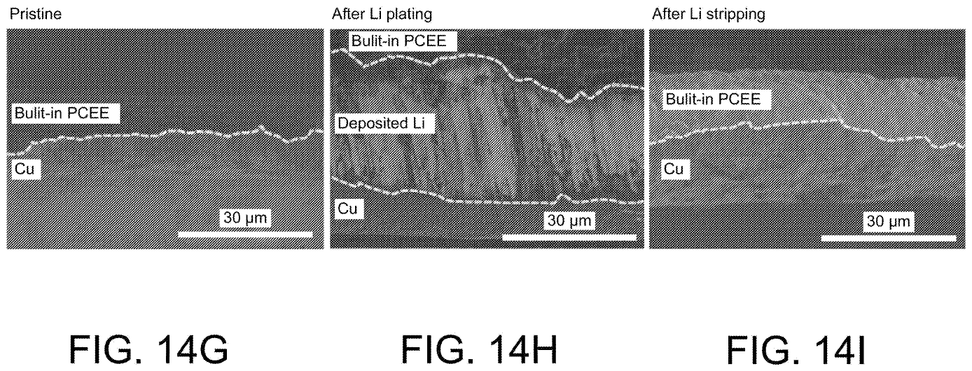

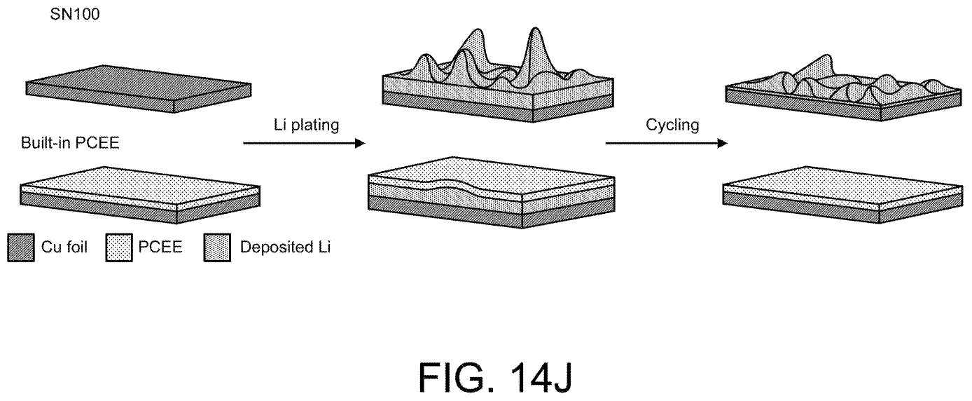

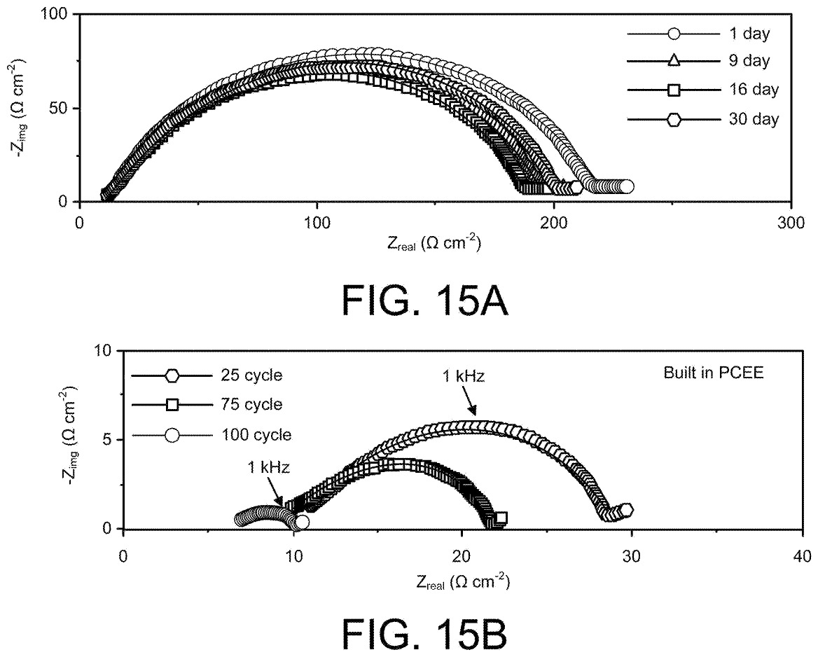

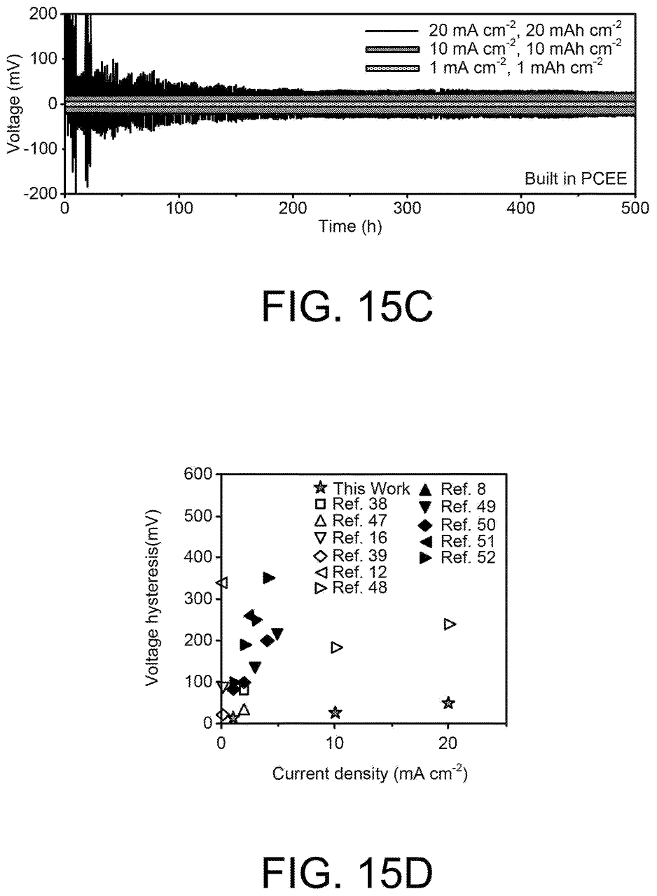

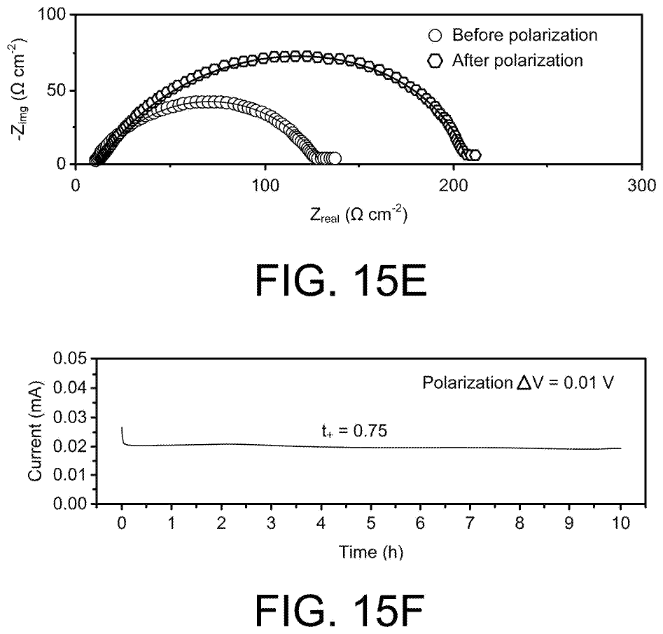

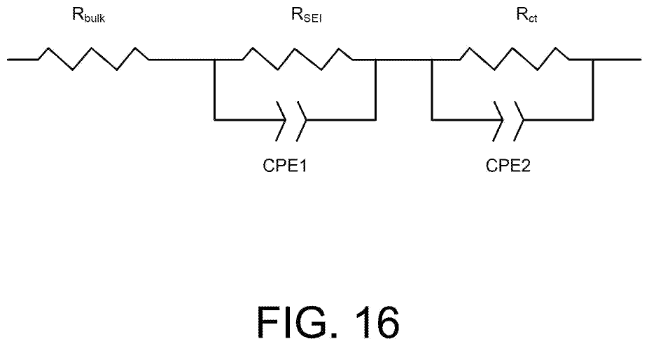

Since the built-in PCEE has demonstrated exceptional mechanical and electrochemical properties, it was decided to use it as a solid electrolyte. Li plating and stripping tests in symmetric Li cells using disclosed PCEE were performed (FIG. 14A). At a high current density of 10 mA cm⁻², the cell with SN100 lasted for only a few cycles. In contrast, the cell with the built-in PCEE showed excellent cycling performance with low polarization over 1,500 h, reaching a cumulative capacity of 7.5 Ah cm⁻² (FIG. 13). Specifically, an extremely low polarization of 13 mV at 10 mA cm⁻² was observed for the built-in PCEE, which is considerably lower than that of the ex situ PCEE (63-111 mV). This low polarization can be attributed to the conformal coating of the built-in PCEE on Li metal, which can substantially reduce the interfacial resistance and generate a uniform Li-ion flux. It is noted that the ‘arch’ shape at the edge of the voltage profile, which is commonly observed with dendritic and dead Li accumulation, did not appear even after repeated plating and stripping of Li metal for 1.500 h (insets of FIG. 14A). These results far exceed the Advanced Research Projects Agency-Energy (ARPA-E) Integration and Optimization of Novel Ion-Conducting Solids (IONICS) goal based on current density, cumulative capacity, and per-cycle areal capacity. The compatibility of PCEE with Li metal was further supported based on the stable interfacial resistances (175 Ωcm⁻²) for 30 days at the Li-PCEE (solid-solid) Interface (FIG. 15A). In addition, as the cycle increased, the overall resistance of the built-in PCEE significantly decreased (FIG. 158). These results demonstrate that the in situ-polymerized PCEE can effectively reduce the interfacial resistance at the solid-solid interfaces, enabling ultra-stable Li plating and stripping cycles. The morphologies of the Li metal anodes with different electrolytes were compared after 100 cycles at 10 mA cm⁻². For SN100, Li metal showed a porous structure containing mossy and dead Li after only a few cycles (FIG. 14B), explaining the sudden failure of the Li cell (FIG. 14A). In contrast, the Li anodes with both the ex-situ and the built-In PCEEs showed a dense and uniform Li structure without dendritic Li after 100 cycles (200 h) (FIGS. 14C, 14D). However, after removing the attached PCEE film, Li metal with the built-in PCEE showed a much smoother surface (FIG. 14D) compared with that of the ex situ PCEE, which showed a wrinkled surface with cracks (FIG. 14C). The stability of the Li cell with the built-in PCEE was further investigated under higher current conditions of 20 mA cm⁻² and 20 mAh cm⁻² (FIG. 15C). After voltage fluctuations in the earlier cycles (<50 h), the Li ceil showed a stable polarization of 25-29 mV for 500 h. It is noted that the voltage hysteresis of the Li cells with the built-in PCEE at various current densities was significantly lower than those of previously reported polymer-based electrolytes (FIG. 15D). Next, the r value of the built-in PCEE was determined by using the Bruce-Vincent method (FIGS. 15E, 15F, FIG. 16).

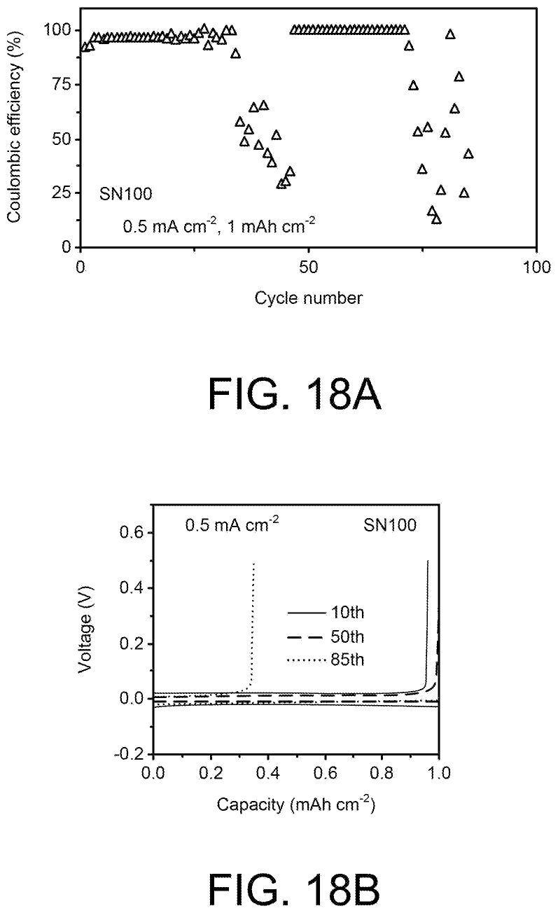

Notably, the built-in PCEE showed a high r value of 0.75, which is substantially higher than the t values of conventional organic liquid electrolytes (t⁺≈0.4) and PEO-based polymer electrolyte (t⁺<0.5). This excellent stability at high-rate Li plating and stripping cycles and high t⁺ value are crucial to enabling fast charging of LMBs. In addition, an inorganic-organic hybrid SEI layer was found in the built-in PCEE, which is beneficial for interfacial stability, whereas the SEI layer derived from SN100 was mainly composed of organic compounds (FIG. 17). The built-in PCEE also showed excellent stability and cyclability in asymmetric Li∥Cu cells (FIG. 14E). At 0.5 mA cm⁻² with 1 mAh cm⁻², the Coulombic efficiency (CE) of the Li∥Cu cell with SN100 fluctuated and faded out after 35 cycles (FIG. 18).

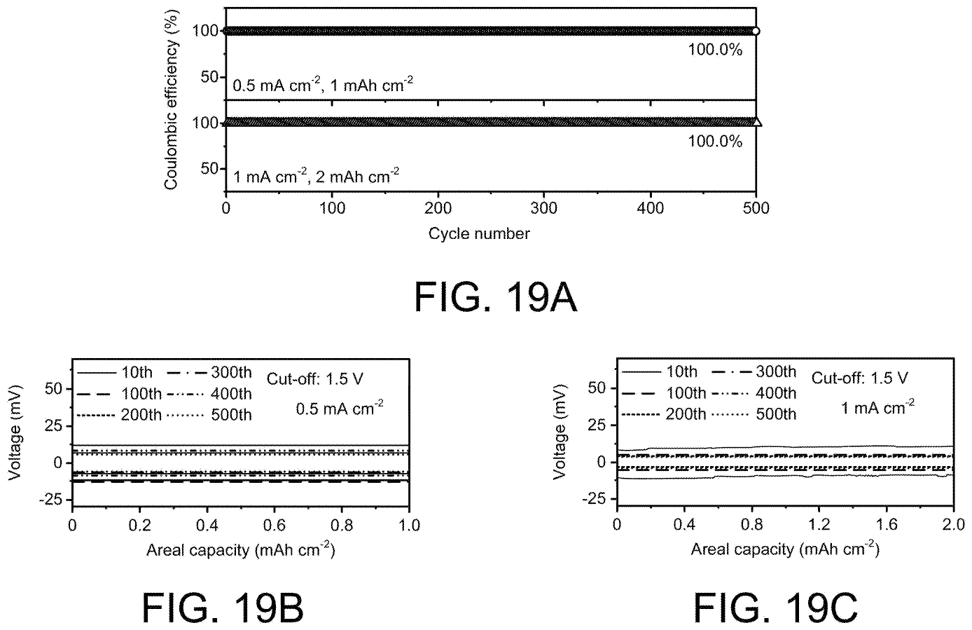

In stark contrast, the cell with the built-in PCEE showed a CE of 100.0% with a small polarization below 8 mV after 500 cycles (FIG. 19). The Li∥Cu cells with PCEEs further maintained a 100.0% CE at higher current densities of 2 mA cm⁻² and 5 mA cm⁻² with capacities of 4 mA cm⁻² and 10 mAh cm⁻² for 430 and 200 cycles, respectively (FIG. 14E, 14F). To better understand the cycling behavior, the morphological changes of the Li∥Cu cells with the built-in PCEE during the Li plating and stripping process were investigated. The cross-sectional SEM image showed that PCEE was conformally coated onto the copper (Cu) foil before electroplating (FIG. 14G). After the first Li plating at 0.5 mA cm⁻² with 1 mAh cm⁻², densely and uniformly deposited Li on the Cu foil was observed (FIG. 14H). After subsequent Li stripping, the Li deposited on the Cu foil disappeared completely (FIG. 14I). These results indicate that PCEE with high elasticity and strong adhesion successfully accommodated large volume changes during Li plating (FIG. 14J). In addition, the resilience of the built-in PCEE allowed the system to return to its original state without having any deformation after the stripping process. Thus, the ultra-stable cycling process of the cells with PCEE stems from its superior mechanical and interfacial properties.

### Demonstrating High-Energy Li Batteries

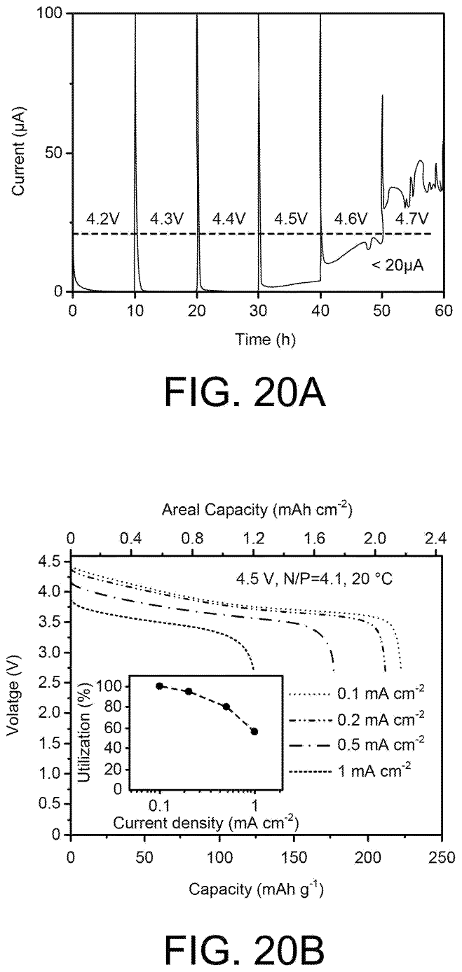

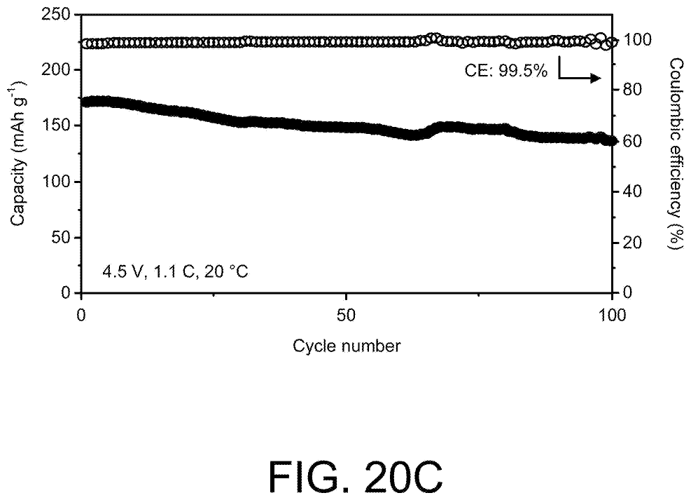

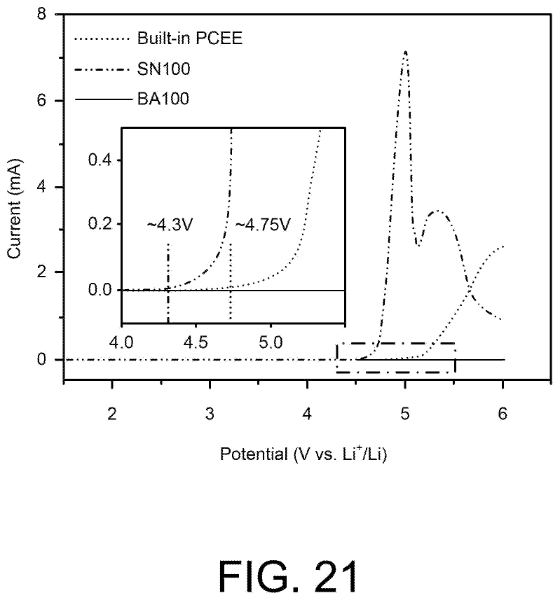

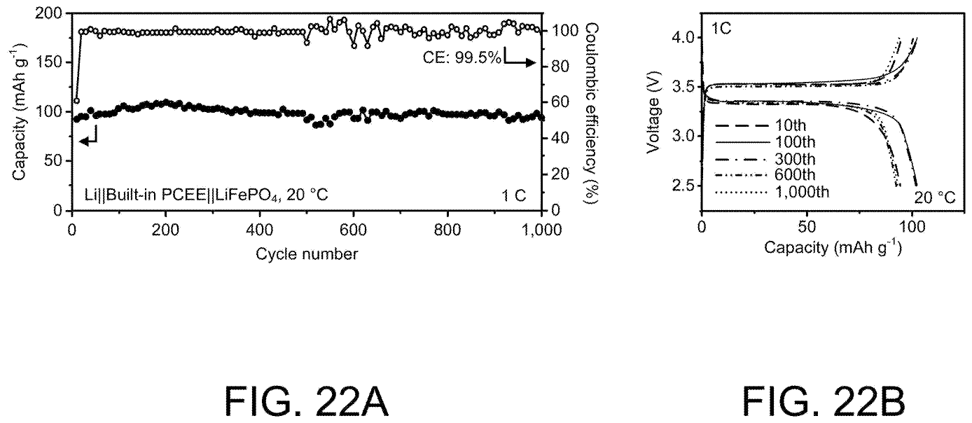

The built-in PCEE with various cathodes, including LiFePO₄ (LFP), LiNi_{0.6}Mn_{0.2}Co_{0.2}O₂ (NMC-622), and NMC-83 cathodes, for solid-state LMB applications, was investigated. Before battery performance testing, an electrochemical floating experiment of PCEE was performed to strictly define the feasible electrochemical window (FIG. 19A). The measured leakage current was less than 20 μA up to 4.6 V, which is consistent with the linear-sweep voltammetry results showing an oxidation wave at 4.75 V (FIG. 21). Thus, the excellent oxidative stability of PCEE allows for stable operation (rate capability and cycling) with NMC-622 cathodes at a high voltage of 4.5 V (FIGS. 20B, 20C). It is noted that the use of SPEs with high-voltage cathodes has been limited to a voltage of 4.3 V. Thus, this study demonstrates the stable operation of SPE-based all-solid-state LMBs at a high voltage of 4.5 V at ambient temperature. In addition, the full cell with an LFP cathode maintained a discharge capacity of 93 mAh g⁻¹ at 1 C without significant capacity fading (0.005% per cycle) over 1,000 cycles at 20° C. (FIG. 22). Towards high-energy LMBs, there is a strong demand for fun cells with a limited source of Li metal anode, a high-loading cathode, and a thin solid electrolyte.

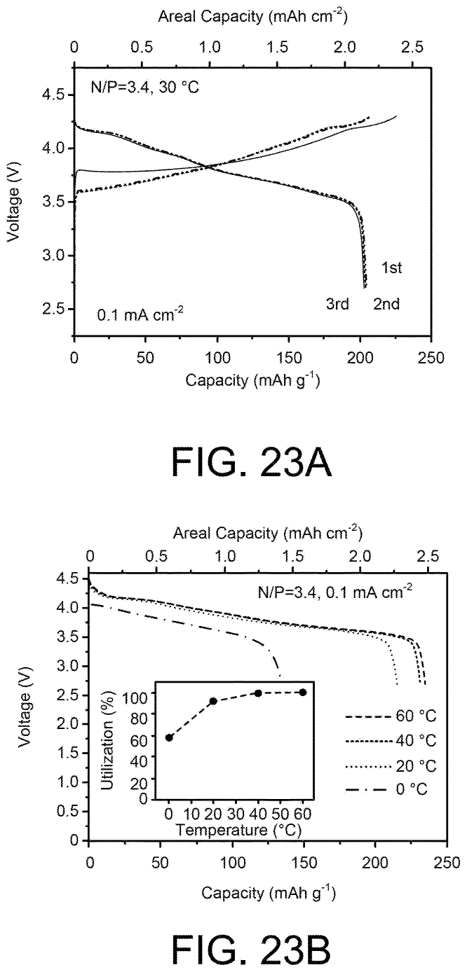

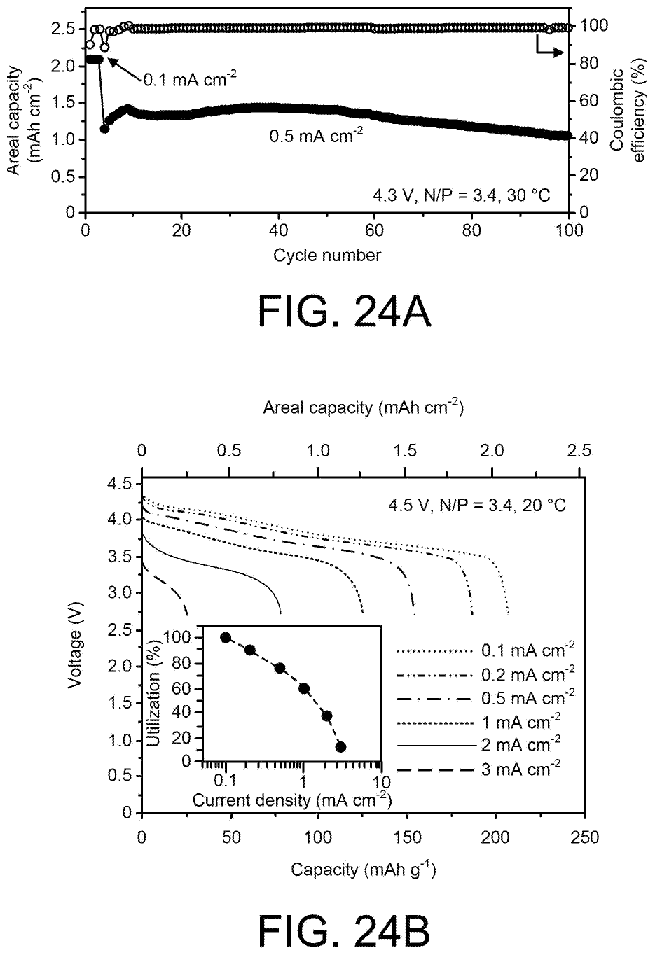

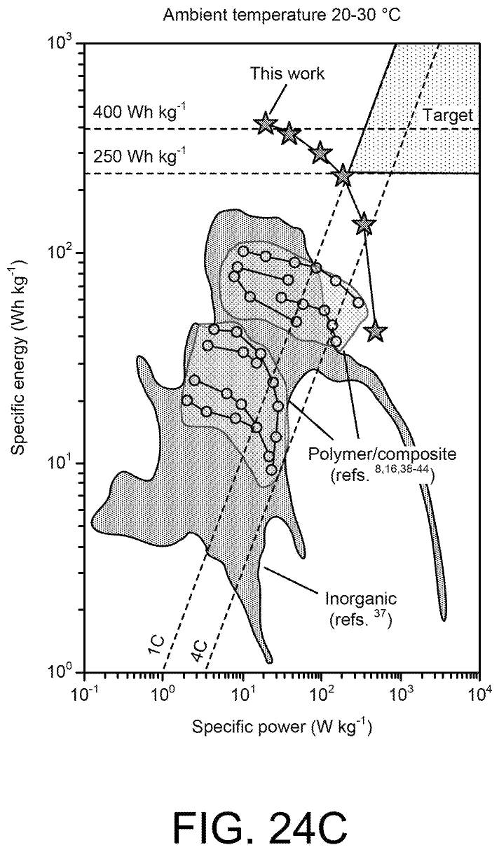

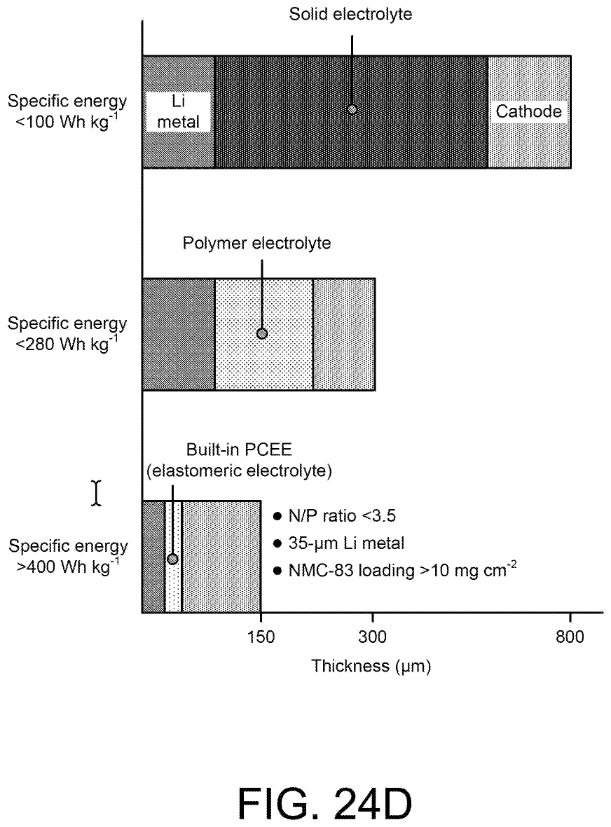

We further performed electrochemical tests of the full cell with a low negative/positive capacity (N/P) ratio of 3.4 (35-μm-thick Li anode; 25-μm-thick built-in PCEE; high-loading NMC-83 (>10 mg cm⁻²)). The full col delivered a high capacity of 2.1 mAh cm⁻² during the initialization cycles at 0.1 mA cm⁻² (FIG. 23A). Thereafter, the cell maintained a capacity of 1.1 mAh cm⁻² (88% capacity retention) with a CE of 99.4% at 0.5 mA cm⁻² after 100 cycles at 30° C. (FIG. 24A). In addition, the rate capability of the cell was evaluated at various current densities from 0.1 mA cm⁻² to 3 mA cm⁻² (FIG. 24B). The cell exhibited a capacity of 1.3 mAh cm⁻² at a high rate of 1 mA cm⁻² (60% of its capacity at 0.1 mA cm⁻²), demonstrating excellent rate capability (inset of FIG. 248). The temperature-dependent voltage profile of the cell from 60° C. to 0° C. (FIG. 23B) was further investigated. The full cell showed a negligible capacity drop from 60° C. to 40° C. (99%) and retained 92% of its capacity at 20° C. and 57% at 0° C. (inset of FIG. 23B).

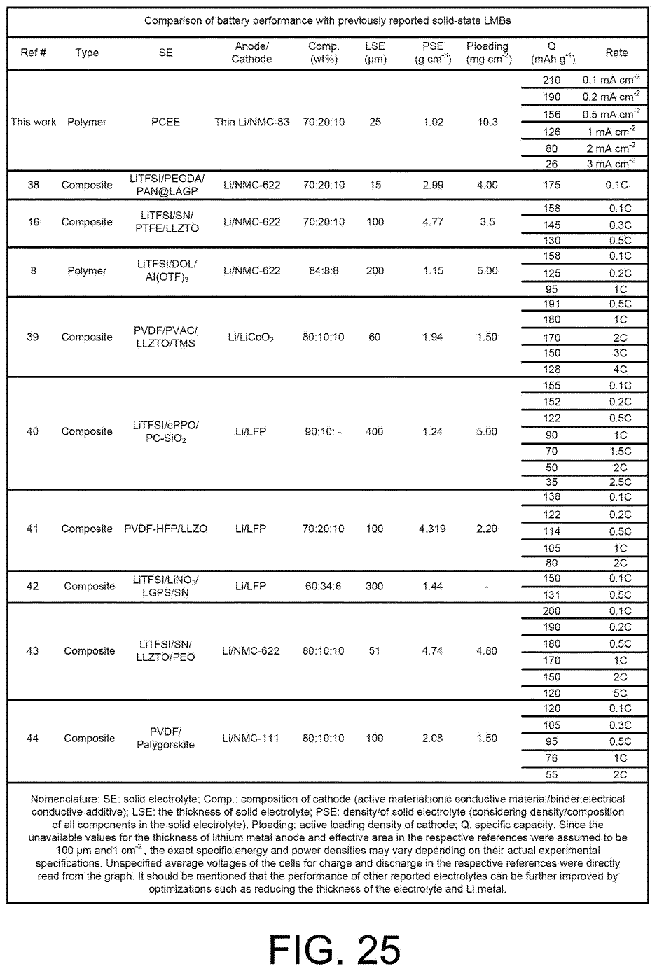

The excellent rate and low-temperature performances can be attributed to the exceptionally high ionic conductivity and r of PCEE. The specific energy and power of all-solid-state LMBs at ambient temperature were calculated based on the weight of the anode, cathode, and solid electrolyte using a Ragone-type plot (FIG. 24C, FIG. 25). The full cell with the NMC-83 cathode exhibited high specific energy exceeding 410 Wh kg⁻¹ (791 Wh kg_{NMC-83}⁻¹) and maintained high specific energy of 235 Wh kg⁻¹ at 184 W kg⁻¹ at ambient temperature. These performances of the full cell with thin PCEE are much higher than any of the previously reported cells using ceramic, polymer, or composite electrolytes tested at ambient temperature (FIGS. 23C, 23D).

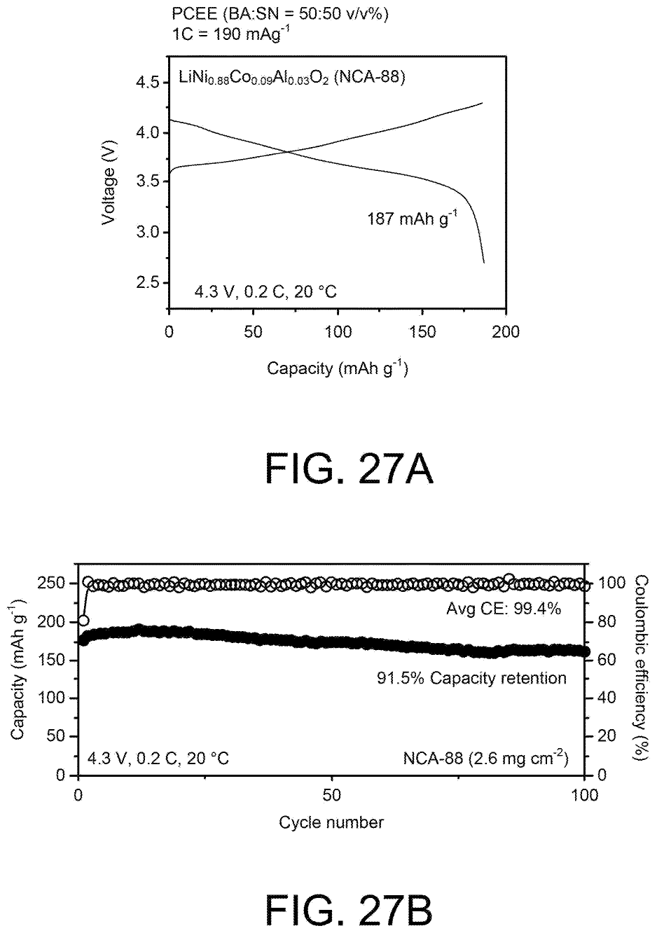

It was also found that PCC can be used for LiNiₓCo_{y}Al_{z}O₂(NCA) cathode, as shown in FIGS. 27A-27B.

### Example 3

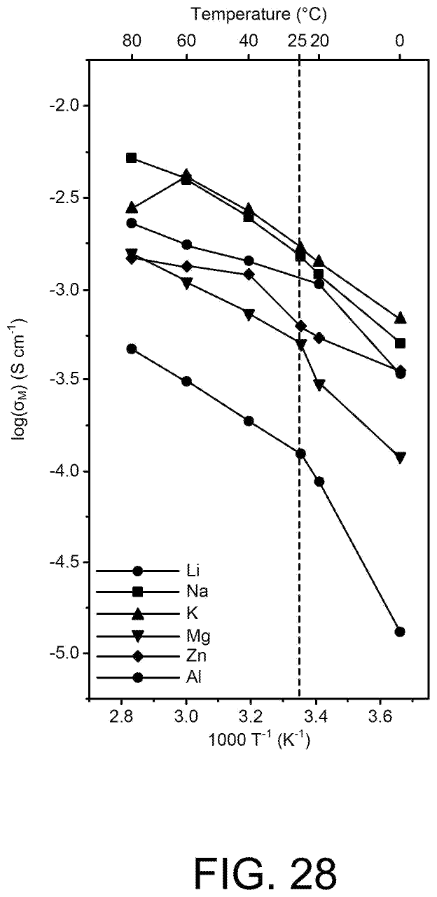

In addition to Li-Ions, PCEE has high ion conductivities (FIG. 28) for various metal cations, including Na, K, Mg, Zn, and Al. Therefore, PCEE can be used for various metal batteries.

Without wishing to be bound by any theory, it was hypothesized that the specific energy of the cells can be further increased by changing the cathode structures or stacking cells multiple times. In summary, a class of SPEs based on an in situ formation of an elastomer electrolyte containing a 3D interconnected plastic crystal phase is reported. It was found that this class can successfully combine the advantages from both elastomer and plastic crystal, including high ionic conductivity, superior mechanical properties, electrochemical stability, low interfacial resistance, and high Li-ion transference number. The built-in PCEEs enabled excellent cycling performances in the symmetric Li and asymmetric Li∥Cu cells with low voltage hysteresis below 26 mV and 100.0% CEs. Finally, under the constrained conditions of a limited Li source and a high-loading NMC cathode (N/P ratio <3.4), the stable operation of a PCEE-based solid-state LMB with high specific energy and power at ambient temperature was demonstrated. Without wishing to be bound by any theory, it is assumed that disclosed herein elastomeric electrolyte system can be widely applied to the operation of various post-metal (for example, sodium, potassium, zinc, magnesium, and aluminum) batteries, including metal-air and metal-sulfur batteries, because of its excellent mechanical properties and high ionic conductivity.

### Example 4

### Fabrication of F-Containing Phase-Separated SPE

A study was conducted to develop a phase-separated SPE system that incorporates an F-containing elastomeric phase, assembled through in-situ polymerization of trifluoroethyl acrylate (TFEA) with a plastic crystal via PIPS. The resulting TFEA-based SPE (T-SPE) showed significant improvements in both mechanical and electrochemical properties, as well as enhanced interfacial stability when compared to an ethylene acrylate-based SPE (E-SPE) that lacks phase separation and F-chemistry. In contrast to the homogeneous structure of E-SPE, T-SPE exhibited a bi-continuous morphology with interconnected phases of ion-conductive plastic crystals, attributed to the immiscibility between the in-situ polymerized poly(TFEA) and the plastic crystal domains. In particular, T-SPE showed remarkable interfacial stability against Li metal anode and high-voltage cathode, with the LiF-rich SEI and CEI having enhanced Li reversibility with a chunky Li deposition and cathode stability with a compact interphase, respectively. The study demonstrated the cycling and rate performances of full cells under a set of stringent conditions: 5 μm-thick Li, thin T-SPE, high-loading LiNi_{0.83}Mn_{0.06}Co_{0.11}O₂ (NMC-83) cathode, high-operating voltage of 4.5 V, and low negative/positive (N/P) ratio of <0.5 at ambient temperature, to achieve high-specific energy and power of solid-state LMBs. The study showcased the rational design of phase-separated SPE systems using F-chemistry, which holds immense potential for achieving high-energy and -power solid-state LMBs.

The study demonstrated that combining bi-continuous structured polymer electrolytes, consisting of distinct elastomer and plastic crystal phases, with F-chemistry is highly effective for achieving high-energy and -power LMBs. Compared to homogenous structured E-SPEs, bi-continuous structured T-SPEs assembled with newly designed TFEA monomers displayed an unparalleled combination of high ionic conductivity, mechanical elasticity, and robust interfacial properties. Furthermore, the use of F-containing T-SPEs resulted in the formation of high-quality SEI and CEI, enriched with LiF, which significantly enhanced Li reversibility and electrode stability at both the Li metal anode and NMC-83 cathode. The full cell with a challenging configuration, including 5-μm thick U, thin T-SPE, high-loading NMC83, high-operating voltage of 4.5 V, and low N/P of <0.5, achieved outstanding specific energy exceeding 538 Wh kg_{anode+cathode+electrolyte}⁻¹ and maintained high specific energy of 393 Wh kg⁻¹ at a high specific power of 804 W kg⁻¹, which are the best performances reported to date for solid-state LMBs tested at ambient temperature. The findings of the study suggest that the F-containing phase-separated SPE system holds significant promise for achieving high-energy and -power solid-state LMBs suitable for practical battery applications.

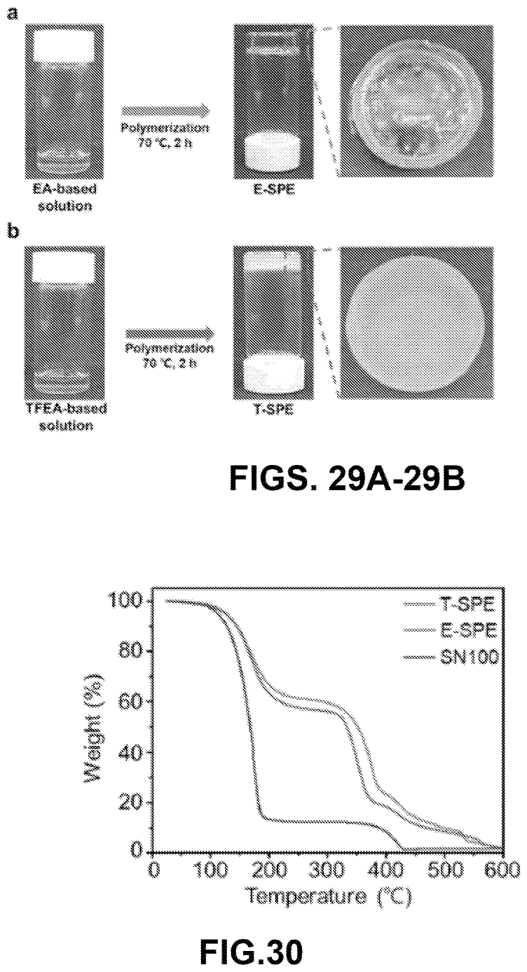

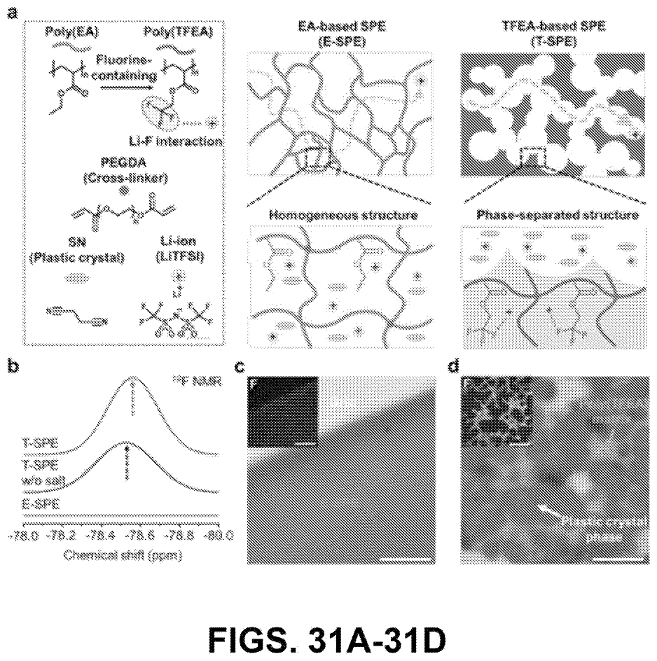

In the study, both E-SPE and T-SPE were synthesized from homogeneous mixtures of monomer-based and succinonitrile (SN)-based solutions by thermally-activated polymerization and crosslinking processes (FIGS. 29A-29B and FIG. 31A). The EA-based solution, which was comprised of EA, azobisisobutyronitrile (thermal initiator), poly(ethylene glycol) diacrylate (PEGDA) (cross-linker), and lithium bis(trifluoromethanesulfonyl)imide (LiTFSI), provided a scaffold for mechanical support in E-SPE by forming crosslinked poly(EA). For T-SPE, the TFEA-based solution was made with the same ingredients as the EA-based solution, except that TFEA monomers were used instead of EA. The SN-based solution was primarily composed of SN and LiTFSI and was used to create a highly ion-conductive SN-LiTFSI complex in E-SPE and T-SPE. Thermal gravimetric analysis (TGA) of both E-SPE and T-SPE showed that they had stable thermal stability over 130° C. due to their crosslinked polymer matrix (FIG. 30). The presence of F atoms in T-SPE and the interaction between —CF₃ and Li ions were confirmed using ¹⁹F solid-state nuclear magnetic resonance (NMR) spectroscopy, as shown in FIG. 31B. In T-SPE, a single ¹⁹F resonance peak at −79.1 ppm originated from —CF₃ of TFEA was observed, whereas the absence of ¹⁹F resonance peak in E-SPE was consistent with the chemical structure of EA. In addition, an upfield shift of 0.06 ppm at the ¹⁹F resonance peak of T-SPE relative to that of the salt-free T-SPE demonstrated the development of Li—F coordination between the —CF₃ of TFEA and the Li ions.

To investigate the impact of using F-containing TFEA monomers on the phase separation process, the study compared the morphology of E-SPE and T-SPE. The transparent digital photographs of E-SPE indicated a homogeneous state (FIG. 29). Conversely, T-SPE exhibited an opaque feature due to the refractive index mismatch between the phase-separated poly(TFEA) matrix and the SN phase. To further identify the phase-separated structure of T-SPE, cryogenic transmission electron microscopy (cryo-TEM) was performed. The cross-sectional cryo-TEM image of E-SPE showed a homogenous phase with uniformly distributed SN within the crosslinked poly(EA) matrix (FIG. 31C). In contrast, T-SPE exhibited separate domains of interconnected plastic crystals surrounded by a crosslinked poly(TFEA) matrix, as indicated by a pronounced phase contrast on length scales ranging from a few hundred nanometers to one micrometer (FIG. 31D). Additionally, electron energy loss spectroscopy (EELS) mapping analysis of T-SPE revealed a higher concentration of F atoms in the phase-separated poly(TFEA) matrix than in the plastic crystal phase. E-SPE showed no variation in F concentration, further confirming its homogeneous structure. The study attributes the observed structural contrast between E-SPE and T-SPE to the difference in hydrophobicity of the monomers used, which in turn affects the degree of immiscibility between the polymer matrix and the SN domain. Based on the Hansen solubility parameters (HSPs), the influence of monomer hydrophobicity on phase separation can be quantitatively understood by estimating the radius of interaction (Ra) between poly(EA)/poly(TFEA) and SN (Tables 1-3)

The estimations were done as follows:

### Estimation of Hansen Solubility Parameters (HSPs) and Radius of Interaction (Rₐ).

HSPs are numerical values associated with energies or intermolecular cohesive forces binding molecules in a substance. The HSP has three components where δ_{D}, δ_{P}, and δ_{H} are the London dispersion interaction, permanent dipole-permanent dipole interaction, and hydrogen bonding interaction, respectively. As given in Tables 1-3, each component is calculated using equations 1, 2, and 3 based on group values.

$${δ}_{D} = \frac{\sum {F}_{di}}{\sum V} \qquad ( 1 )$$

$${δ}_{P} = \frac{\sqrt{\sum {F}_{di}^{2}}}{\sum V} \qquad ( 2 )$$

$${δ}_{H} = \frac{\sqrt{\sum {U}_{hi}}}{\sum V} \qquad ( 3 )$$

The radius of interaction (Rₐ) means the similarity between two substances in the Hansen solubility space in which the three HSPs are coordinated on the x, y, and z axes. For the calculation of Rₐ values using equation 4, the HSPs of EA, TFEA, and SN are estimated. The δ_{D}, δ_{P}, and δ_{H} parameters of EA, TFEA, and SN are estimated to be (17.29 MPa^{1/2}, 5.92 MPa^{1/2}, and 9.20 MPa^{1/2}), (16.7 MPa^{1/2}, 5.10 MPa^{1/2}, and 8.50 MPa^{1/2}), and (17.46 MPa^{1/2}, 19.4 MPa^{1/2}, and 7.90 MPa^{1/2}). Each Rₐ value is 13.55 MPa^{1/2} between poly(EA) and SN, and 14.33 MPa^{1/2} between poly(TFEA) and SN, respectively.

$$Ra = \sqrt{4 {( {δ}_{D 2} - {δ}_{D 1} )}^{2} + {( {δ}_{P 2} - {δ}_{P 1} )}^{2} + {( {δ}_{H 2} - {δ}_{H 1} )}^{2}} \qquad ( 4 )$$

TABLE 1
Functional group contribution terms used for calculating Hansen solubility parameters
(HSPs) of poly(EA). From the calculation above, δ_{D}, δ_{P}, and δ_{H} parameters were
estimated to be 17.29 MPa^{1/2}, 5.92 MPa^{1/2}, and 9.20 MPa^{1/2}, respectively.

| Functional | | V | F_{di} | Fₚᵢ | Uₕᵢ |
|---|---|---|---|---|---|
| Group | Occurrences | (cm³ mol⁻¹) | (J^{1/2} cm^{3/2} mol⁻¹) | (J^{1/2} cm^{3/2} mol⁻¹) | (J mol⁻¹) |
| —CH₃ | 1 | 33.5 | 420 | 0 | 0 |
| —CH₂— | 2 | 16.1 | 270 | 0 | 0 |
| >CH— | 1 | −1.0 | 80 | 0 | 0 |
| —COO— | 1 | 18.0 | 390 | 490 | 7000 |
| Functional | | ΣV | ΣF_{di} | ΣFₚᵢ² | ΣUₕᵢ |
| Group | Occurrences | (cm³ mol⁻¹) | (J^{1/2} cm^{3/2} mol⁻¹) | (J^{1/2} cm^{3/2} mol⁻¹) | (J mol⁻¹) |
| —CH₃ | 1 | 33.5 | 420 | 0 | 0 |
| —CH₂— | 2 | 32.2 | 540 | 0 | 0 |
| >CH— | 1 | −1.0 | 80 | 0 | 0 |
| —COO— | 1 | 18.0 | 390 | 240100 | 7000 |
| Total | | 82.7 | 1430 | 240100 | 7000 |

The Rₐ value measures the degree of immiscibility between two substances. In the case of the poly(EA) and SN pair, the Rₐ value was 13.55 MPa^{1/2}, while for the poly(TFEA) and SN pair, it Increased to 14.33 MPa^{1/2}. The increased Immiscibility between poly(TFEA) and SN facilitates phase separation during in-situ polymerization, while the growth and crosslinking of poly(TFEA) kinetically trap the ion-conducting plastic crystal phase

TABLE 2
Functional group contribution terms used for calculating HSPs of poly(TFEA).
From the calculation above, δ_{D}, δ_{P}, and δ_{H} parameters were estimated to be
16.7 MPa^{1/2}, 5.10 MPa^{1/2}, and 8.50 MPa^{1/2}, respectively.

| Functional | | V | F_{di} | Fₚᵢ | Uₕᵢ |
|---|---|---|---|---|---|
| Group | Occurrences | (cm³ mol⁻¹) | (J^{1/2} cm^{3/2} mol⁻¹) | (J^{1/2} cm^{3/2} mol⁻¹) | (J mol⁻¹) |
| —CH₂— | 2 | 16.1 | 270 | 0 | 0 |
| >CH— | 1 | −1.0 | 80 | 0 | 0 |
| —COO— | 1 | 18.0 | 390 | 490 | 7000 |
| >C< | 1 | −19.2 | −70 | 0 | 0 |
| —F | 3 | 22.0 | 220 | 0 | 0 |
| Functional | | ΣV | ΣF_{di} | ΣFₚᵢ² | ΣUₕᵢ |
| Group | Occurrences | (cm³ mol⁻¹) | (J^{1/2} cm^{3/2} mol⁻¹) | (J^{1/2} cm^{3/2} mol⁻¹) | (J mol⁻¹) |
| —CH₂— | 2 | 32.2 | 540 | 0 | 0 |
| >CH— | 1 | −1.0 | 80 | 0 | 0 |
| —COO— | 1 | 18.0 | 390 | 490 | 7000 |
| >C< | 1 | −19.2 | −70 | 0 | 0 |
| —F | 3 | 66.0 | 660 | 0 | 0 |
| Total | | 96 | 1600 | 240100 | 7000 |

TABLE 3
Functional group contribution terms used for calculating HSPs of SN.
From the calculation above, δ_{D}, δ_{P}, and δ_{H} parameters were estimated to be
17.46 MPa^{1/2}, 19.4 MPa^{1/2}, and 7.90 MPa^{1/2}, respectively.

| Functional | | V | F_{di} | Fₚᵢ | Uₕᵢ |
|---|---|---|---|---|---|
| Group | Occurrences | (cm³ mol⁻¹) | (J^{1/2} cm^{3/2} mol⁻¹) | (J^{1/2} cm^{3/2} mol⁻¹) | (J mol⁻¹) |
| —CH₂— | 2 | 16.1 | 270 | 0 | 0 |
| —CN | 2 | 24.0 | 430 | 1100 | 2500 |
| Functional | | ΣV | ΣF_{di} | ΣFₚᵢ² | ΣUₕᵢ |
| Group | Occurrences | (cm³ mol⁻¹) | (J^{1/2} cm^{3/2} mol⁻¹) | (J^{1/2} cm^{3/2} mol⁻¹) | (J mol⁻¹) |
| —CH₂— | 2 | 32.2 | 540 | 0 | 0 |
| —CN | 2 | 48.0 | 860 | 2420000 | 5000 |
| Total | | 179.3 | 3050 | 2420000 | 5000 |

### Properties of F-Containing Phase-Separated SPE

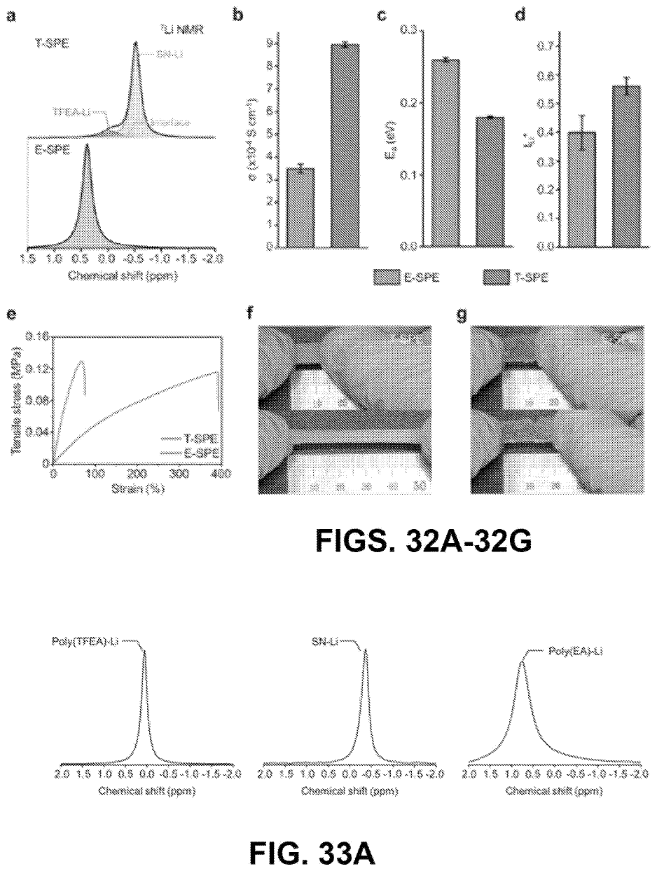

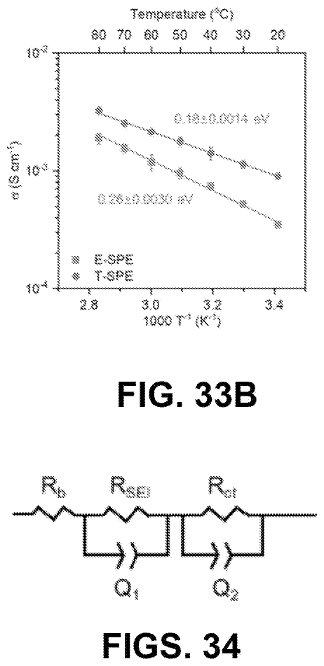

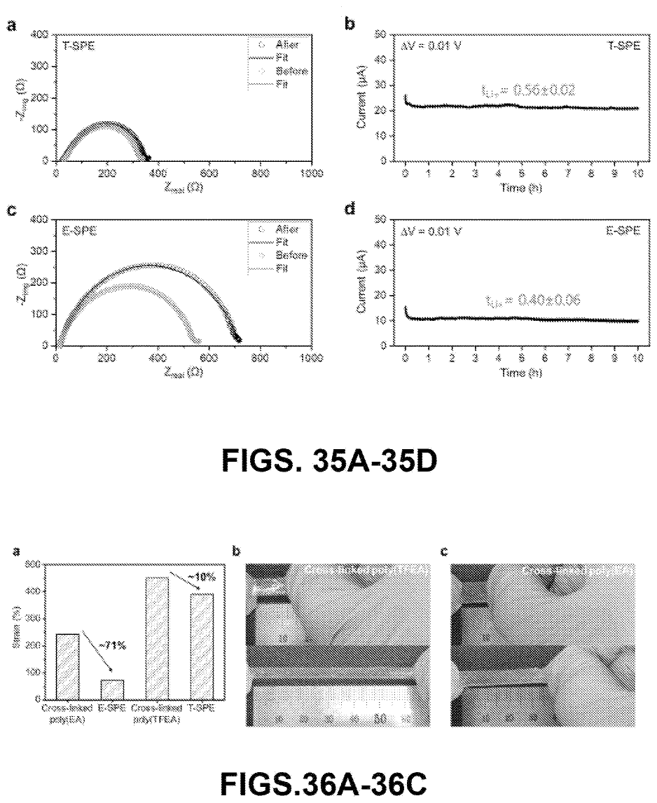

Li-ion distribution in T-SPE and E-SPE was investigated using ⁷Li solid-state NMR spectroscopy (FIG. 32A). To elucidate the interactions of Li ions with T-SPE and E-SPE, we observed the ⁷Li resonance peaks of poly(TFEA)-Li, poly(EA)-Li, and SN-Li (FIG. 33A). The ⁷Li resonance of T-SPE can be deconvoluted to three distinct peaks (−0.06, −0.51, and −0.31 ppm), correlate to Li-ion interactions with different domains of the crosslinked poly(TFEA) matrix, SN, and interfaces between the polymer matrix and SN, indicating the presence of distinct poly(TFEA) and plastic crystal phases within T-SPE. Conversely, E-SPE exhibited only one ⁷Li resonance peak at 0.39 ppm, indicating a homogenous mixture of SN and poly(EA) film without any phase separation. At 20° C. and 0.6 M of Li-salt concentration, T-SPE exhibited a significantly higher ionic conductivity of 9.0×10⁻⁴ S cm⁻¹ compared to that of E-SPE (3.5×10⁻⁴ S cm⁻¹) (FIG. 32B and FIG. 338) and had a lower activation energy (Eₐ) of 0.17 eV compared to that of E-SPE (0.26 eV) (FIG. 32C and FIG. 338). The results suggest that the dissociation of ion pairs and local ion hopping occur more efficiently through the independently-formed SN phase of T-SPE compared to the homogeneously distributed SN molecules in E-SPE. The Bruce-Vincent method was used to investigate the transference number (t_{Li+}) of T-SPE and E-SPE (FIG. 32D, FIG. 34, FIGS. 35A-35D). The analysis showed T-SPE to exhibit a higher t_{Li+} of 0.56 than that of 0.4 for E-SPE, which is beneficial for fast charge-discharge capability.

The ability of SPEs to withstand large volume changes of Li metal and suppress dendritic Li growth highly depends on their mechanical properties, and in particular, high elasticity is a critical factor in improving cycling stability. Therefore, stress-strain curves for E-SPE and T-SPE were measured using a universal tensile machine (UTM). The bi-continuous T-SPE exhibited very high extensibility (elongation at break ≈390%), whereas E-SPE with a homogeneous structure showed poor extensibility (elongation at break-70%) (FIGS. 32E-32F). This indicates that the 3D interconnected SN phase in T-SPE does not degrade the mechanical robustness of the F-containing elastomer matrix, showing only a ~10% reduction in the elongation at break value compared to the crosslinked poly(TFEA) alone (FIG. 32E, 32F and FIGS. 36A-36C). On the other hand, E-SPE with a homogeneous structure showed poor extensibility (elongation at break ≈70%) in spite of the high elasticity of the pristine crosslinked poly(EA) sample (elongation at break ≈250%) (FIG. 32E, 32G and FIGS. 36A-36C). The drastic decrease of the elasticity of E-SPE (72% reduction in the elongation at break) is caused by the homogeneously dispersed fragile SN, which interferes with the continuous phase of the polymer matrix that is important in dissipating mechanical stresses during the stretching.

### Electrochemical Performances of F-Containing Phase-Separated SPE

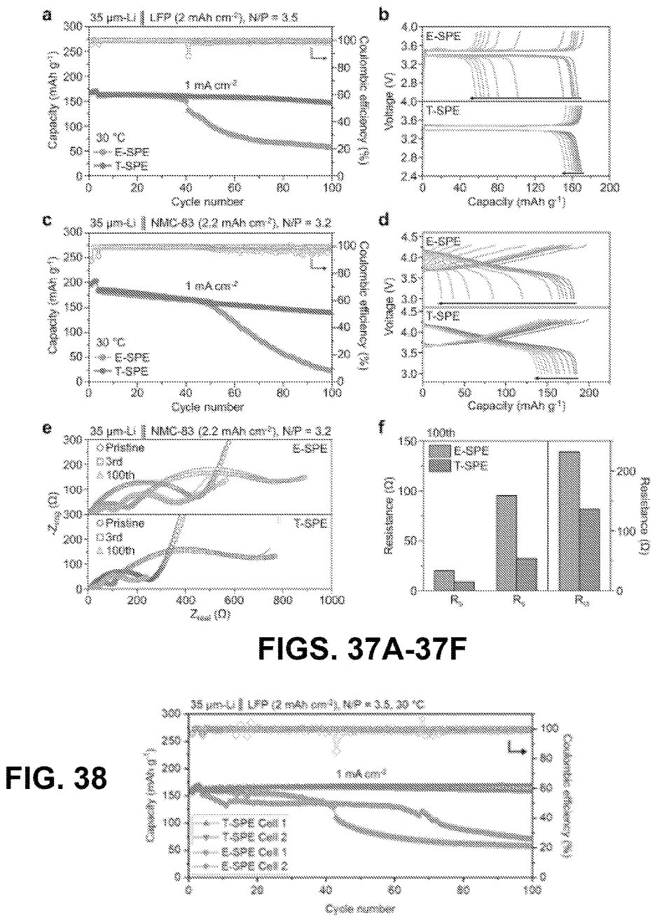

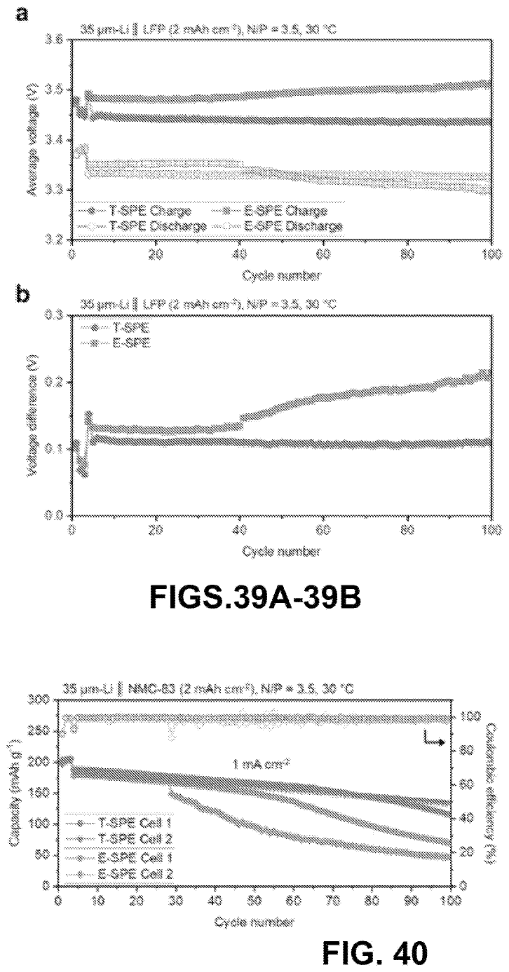

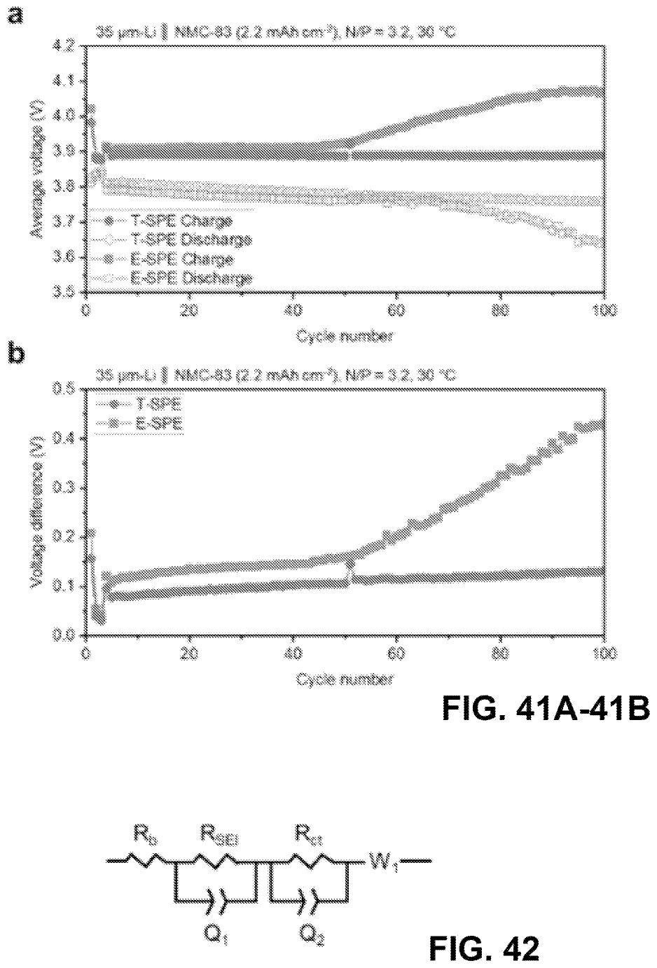

To evaluate the feasibility of T-SPEs for practical battery operation, full cells configured with a 35 μm-thick Li metal anode, a 25 μm-thick SPE, and high-loading cathodes (>2 mAh cm⁻²) were prepared (FIGS. 37A-37F). The N/P ratios of the full cells were below 3.5, and the full cells were tested at 1 mA cm⁻² (approximately 0.5 C) after three formation cycles at 0.2 mA cm⁻². The experimentation involved first conducting cycling tests of the full cells with LiFePO₄ (LFP) cathodes (>12 mg cm⁻²) (FIG. 37A). The full cell with E-SPE exhibited poor cycling stability, retaining only 35% capacity with an average CE of 98.9% (4th-100th) after 100 cycles at 1 mA cm⁻², whereas T-SPE maintained a high capacity of 147 mAh g⁻¹ (1.8 mAh cm⁻²) with an average CE of 99.8% under the same conditions (FIG. 378 and FIGS. 38, 39). The experimentation also assessed the cycling stability of fun cells with practical loading of single-crystal LiNi_{0.83}Mn_{0.06}Co_{1.11}O₂ (NMC-83) cathode (>11 mg cm⁻²) (FIG. 37C). Despite showing similar capacities to T-SPE at an early stage of cycling, the full cell with E-SPE experienced a drastic capacity fade after 50 cycles, whereas the full cel with T-SPE maintained a high capacity of 139 mAh g⁻¹ (1.6 mAh cm⁻²) with an average CE of 99.5% (4th-100th) after 100 cycles (FIG. 37D). Replicated cells with T-SPE further confirmed this superior cycling performance compared to E-SPE (FIGS. 40,41). Electrochemical impedance spectroscopy (EIS) of full cells at different cycles showed lower overall resistances of T-SPE compared to E-SPE (FIG. 37E). Quantitative resistances of Nyquist plots were obtained by fitting the equivalent circuit model (FIG. 37F and FIG. 42). Surface film resistance (Rₛ) and charge transfer resistance (R_{ct}) of T-SPE were lower than E-SPE, while bulk resistance (R_{b}) was comparable at 100th cycle. The results suggest that using T-SPE with F chemistry can create highly robust and conductive interphases, which effectively suppress dendritic Li growth, prevent cathode degradation, and thus enhance cycling stability.

### Characterization of the Cycled-Li Metal Anode and NMC Cathode

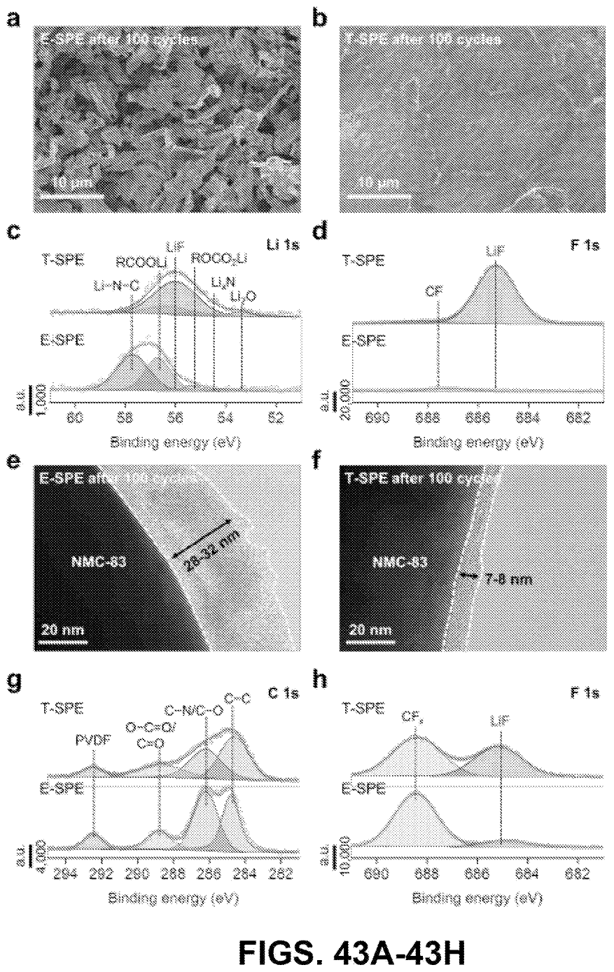

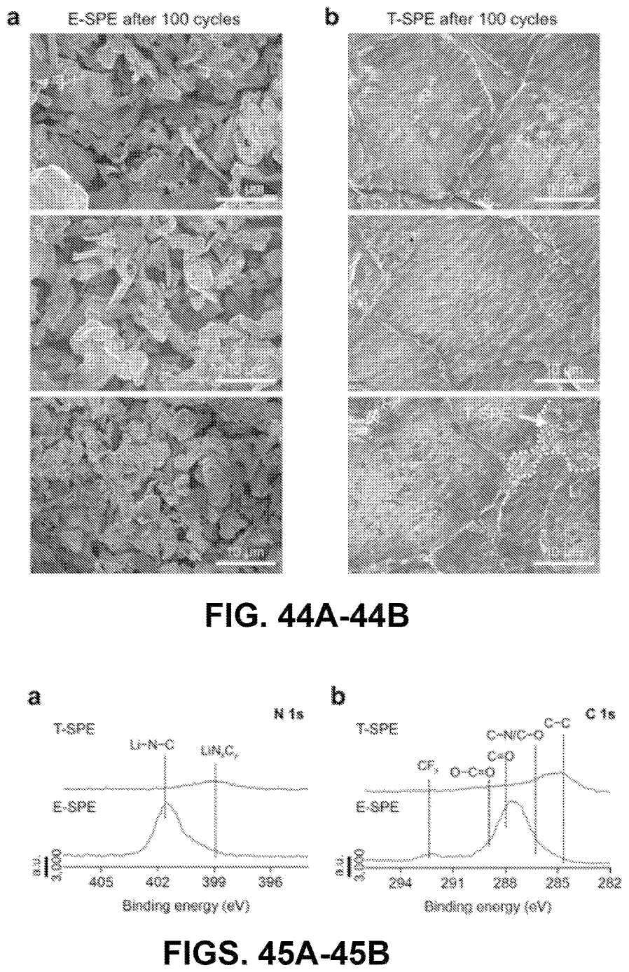

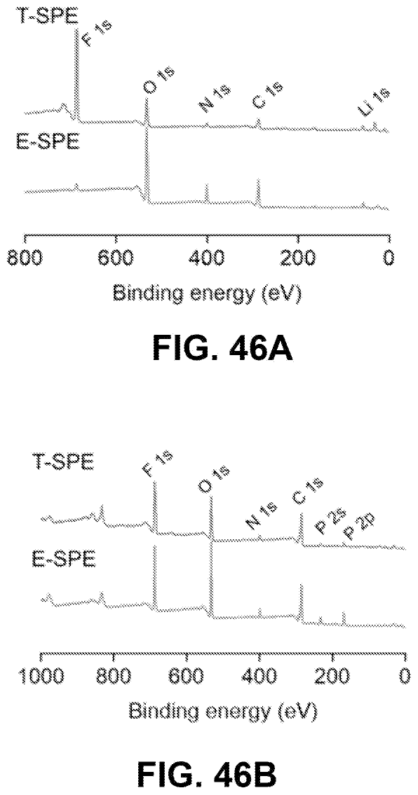

To better understand the origin of superior cycling stability achieved with T-SPE, the study characterized the structures of cycled-Li metal anodes (35 μm) and -NMC-83 cathodes (>10 mg cm⁻²) after 100 cycles at 1 mA cm⁻². The scanning electron microscopy (SEM) Images showed that after 100 cycles, the Li metal anode in E-SPE transformed into highly porous Li with numerous Li whisker and mossy Li (FIG. 43A and FIG. 44A). This morphological instability is consistent with the diminished cycling performance and the impedance growth. In contrast, the deposited Li in T-SPE displayed favorable Li morphology without dendritic Li (FIG. 43B and FIG. 44B). The diameter of the densely deposited Li was larger than 15 μm, with few grain boundaries. This chunk-Li morphology explains the outstanding cycling performance with low impedance observed after cycling under stringent conditions. The study also investigated the chemical compositions of the SEI on the cycled-Li metal anode in E-SPE and T-SPE using X-ray photoelectron spectroscopy (XPS). The Li is spectra showed that the SEI derived from T-SPE contained a significant amount of inorganic compounds (LiF and Li₂O) compared to organic compounds (Li—N—C, RCOOLi, and ROCO₂Li), whereas the SEI derived from E-SPE consisted mainly of organic compounds (FIG. 43C). This was further confirmed by the intense peak assigned to Li—N—C in the N 1s spectra (FIG. 45A) and the high content of organic compounds (C—C, C═O, O—C═O, and C—N/C—O) primarily originating from poly(EA) of E-SPE in the C 1s spectrum (FIG. 45B). In contrast, the LiF-rich SEI on the cycled-Li metal anode in T-SPE was confirmed by the LiF peak at 685.2 eV in the F is spectra (FIG. 43D). T-SPE showed a high concentration of the inorganic compound of LiF, which has been shown to effectively suppress dendritic Li and promote uniform U deposition whereas only a scant amount of LiF was observed in the SEI derived from E-SPE. This difference is clearly reflected in the atomic F-to-oxygen (F/O) ratios: 3.01 for T-SPE and 0.05 for E-SPE (FIG. 46A). Therefore, the stable cycling and uniform Li deposition observed in T-SPE can be attributed to the LiF-rich SEI (FIGS. 37A-37F, 43A, 43B). Moreover, the enrichment of LiF can effectively prevent the subsequent decomposition of the SPEs during cycling and enhance Li-Ion diffusion throughout the SEI.

High-resolution TEM (HR-TEM) images were used to examine the development of CEI in cycled-NMC-83 cathodes under different SPEs. The image showed that in E-SPE, the cathode surface was covered by a thick and non-uniform CEI with a thickness of ~28-32 nm due to a phase transition of the cathode and CEI reconstruction upon cycling (FIG. 43E). In sharp contrast, the cycled-NMC-83 cathode in T-SPE had a conformal and compact CEI with a thickness of ~7-8 nm, which is advantageous for facile Li-ion transport and structural stability of the cathode (FIG. 43F). The XPS C 1s spectra showed that the peak intensity ratio of C—O to C—C in E-SPE (1.06) was higher than that in T-SPE (0.75). Indicating that poly(EA) decomposition was aggravated in E-SPE (FIG. 43G). Moreover, the F 1s spectrum of T-SPE exhibited a significantly stronger LiF peak than that of E-SPE, with atomic F to oxygen (F/O) ratios of 0.98 and 0.53 for T-SPE and E-SPE, respectively (FIG. 43H and FIG. 468). The presence of a LiF-rich CEI on the cathode surface in T-SPE contributed to a more robust CEI and suppressed parasitic reactions, such as transition metal dissolution and gas evolution.

High-Energy and -Power Solid-State LMBs with F-Containing Phase-Separated SPE

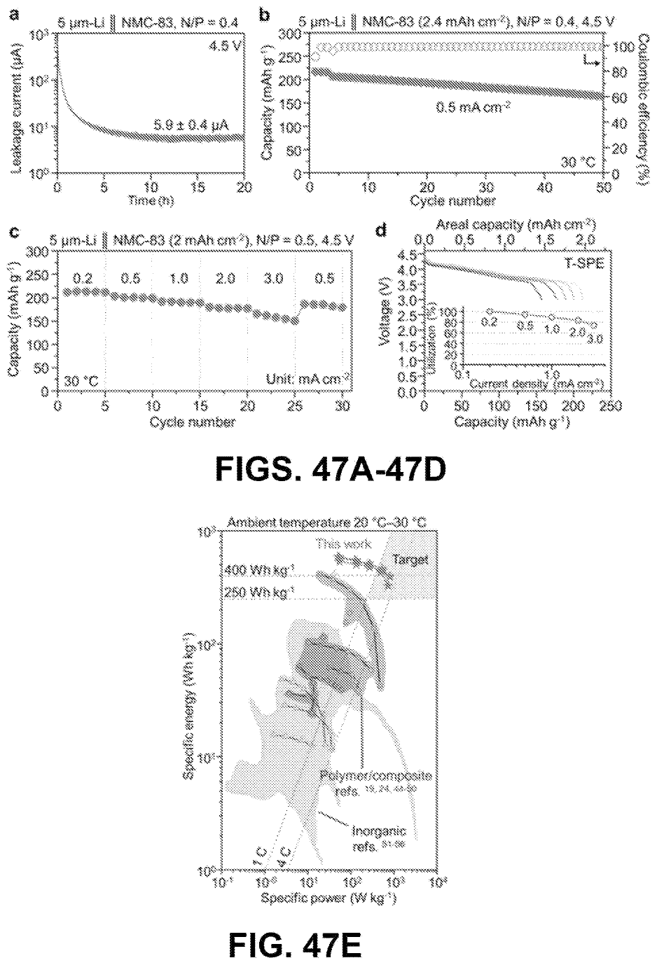

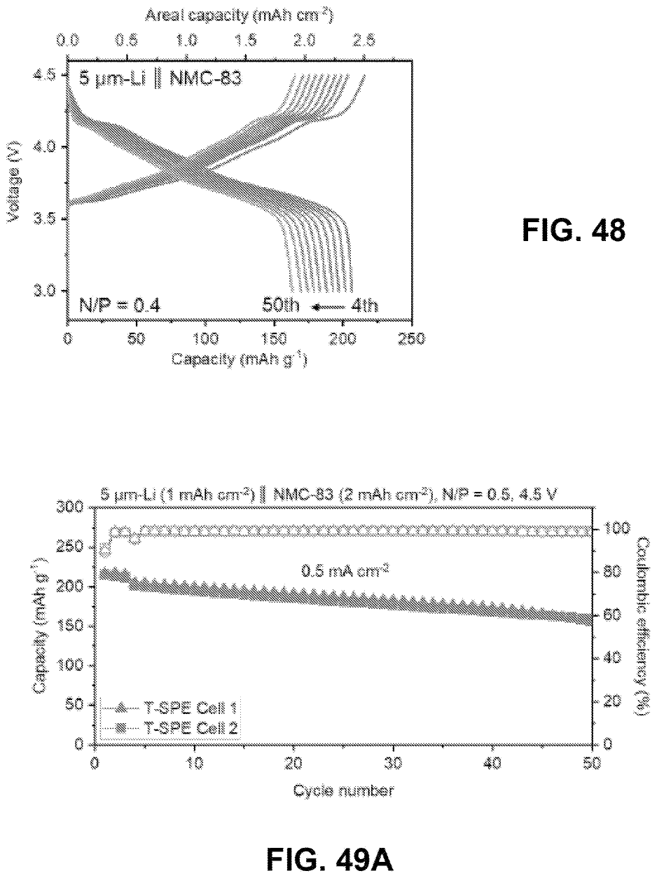

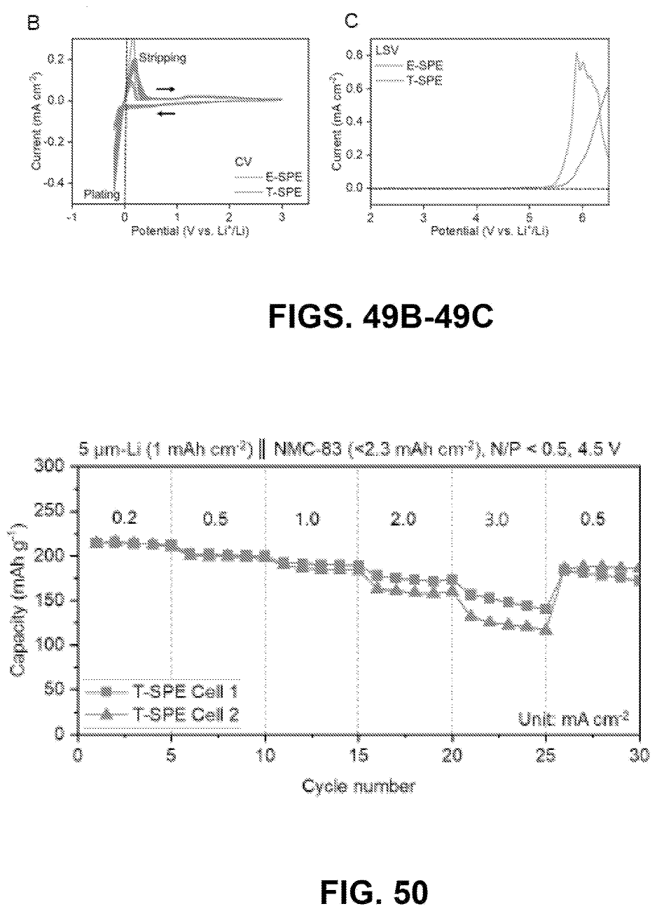

To further demonstrate the efficacy of T-SPE for high-energy and -power solid-state LMBs, full cells were subjected to more stringent conditions with a low N/P ratio (<0.5), a high-loading NMC-83 cathode (>2 mAh cm⁻²), 25 μm-thick SPE, and thin Li foil (5 μm; 1 mAh cm⁻²). Increasing upper cut-off voltage in SPE-based full cells is challenging due to the low oxidative stability of SPEs and severe side reactions at interfaces during cycling. To explore the potential of the T-SPE in addressing this important issue, an accelerated degradation test was performed to evaluate the side reactions between T-SPE and NMC-83 cathodes by exposing the cathode to high voltage conditions for an extended period. The cell with a low N/P ratio <0.5 was charged at 0.2 mA cm⁻¹ to 4.5 V versus Li⁺/Li and then held at that voltage for 20 h (FIG. 47A). The full cell with T-SPE reached a steady-state leakage current of 5.9 μA after 7.7 h of voltage holding, indicating effective suppression of side reactions and formation of a stable CEI on the cathode surface. With suppressed side reaction of T-SPE, the upper cut-off voltage of the full cells was extended from 4.3 V to 4.5 V. The full cell with a low N/P ratio of 0.4 delivered high capacities of 216 mAh g⁻¹ (2.5 mAh cm⁻²) and 206 mAh g⁻¹ (2.4 mAh cm⁻²) at 0.2 mA cm⁻² and 0.5 mA cm⁻², respectively, and maintained a capacity of 163 mAh g⁻¹ (1.9 mAh cm⁻²; 79% capacity retention) with an average CE of 99.1% (4th-50th) at 0.5 mA cm⁻² after 50 cycles (FIG. 478 and FIG. 48). The stable operation of full cells with T-SPE was further demonstrated with the replicated cells (FIG. 49A). The observed Li reversibility and oxidative stability from cyclic voltammetry and linear sweep voltammetry further support our findings from the accelerated degradation test and the subsequent cycling performances (FIG. 49B-49C). These results suggest that the unique bicontinuous structure of T-SPE offers a synergistic combination of superior ion transport properties and mechanical properties. In addition, the LF-rich interphases effectively stabilize electrode/electrolyte interfaces. Collectively, these factors contribute to the stable operation of the full cell, even with a low N/P ratio below 0.5.

To evaluate the effect of LiF-rich interphases with T-SPE on fast-charge capability, rate-capability tests of full cells with a low N/P ratio (<0.5) were conducted at various current densities from 0.2 to 3 mA cm⁻² (FIG. 47C). At 0.2 mA cm⁻², the full cell delivered a high capacity of 213 mAh g⁻¹ (2.0 mAh cm⁻²). The full col maintained high capacities of 178 mAh g⁻¹ (1.7 mAh cm⁻²; 84% of its capacity at 0.2 mA cm⁻²) at 2.0 mA cm⁻² and 158 mAh g⁻¹ (1.5 mAh cm⁻²; 74% of its capacity at 0.2 mA cm⁻²) at 3.0 mA cm⁻² (FIG. 47D). After the current density reduced to 0.5 mA cm⁻², the capacity was restored to 186 mAh g⁻¹. Replicated cells also demonstrated the fast-rate capability of T-SPE (FIG. 50). Specific energy and power densities of the cells with T-SPE at ambient temperature were plotted in a Ragone-type plot based on the weight of the anode, cathode, and solid electrolytes (FIG. 47E; Table 4 i). To enable a fair comparison of electrolyte potential across various experimental conditions, different cel types were normalized based solely on the weight of the anode, cathode, and solid electrolyte, with the exclusion of the weight of the current collector and cell casing. The full cells exhibited high specific energy exceeding 538 Wh kg_{anode+cathode+electrolyte}⁻¹ (766 Wh kg_{NMC-83}⁻¹) and maintained a high specific energy of 393 Wh kg⁻¹ at a high specific power of 804 W kg_{anode+cathode+electrolyte}⁻¹ at ambient temperature. The incorporation of a LiF-rich interphase at electrodes, derived from F-containing phase-separated electrolytes, significantly enhances to various properties of the phase-separated electrolyte system. These contributions include improved interfacial stability, superior overall electrochemical performance, and increased energy density. This system represents an advancement over non-fluorinated, bicontinuous electrolytes, which are primarily recognized for their structure that facilitates high ionic conductivity while preserving mechanical properties. However, these non-fluorinated systems overlook the important role of interphase formation, a key factor in the augmented performance of fluorinated electrolytes. Thus, these multifaceted improvements demonstrate the significance of the LiF-rich interphase in advancing the efficacy of phase-separated electrolyte systems.

Comparison of Battery Performance with Previously Reported Solid-State LMBs.

| Ref | Type | | Anode/ | Comp. | L_{SE} | ρ_{SE} | ρ_{loading} | Q | | |
|---|---|---|---|---|---|---|---|---|---|---|
| # | (Cell type) | SE | Cathode | (wt %) | (μm) | (g cm⁻³) | (mg cm⁻²) | (mAh g⁻¹) | Rate | |
| This | Polymer | T-SPE | Li/ | 90:5:5 | 25 | 1.14 | 10.00 | 213 | 0.2 | mA cm⁻² |
| work | (Coin type) | | NMC-83 | | | | | 200 | 0.5 | mA cm⁻² |
| | | | | | | | | 190 | 1 | mA cm⁻² |
| | | | | | | | | 178 | 2 | mA cm⁻² |
| | | | | | | | | 158 | 3 | mA cm⁻² |
| 12a | Polymer | PCEE | Li/ | 70:20:10 | 25 | 1.02 | 10.30 | 210 | 0.1 | mA cm⁻² |
| | (Coin type) | | NMC-83 | | | | | 190 | 0.2 | mA cm⁻² |
| | | | | | | | | 156 | 0.5 | mA cm⁻² |
| | | | | | | | | 126 | 1 | mA cm⁻² |
| | | | | | | | | 80 | 2 | mA cm⁻² |
| | | | | | | | | 26 | 3 | mA cm⁻² |
| 13c | Polymer | EA/FEC/ | Li/ | 80:10:10 | 300 | 1.1 | 11.53 | 150 | 0.2 | C |
| | (Coin type) | SN/LiTFSI | NMC-811 | | | | | | | |
| 25 | Composite | PTFE/LLZTO/ | Li/ | 70:20:10 | 100 | 4.77 | 3.50 | 158 | 0.1 | C |
| | (Pouch | SN/LiTFSI | NMC-622 | | | | | 145 | 0.3 | C |
| | type) | | | | | | | 130 | 0.5 | C |
| 26 | Composite | PVDF/PVAC/ | Li/ | 80:10:10 | 60 | 1.94 | 1.50 | 191 | 0.5 | C |
| | (Coin type) | LLZTO/TMS | LiCoO₂ | | | | | 180 | 1 | C |
| | | | | | | | | 170 | 2 | C |
| | | | | | | | | 150 | 3 | C |
| | | | | | | | | 128 | 4 | C |
| 27 | Composite | LLZTO/PEO/ | Li/ | 80:10:10 | 51 | 4.74 | 4.80 | 200 | 0.1 | C |
| | (Coin type) | SN/LiTFSI | NMC-622 | | | | | 190 | 0.2 | C |
| | | | | | | | | 180 | 0.5 | C |
| | | | | | | | | 170 | 1 | C |
| | | | | | | | | 150 | 2 | C |
| | | | | | | | | 120 | 5 | C |
| 28 | Polymer | Li—Cu-CNF | Li/ | 80:10:10 | 50 | 1.5 | 16.32 | 150 | 0.1 | C |
| | (Pouch | | LFP | | | | | | | |
| | type) | | | | | | | | | |
| 29 | Polymer | TB/DOL/ | Li/ | 80:10:10 | 25 | 1.15 | 4.00 | 132 | 0.5 | C |
| | (Coin type) | LiTFSI | NMC-622 | | | | | | | |
| 30 | Polymer | P(VDF- | Li/ | 80:10:10 | 70 | 1.53 | 1.60 | 175 | 0.1 | C |
| | (Coin type) | TrFE- | NMC-811 | | | | | | | |
| | | CTFE)/LiTFSI | | | | | | | | |
| 31 | Polymer | PVDF/VEC/ | Li/ | 70:20:10 | 20 | 1.31 | 5.00 | 155 | 0.1 | C |
| | (Coin type) | MASTFSILi/ | LFP | | | | | 125 | 0.2 | C |
| | | SN | | | | | | 110 | 0.3 | C |
| | | | | | | | | 85 | 0.4 | C |
| | | | | | | | | 60 | 0.5 | C |
| 32 | Inorganic | LPSCl- | Li-graphite/ | 67.9:32.1:0 | 200 | 1.9 | 2.00 | 125 | 1 | C |
| | (Homemade) | LGPS- | NMC-811 | | | | | | | |
| | | LPSCl | | | | | | | | |
| 33 | Inorganic | LLZTO/Li₃N/ | Li/ | 50:44:6 | 100 | 5.5 | 2.00 | 130 | 0.1 | C |
| | (Coin type) | Cu | LCO | | | | | 25 | 0.2 | C |
| | | | | | | | | 116 | 0.5 | C |
| | | | | | | | | 104 | 1 | C |
| 35 | Inorganic | LPSCl-LIC | Li—In/ | 66.5:28.5:5 | 120 mg | | 8.45 | 240 | 0.05 | C |
| | (Homemade) | | LPO-LLO | | | | | 223 | 0.1 | C |
| | | | | | | | | 197 | 0.2 | C |
| | | | | | | | | 151 | 0.5 | C |
| | | | | | | | | 108 | 1 | C |
| | | | | | | | | 62 | 2 | C |
| 36 | Inorganic | LPSCl | Ag—C/ | 81.3:14.4:4.3 | 40 | 1.64 | 15.80 | 194 | 0.1 | C |
| | (Pouch | | LZO-NMC | | | | | | | |
| | type) | | | | | | | | | |
| 37 | Inorganic | LPSCl | Li—In/ | 70:30:0 | 80 mg | | 8.91 | 157 | 0.1 | C |
| | (Homemade) | | LCO | | | | | 148 | 0.2 | C |
| | | | | | | | | 135 | 0.5 | C |
| | | | | | | | | 118 | 1 | C |
| | | | | | | | | 91 | 2 | C |
| | | | | | | | | 65 | 3 | C |

Nomenclature: SE: solid electrolyte; Comp.: the composition of cathode (active material:ionic conductive material/binder:electrical conductive additive); L_{SE}: the thickness of solid electrolyte; ρ_{SE}: the density of solid electrolyte (considering the density/composition of all components in the solid electrolyte); ρ_{loading}: the active loading density of cathode; Q: specific capacity. The cell types discussed in the literature are classified into three categories: coin, pouch, and homemade. It is noted that due to the unavailable values for the thickness of the lithium metal anode and effective area in the respective references, assumed values of 100 μm and 1 cm² were used, respectively. Therefore, the exact specific energy and power densities may vary depending on their actual experimental specifications. Unspecified average voltages of the cells for charge and discharge in the respective references were directly read from the graph. The data were acquired from the cells operated at ambient temperature (20-30° C.). It should be mentioned that the performance of other reported electrolytes can be further improved by optimizations such as reducing the thickness of the electrolyte and Li metal.

### Conclusions

We have demonstrated that combining bi-continuous structured polymer electrolytes, consisting of distinct elastomer and plastic crystal phases, with F-chemistry is highly effective for achieving high-energy and -power LMBs. Compared to homogenous structured E-SPEs, b-continuous structured T-SPEs assembled with newly designed TFEA monomers displayed an unparalleled combination of high ionic conductivity, mechanical elasticity, and robust interfacial properties. Furthermore, the use of F-containing T-SPEs resulted in the formation of high-quality SEI and CEI, enriched with LiF, which significantly enhanced Li reversibility and electrode stability at both the Li metal anode and NMC-83 cathode. The full cell with a challenging configuration, including 5-Nm thick Li, thin T-SPE, high-loading NMC-83, high-operating voltage of 4.5 V. and low N/P of <0.5, achieved outstanding specific energy exceeding 538 Wh kg_{anode+cathode+electrolyte}⁻¹ and maintained high specific energy of 393 Wh kg⁻¹ at a high specific power of 804 W kg_{anode+cathode+electrolyte}⁻¹. Our findings suggest that the F-containing phase-separated SPE system holds significant promise for achieving high-energy and -power solid-state LMBs suitable for practical battery applications.

### Example 5

### Preparation of Electrolytes

The E-SPE and T-SPE were prepared in an argon (Ar)-filled glove box where the concentration of O₂ and H₂O was maintained below 0.1 ppm. Both EA (≥99%; TCI) and TFEA (≥99%; Sigma-Aldrich) were degassed by Ar bubbling for 30 min before use. Due to the hygroscopic nature of SN (99%; TCI), SN was used after undergoing the following degassing process: (1) Ar bubbling at 70° C. for 30 min, (2) resting under vacuum conditions at 20° C. for 10 min, and (3) repeating steps (1) and (2) three times. The E-SPE precursor solution was prepared by mixing EA, SN, and LiTFSI powder (≥99%; Sigma-Aldrich) in a weight ratio of 45.7:41.2:11.1, respectively. 1 mol % of PEGDA (average Mn=575; Sigma-Aldrich) and 0.25 mol % of AIBN (Sigma-Aldrich) were added to EA. The T-SPE precursor solution was prepared by mixing TFEA, SN, and LiTFSI powder in a weight ratio of 45.7:41.2:11.1, respectively. 1 mol % of PEGDA and 0.25 mol % of AIBN were added to TFEA. Additives of 5 wt. % of fluoroethylene carbonate (FEC) (99%; Sigma-Aldrich) and 1.3 wt. % of lithium difluoro(oxalato)borate (LiDFOB) powder (299%: Sigma-Aldrich) were included to protect against the side reaction of SN with Li metal. The homogeneous precursor solutions were in-situ polymerized at 70° C. for 2 h within a 2032-type coin cell to yield E-SPE and T-SPE, which were used for the EIS measurements and full-cell fabrications.

### Material Characterization

⁷Li- and ¹⁹F-solid state NMR spectra were recorded at room temperature using a 400-MHz solid-state NMR spectrometer. To investigate the cross-sectional structure of E-SPE and T-SPE, the bulk PCEE was rapidly frozen using liquid nitrogen and then cut into ultra-thin sections with a thickness of ~100 nm at ~80° C. using an EM UC7 ultramicrotome (Leica 3 Microsystems GmbH, Vienna, Austria) with a cryo chamber (EM FC7, Leica Microsystems GmbH, Vienna, Austria) equipped with a glass knife cutting at a rate of 0.2 mm s⁻¹. TEM and scanning TEM (STEM) images were obtained using JEM-1400 and 2100F (JEOL Ltd., Tokyo, Japan) equipped with a Gatan 914 cryo-holder (Gatan Inc., Pleasanton, CA. USA), operating at 120 kV and 200 kV respectively. The EELS mapping images of fluorine in E-SPE and T-SPE were collected using a Titan G2 cube 60-300 (FEI, Hillsboro, USA) operating at 80 kV (FEI, Hillsboro, USA) to avoid electron beam damage. TGA (TA Instruments 0500) was performed from 25° C. to 700° C. at a heating rate of 10° C. min⁻¹ under a nitrogen atmosphere. A mechanical tensile test was carried out using a universal testing machine (UTM, lloyd instruments LR5K) with a 10 N force transducer. XPS (Thermal Scientific K-alpha XPS instruments) measurements were obtained to investigate the compositions of SEI and CEI formed on the Li metal anode (35 μm-thick Li) and NMC-83 cathode (>2 mAh cm⁻²) after 100 cycles of the full cells with E-SPE and T-SPE. The cycled-Li metal anode and -NMC-83 cathode were obtained by disassembling CR2032 coin cells in a glove box under 02 and H₂O levels below 1 ppm. The cycled-Li metal anodes and -NMC-83 cathodes were then transferred to XPS using a vacuum transfer vessel to prevent any contamination or side reactions from ambient oxygen and moisture. For comparison, the top surfaces of the cycled-Li metal anodes and -NMC-83 cathodes were etched using Ar-ion sputtering until the atomic ratio of Li in SEI components of E-SPE and T-SPE reached approximately 40%. For high resolution-TEM measurement, the cycled-NMC-83 particles were carefully scraped and loaded on a lacey carbon coated nickel TEM grid. The as-prepared sample was then characterized by an FEI Talos F200X operated at 200 keV.

### Electrode Preparation

LiNi_{0.6}Mn_{0.2}Co_{0.2}O₂ (NMC-622) cathodes were prepared using a slurry casting technique. Active material, Super P carbon, and polyvinylidene fluoride were dissolved in N-methyl-2-pyrrolidone with a weight ratio of 90:5:5 to make a slurry and then coated onto a current collector of aluminum foil. The cathodes were dried in a vacuum oven at 100° C. for 24 h. The active loading density of NMC-83 and LFP cathode was over 10 and 12 mg cm⁻², respectively.

### Electrochemical Measurements

The electrochemical performances of all cels were tested using 2032-type coin cells assembled using Li foil as the anode in an Ar-filled glovebox (M. Braun, O₂ and H₂O<0.1 ppm). EIS (BioLogic VMP3) of SPEs was measured from 10⁰ to 10⁷ Hz for symmetric Li cells and 10-3 to 10⁷ Hz for full cells, using a peak voltage of 10 mV at an open-circuit voltage. The ionic conductivity of electrolytes was measured using EIS measurement with stainless steel (SS)//electrolyte//SS symmetric cells in an environmental chamber (MC-812R, Espec Corp.) at the desired temperatures. A commercial polypropylene separator was used as a reservoir for the in situ polymerization of SPEs to prevent short circuits for full cells and ensure compatibility with the current roll-to-roll based Li-ion battery manufacturing. The cycling tests of 35 μm-thick Li∥25 μm-thick SPE∥high-loading LFP and NMC-83 cathodes cells were performed in the voltage range of 2.5.3.9 V and 3.0-4.3 V, respectively, with three initialization cycles at a current density of 0.2 mA cm⁻² prior to cycling at a current density of 1.0 mA cm⁻². The accelerated degradation test of 5 μm-thick Li∥25 μm-thick T-SPE∥high-loading NMC-83 cathode cel was charged to 4.5 V at 0.2 mA cm⁻² and then held at 4.5 V for 20 h. The cycling test of 5 μm-thick Li∥25 μm-thick T-SPE∥high-loading NMC-83 cathode cels was performed in the voltage range of 3.0-4.3 V with three initialization cycles at a current density of 0.2 mA cm⁻² prior to cycling at a current density of 0.5 mA cm⁻². The upper cut-off voltage was extended to 4.5 V for high-voltage operation of 5 μm-thick Li∥25 μm-thick T-SPE∥high-loading NMC-83 cathode cells. The high-voltage rate-capability test of 5 μm-thick Li∥25 μm-thick T-SPE∥high-loading NMC-83 cells was carried out in the voltage range of 3.0-4.5 V at varied current densities from 0.2 to 3 mA cm⁻². All specific and areal capacities were normalized using the weight of active material in the electrodes and the area of the electrodes, respectively.

Other advantages which are obvious and which are inherent to the invention will be evident to one skilled in the art. It will be understood that certain features and sub-combinations are of utility and may be employed without reference to other features and sub-combinations. This is contemplated by and is within the scope of the claims. Since many possible embodiments may be made of the invention without departing from the scope thereof, it is to be understood that all matter herein set forth or shown in the accompanying drawings is to be interpreted as illustrative and not in a limiting sense.

The compositions, systems, and methods of the appended claims are not limited in scope by the specific compositions, system, and methods described herein, which are intended as illustrations of a few aspects of the claims and any methods that are functionally equivalent are intended to fall within the scope of the claims. Various modifications of the compositions, systems, and methods in addition to those shown and described herein are intended to fall within the scope of the appended claims. Further, while only certain representative composition elements, system elements, and method steps disclosed herein are specifically described, other combinations of the composition elements, system elements, and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

The following patents, applications and publications as listed below and throughout this document are hereby incorporated by reference in their entirety herein.

The devices, systems, and methods of the appended claims are not limited in scope by the specific devices, systems, and methods described herein, which are intended as illustrations of a few aspects of the claims. Any devices, systems, and methods that are functionally equivalent are intended to fall within the scope of the claims. Various modifications of the devices, systems, and methods, in addition to those shown and described herein, are intended to fall within the scope of the appended claims. Further, while only certain representative devices, systems, and method steps disclosed herein are specifically described, other combinations of the devices, systems, and method steps also are intended to fall within the scope of the appended claims, even if not specifically recited. Thus, a combination of steps, elements, components, or constituents may be explicitly mentioned herein or less; however, other combinations of steps, elements, components, and constituents are included, even though not explicitly stated.

Unless defined otherwise, all technical and scientific terms used herein have the same meanings as commonly understood by one of skill in the art to which the disclosed invention belongs. Publications cited herein and the materials for which they are cited are specifically incorporated by reference.

The claims are not intended to include, and should not be interpreted to include, means-plus- or step-plus-function limitations unless such a limitation is explicitly recited in a given claim using the phrase(s) “means for” or “step for,” respectively.

In view of the described processes and compositions, hereinbelow are described certain more particularly described aspects of the inventions. These particularly recited aspects should not, however, be interpreted to have any limiting effect on any different claims containing different or more general teachings described herein or that the “particular” aspects are somehow limited in some way other than the inherent meanings of the language and formulas literally used therein.

### ASPECTS

In view of the described electrodes, batteries, and methods and variations thereof, herein below are described certain more particularly described aspects of the inventions. The particularly recited aspects should not, however, be interpreted to have any limiting effect on any different claims containing different or more general teachings described herein or that the “particular” aspects are somehow limited in some way other than the inherent meanings of the language and formulas literally used therein.
1. A composition comprising:
a) a matrix comprising a fluorinated elastomeric polymer;
b) a plurality of plastic crystals dispersed within the matrix to form a three-dimensional interconnected phase of plastic crystals, and
wherein the composition exhibits an ionic conductivity of 0.7 mS/cm to 5 mS/cm at 20° C.
2. The composition of aspect 1, wherein the fluorinated elastomeric polymer is derived from at least one monomer comprising:

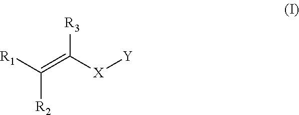

wherein R₁, R₂, and R₃ each is independently selected from hydrogen. C₁₋₁₂ alkyl, C₁₋₁₂ alkoxy, C₁₋₁₂ heteroalkyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), halide, amine; wherein R₁ and R₂ each is independently and optionally substituted with one or more of C₁₋₁₂ alkyl, C₁₋₁₂ alkoxy, C₁₋₁₂ heteroalkyl, —(C₀₋₅ alkyl)(C₆₋₁₄ aryl), —(C₀₋₅ alkyl-)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), aldehyde, amino, carbonyl, ester, ketone, ether, halide, carboxyl, hydroxy, nitro, sulfo-oxo, sulfonyl, sulfone, sulfoxide, thiol, or phosphonyl,
wherein X is C(O), O, or null,
wherein Y is R₄CF₃;
wherein R₄ is selected from C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₃₋₁₀ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), (—O—CH₂—CH₂—)ₙ, (O—CH₂—CF₂—), amine; wherein R₄ is independently and optionally substituted with one or more of C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆-C₁₄ aryl), —(C₀₋₅ alkyl)(C₁-C₁₃ heteroaryl), —(C₀₋₅ alkyl-)(C₆-C₁₄ aryloxy), —(C₀₋₅ alkyl)(C₃-C₁₀ cycloalkyl), —(C₀₋₅ alkyl)(C₃-C₁₀ heterocycloalkyl), —(C₀₋₅ alkyl)(C₃-C₁₀ cycloalkenyl), —(C₀₋₅ alkyl)(C₃-C₁₀ heterocycloalkenyl), aldehyde, amino, carbonyl, ester, ketone, ether, halide, carboxyl, hydroxy, nitro, sulfo-oxo, sulfonyl, sulfone, sulfoxide, thiol, or phosphonyl;
and wherein n is 1 to 200.
3. The composition of aspect 2, wherein the at least one monomer (I) comprises

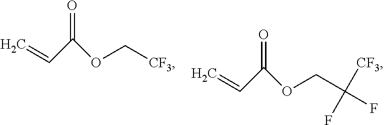

or a combination thereof.
4. The composition of any one of aspects 1-3, wherein the plurality of plastic crystals are derived from one or more:

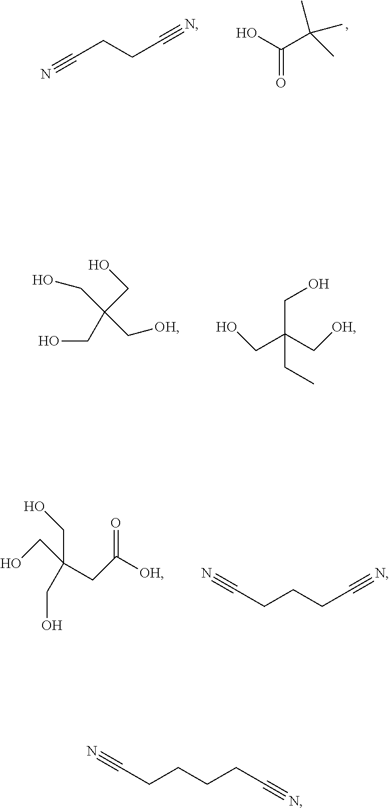

or a combination thereof.
5. The composition of any one of aspects 1-4, further comprising a metal salt, wherein a cation of metal salt comprises one or more of Li, K, Na, Ca, Mg, Zn, Al, or a combination thereof.
6. The composition of aspect 5, wherein an anion of metal salt comprises bistriflimide (TFSI⁻), bis(fluorosulfonyl)imide) (FSI⁻), triflate (OTf⁻), hexafluorophosphate (PF₆⁻), hexafluoroarsenate (AsF₆⁻), aluminum tetrachloride (AlCl₄⁻), boron tetrachloride (BCl₄⁻), boron tetrafluoride (BF₄⁻), iodide (I⁻), chlorate (ClO₃⁻), bromate (BrO₃⁻) iodate (IO₃⁻) difluoro(oxalato)borate (DFOB⁻), bis(oxalato)borate (BOB⁻), difluorophosphate (DFP) or a combination thereof.
7. The composition of any one of aspects 1-6, wherein the composition is crosslinked.
8. The composition of any one of aspects 1-7, wherein the composition exhibits an elongation at break of 300% to 450%.
9. The composition of any one of aspects 5-8, wherein an ion transference number of the cation is greater than 0.4.
10. The composition of any one of aspect 1-9, wherein the composition is flame retardant.
11. A battery comprising an electrolyte comprising the composition of any one of claims 1-10, an anode, and a cathode.
12. The battery of aspect 11, wherein the anode comprises a metal material.
13. The battery of aspect 12, wherein the metal material comprises Li, Ca, Na, K, Mg, Zn, Al, alloys thereof, or a combination thereof.
14. The battery of any one of aspects 11-13, wherein the cathode is a metal cathode or a composite cathode.
15. The battery of aspect 14, wherein the cathode comprises copper, carbon, graphite, sodium, potassium, lithium, magnesium, calcium, aluminum, layered oxides, vanadium-based cathode, sulfur-based cathode, manganese-based cathode, rocksalt cathode, disordered rocksalt cathode, lithium-rich cathode, high voltage ceramic, low voltage ceramic. NMC (nickel-manganese-cobalt oxide) cathode, NCA (nickel-cobalt-aluminum oxide) cathode, LCO (lithium cobalt oxide) cathode, lithium-nickel-cobalt-aluminum oxide material (LNCAO), lithium-nickel-manganese-cobalt oxide (LNMCO), LFP (lithium iron phosphate) cathode, fluoride-based cathode, sulfur selenium cathode, sulfur selenium tellurium cathode, spinels, olivines, or any combination thereof.
16. The battery of any one of aspects 11-15, the battery exhibits a cyclic coulombic efficiency greater than 90% for 1,000 cycles at a current density from 0.1 mA cm⁻² to 10 mA cm⁻².
17. The battery of any one of aspects 11-16, wherein the battery exhibits a specific energy greater than 350 Wh/kg_{anode+cathode+electrolyte}.
18. A method of making the composition of any one of aspects 1-10, wherein the method comprises:
a) forming a mixture comprising
i. one or more monomers of Formula (I),
ii. a plurality of plastic crystals; and
b) polymerizing the mixture to form the composition.
19. The method of aspect 18, wherein the mixture further comprises a salt AB, A is selected from Li, K, Na, Ca, Mg, Zn, Al, or a combination thereof; and B is selected from bistriflimide (TFSI⁻), bis(fluorosulfonyl)imide) (FSI⁻), triflate (OTf⁻), hexafluorophosphate (PF₆⁻), hexafluoroarsenate (AsF₆⁻), aluminum tetrachloride (AlCl₄⁻—), boron tetrachloride (BCl₄⁻), boron tetrafluoride (BF₄⁻), iodide (I⁻), chlorate (ClO₃⁻), bromate (BrO₃⁻), iodate (IO₃⁻), difluoro(oxalato)borate (DFOB⁻), bis(oxalato)borate (BOB⁻), difluorophosphate (DFP), or a combination thereof.

1. A composition comprising:
a) a first phase comprising a fluorinated elastomeric polymer, and
b) a second phase comprising a plurality of plastic crystals dispersed within the matrix to form a three-dimensional interconnected phase of plastic crystals,
wherein the composition exhibits an ionic conductivity of 0.7 mS/cm to 5 mS/cm at 20° C.

2. The composition of claim 1, wherein the fluorinated elastomeric polymer is present in an amount from 5-80 vol. %, of the composition, and/or wherein the plurality of plastic crystals is present in an amount from 20-95 vol. % of the composition; and/or wherein the plurality of plastic crystals is present in the composition in a volume that is greater than the fluorinated elastomer, and/or wherein the plurality of plastic crystals is present in the composition in a weight that is greater than the fluorinated elastomer.

3.-10. (canceled)

11. The composition of claim 1, wherein the fluorinated elastomeric polymer is derived from a mixture comprising a compound of Formula (I): 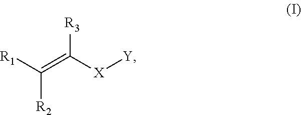
wherein R₁, R₂, and R₃ each is independently selected from hydrogen, C₁₋₁₂ alkyl, C₁₋₁₂ alkoxyl, C₁₋₁₂ heteroalkyl, —(C₀₋₅ alkylene)(C₆₋₁₄ aryl), —(C₀₋₅ alkylene)(C₁₋₁₃ heteroaryl), —(C₀₋₅ alkylene)(C₆₋₁₄ aryloxy), —(C₀₋₅ alkylene)(C₃₋₁₀ cycloalkyl), —(C₀₋₅ alkylene)(C₃₋₁₀ heterocycloalkyl), —(C₀₋₅ alkylene)(C₃₋₁₀ cycloalkenyl), —(C₀₋₅ alkylene)(C₃₋₁₀ heterocycloalkenyl), halo, amine; wherein R₁ and R₂ each is independently and optionally substituted with one or more of C₁₋₁₂ alkyl, C₁₋₁₂ alkoxy, C₁₋₁₂ heteroalkyl, —(C₀₋₅ alkylene)(C₆₋₁₄ aryl), —(C₀₋₅ alkylene)(C₁₋₁₃ heteroaryl), —(C₀₋₅ alkylene)(C₆₋₁₄ aryloxy), —(C₀₋₅ alkyl)(C₃₋₁₀ cycloalkyl), —(C₀₋₅ alkylene)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), aldehyde, amino, carbonyl, ester, ketone, ether, halo, carboxyl, hydroxy, nitro, sulfo-oxo, sulfonyl, sulfone, sulfoxide, thiol, or phosphonyl,
X is C(═O), C(═O) O, C(═O) NH, or null,
Y is R₄CF₃;
wherein R₄ is selected from C₁₋₂₀ alkylene, C₂₋₂₀ alkenylene, C₂₋₂₀ alkynylene, C₁₋₂₀ alkoxylene, C₁₋₂₀ heteroalkylene, C₂₋₂₀ heteroalkenylene, C₂₋₂₀ heteroalkynylene, —(C₀₋₅ alkylene)(C₆₋₁₄ aryl), —(C₀₋₅ alkylene)(C₁₋₁₃ heteroaryl), —(C₀₋₅ alkylene)(C₆₋₁₄ aryloxy), —(C₀₋₅ alkylene)(C₃₋₁₀ cycloalkyl), —(C₀₋₅ alkylene)(C₃₋₁₀ heterocycloalkyl), —(C₀₋₅ alkyl-ene)(C₃₋₁₀ cycloalkenyl), —(C₀₋₅ alkylene)(C₃₋₁₀ heterocycloalkenyl), (—O—CH₂—CH₂—)ₙ, (O—CH₂—CF₂—), amine; wherein R₄ is independently and optionally substituted with one or more of C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkylene)(C₆-C₁₄ aryl), —(C₀₋₅ alkylene)(C₁-C₁₃ heteroaryl), —(C₀₋₅ alkylene)(C₆-C₁₄ aryloxy), —(C₀₋₅ alkylene)(C₃-C₁₀ cycloalkyl), —(C₀₋₅ alkylene)(C₃-C₁₀ heterocycloalkyl), —(C₀₋₅ alkylene)(C₃-C₁₀ cycloalkenyl), —(C₀₋₅ alkylene-) (C₃-C₁₀ heterocycloalkenyl), aldehyde, amino, carbonyl, ester, ketone, ether, halo, carboxyl, hydroxy, nitro, sulfo-oxo, sulfonyl, sulfone, sulfoxide, thiol, or phosphonyl; and
wherein n is 1 to 200.

12. The composition of claim 11, wherein R₁ and R₂ are each hydrogen, and/or wherein R₃ is hydrogen or methyl, and/or wherein X is C(O)O, and/or wherein Y is C₁₋₂₀ alkylene, optionally substituted one or more times by halo.

13.-18. (canceled)

19. The composition of any claim 11, wherein the compound of Formula (I) is:

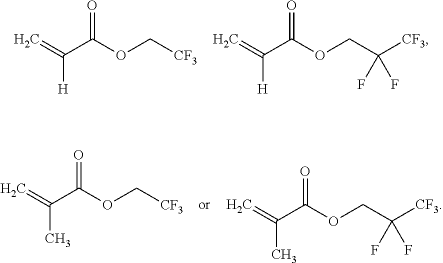

20. (canceled)

21. The composition of claim 11, wherein the mixture further comprises a crosslinker, wherein the crosslinker comprises a bis(meth)acrylate, a bis(meth)acrylamide, or a divinyl compound.

22.-24. (canceled)

25. The composition of claim 21, wherein the crosslinker has the formula: 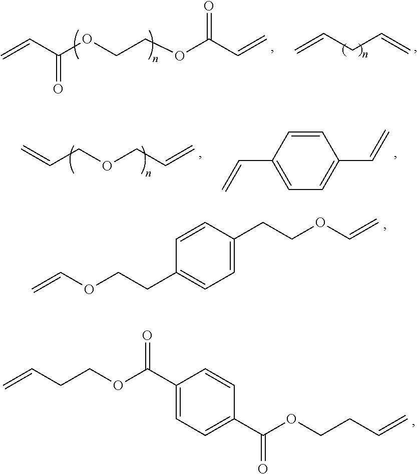
or a combination thereof,
wherein n is from 1 to 30.

26. The composition of claim 1, wherein the plurality of plastic crystals comprise a compound having the formula: 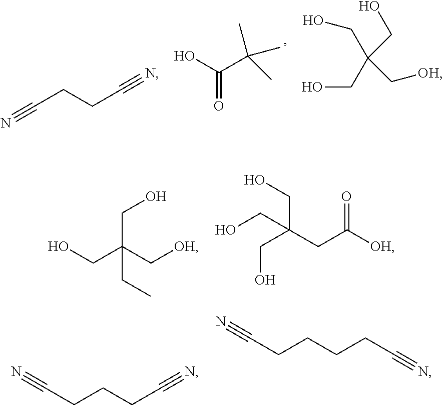
or a combination thereof.

27. The composition of claim 1, further comprising a metal salt comprising a cation and an anion, wherein the cation comprises Li, K, Na, Ca, Mg, Zn, Al, or a combination thereof, and wherein the anion comprises bistriflimide (TFSI⁻), bis(fluorosulfonyl)imide) (FSI⁻), triflate (OTf⁻), hexafluorophosphate (PF₆⁻), hexafluoroarsenate (AsF₆⁻), aluminum tetrachloride (AlCl₄⁻), boron tetrachloride (BCl₄⁻), boron tetrafluoride (BF₄⁻″), iodide (I⁻), chlorate (ClO₃⁻), bromate (BrO₃⁻), iodate (IO₃⁻), difluoro(oxalato)borate (DFOB⁻), bis(oxalato)borate (BOB⁻), difluorophosphate (DFP) or a combination thereof.

28.-30. (canceled)

31. The composition of claim 27, wherein the concentration of the cation is greater in the interconnected phase of plastic crystals than in the fluorinated elastomeric polymer, and wherein at least 75%, the cations are in the interconnected phase of plastic crystals.

32. (canceled)

33. The composition of claim 1, wherein the composition exhibits at elongation at break of at least 100%.

34. (canceled)

35. An electrolyte comprising the composition of claim 1.

36. A battery comprising the electrolyte of claim 35, an anode and a cathode, wherein
the anode comprises Li, Ca, Na, K, Mg, Zn, Al, an alloy thereof, or a combination thereof, and wherein
the cathode comprises copper metal, carbon, graphite, sodium, potassium, lithium, magnesium, calcium, aluminum, layered oxides, a vanadium-based cathode, a sulfur-based cathode, manganese-based cathode, a rocksalt cathode, a disordered rocksalt cathode, a lithium-rich cathode, a high voltage ceramic, a low voltage ceramic, a NMC (nickel-manganese-cobalt oxide) cathode, a NCA (nickel-cobalt-aluminum oxide) cathode, a LCO (lithium cobalt oxide) cathode, lithium-nickel-cobalt-aluminum oxide material (LNCAO), lithium-nickel-manganese-cobalt oxide (LNMCO), a LFP (lithium iron phosphate) cathode, a fluoride-based cathode, a sulfur selenium cathode, a sulfur selenium tellurium cathode, spinels, olivines, or a combination thereof.

37.-44. (canceled)

45. The battery of claim 36, wherein the battery exhibits a cyclic coulombic efficiency greater than 90% for 1,000 cycles at a current density from 0.1 mA cm⁻² to 10 mA cm⁻², and/or
wherein the battery exhibits a specific energy greater than 350 Wh/kg_{anode+cathode+electrolyte}.

46. (canceled)

47. A composition obtained by polymerizing a mixture comprising:
a) a metal salt comprising a cation and an anion;
b) a plurality of plastic crystals; and
c) a compound of Formula (I): 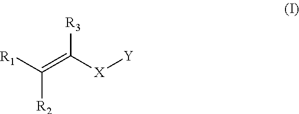
wherein R₁, R₂, and R₃ each is independently selected from hydrogen, C₁₋₁₂ alkyl, C₁₋₁₂ alkoxyl, C₁₋₁₂ heteroalkyl, —(C₀₋₅ alkylene)(C₆₋₁₄ aryl), —(C₀₋₅ alkylene)(C₁₋₁₃ heteroaryl), —(C₀₋₅ alkylene)(C₆₋₁₄ aryloxy), —(C₀₋₅ alkylene)(C₃₋₁₀ cycloalkyl), —(C₀₋₅ alkylene)(C₃₋₁₀ heterocycloalkyl), —(C₀₋₅ alkylene)(C₃₋₁₀ cycloalkenyl), —(C₀₋₅ alkylene)(C₃₋₁₀ heterocycloalkenyl), halo, amine; wherein R¹ and R² each is independently and optionally substituted with one or more of C₁₋₁₂ alkyl, C₁₋₁₂ alkoxy, C₁₋₁₂ heteroalkyl, —(C₀₋₅ alkylene)(C₆₋₁₄ aryl), —(C₀₋₅ alkylene)(C₁₋₁₃ heteroaryl), —(C₀₋₅ alkylene)(C₆₋₁₄ aryloxy), —(C₀₋₅ alkyl)(C₃₋₁₀ cycloalkyl), —(C₀₋₅ alkylene)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), aldehyde, amino, carbonyl, ester, ketone, ether, halo, carboxyl, hydroxy, nitro, sulfo-oxo, sulfonyl, sulfone, sulfoxide, thiol, or phosphonyl,
X is C(═O), C(═O) O, C(═O) NH, or null,
Y is R₄CF₃;
wherein R⁴ is selected from C₁₋₂₀ alkylene, C₂₋₂₀ alkenylene, C₂₋₂₀ alkynylene, C₁₋₂₀ alkoxylene, C₁₋₂₀ heteroalkylene, C₂₋₂₀ heteroalkenylene, C₂₋₂₀ heteroalkynylene, —(C₀₋₅ alkylene)(C₆₋₁₄ aryl), —(C₀₋₅ alkylene)(C₁₋₁₃ heteroaryl), —(C₀₋₅ alkylene)(C₆₋₁₄ aryloxy), —(C₀₋₅ alkylene)(C₃₋₁₀ cycloalkyl), —(C₀₋₅ alkylene)(C₃₋₁₀ heterocycloalkyl), —(C₀₋₅ alkyl-ene)(C₃₋₁₀ cycloalkenyl), —(C₀₋₅ alkylene)(C₃₋₁₀ heterocycloalkenyl), (—O—CH₂—CH₂—)ₙ, (O—CH₂—CF₂—), amine; wherein R⁴ is independently and optionally substituted with one or more of C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkylene)(C6-C₁₄ aryl), —(C₀₋₅ alkylene)(C1-C₁₃ heteroaryl), —(C₀₋₅ alkylene)(C₆-C₁₄ aryloxy), —(C₀₋₅ alkylene)(C₃-C₁₀ cycloalkyl), —(C₀₋₅ alkylene)(C₃-C₁₀ heterocycloalkyl), —(C₀₋₅ alkylene)(C₃-C₁₀ cycloalkenyl), —(C₀₋₅ alkylene-)(C₃-C₁₀ heterocycloalkenyl), aldehyde, amino, carbonyl, ester, ketone, ether, halo, carboxyl, hydroxy, nitro, sulfo-oxo, sulfonyl, sulfone, sulfoxide, thiol, or phosphonyl; and
wherein n is 1 to 200.

48.-54. (canceled)

55. The composition of claim 47, wherein the compound of Formula (I) is:

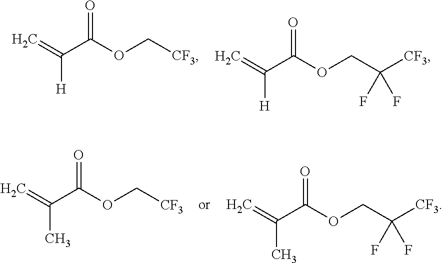

56. (canceled)

57. The composition of claim 47, wherein the plurality of plastic crystals comprise a compound having the formula: 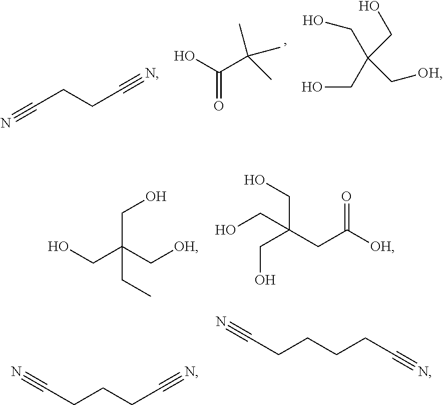
or a combination thereof.

58. The composition of claim 47, wherein the cation comprises Li, K, Na, Ca, Mg, Zn, Al, or a combination thereof, and wherein the anion comprises bistriflimide (TFSI⁻), bis(fluorosulfonyl)imide) (FSI⁻), triflate (OTf⁻), hexafluorophosphate (PF₆⁻), hexafluoroarsenate (AsF₆⁻), aluminum tetrachloride (AlCl₄⁻), boron tetrachloride (BCl₄⁻), boron tetrafluoride (BF₄⁻), iodide (I⁻), chlorate (ClO₃⁻), bromate (BrO₃⁻) iodate (IO₃⁻) difluoro(oxalato)borate (DFOB⁻), bis(oxalato)borate (BOB⁻), difluorophosphate (DFP) or a combination thereof.

59.-68. (canceled)

69. The composition of claim 47, wherein the mixture further comprises a crosslinker wherein the crosslinker has the formula: 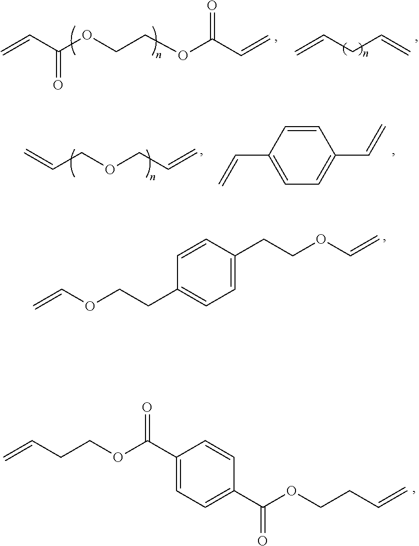
or a combination thereof,
wherein n is from 1 to 30.

70.-74. (canceled)

75. The composition of claim 47, wherein the mixture further comprises an initiator, and the initiator comprises a thermal initiator, a photoinitiator, or a combination thereof.

76.-80. (canceled)
